(19) United States
(12) Patent Application Publication
(10) Pub. No.: US 2022/0343411 A1
(43) Pub. Date: Oct. 27, 2022

(54) Cloud-Based Infrastructure for Multi-Party Commercial Real Estate Management

(71) Applicant: NVZ Technologies, Inc., Dallas, TX (US)

(72) Inventors: Kyle Andrew Waldrep, Dallas, TX (US); Alex Hibbard, Dallas, TX (US); Senecca Miller, Dallas, TX (US)

(21) Appl. No.: 17/640,261

(22) PCT Filed: Sep. 9, 2020
(86) PCT No.: PCT/US20/49979

§ 371 Date: Mar. 3, 2022

Related U.S. Application Data
(60) Provisional application No. 62/897,922, filed on Sep. 9, 2019.
(60) Provisional application No. 62/964,004, filed on Jan. 21, 2020.

(51) Int. Cl. G06Q 30/06; G06Q 50/16

(52) U.S. Cl. CPC G06Q 30/0645; G06Q 50/163; G06Q 50/165

(57) ABSTRACT

The present disclosure involves systems, software, and computer implemented methods for adaptive role-based leasing transaction management, including management of tenant inquiries. An example method includes receiving a request from a user to access a lease transaction management system. An organization and a role associated with a current session of the user are determined. A user interface is customized based on the organization and the role associated with the current session. Information for tenant inquiries that the user is authorized to view based on the role and the organization is displayed. Tenant inquiry information for a first tenant inquiry for a first prospective tenant is received. At least one matching property that matches the tenant inquiry information is automatically identified. Information about the at least one matching property is presented to the user.

### TECHNICAL FIELD

The present disclosure relates to computer-implemented methods, software, and systems for adaptive role-based leasing transaction management, including management of tenant inquiries.

### BACKGROUND

Commercial real estate deals can occur in response to a party needing a space to rent. The party can contact a tenant representative for assistance in finding a suitable space to rent. The tenant representative can contact one or more leasing agents. A leasing agent can represent a property owner who is advertising a commercial space for rent.

### SUMMARY

The present disclosure involves systems, software, and computer implemented methods for adaptive role-based leasing transaction management, including management of tenant inquiries. One example method includes, for example: receiving a request from a first user to access a lease transaction management system; determining a first organization and a first role associated with a current session of the first user; customizing a user interface of the lease transaction management system based on the first organization and the first role associated with the current session, including displaying information for tenant inquiries that the first user is authorized to view based on the first role and the first organization; receiving, through the user interface, first tenant inquiry information for a first tenant inquiry for a first prospective tenant; automatically identifying at least one matching property that matches the tenant inquiry information; and presenting, in the user interface, information about the at least one matching property to the first user.

While generally described as computer-implemented software embodied on tangible media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram illustrating an example system for adaptive role-based leasing transaction management.

FIG. 2 illustrates an example server.

FIG. 3 illustrates an example system that provides role-based access.

FIG. 4 illustrates an example system for management of various activity phases.

FIG. 5 is a flowchart of an example method for deal creation.

FIG. 6 is a flowchart of an example method for enabling a user to view and interact with assigned deals

FIG. 7 is a flowchart of an example method for enabling a user to perform actions for a deal.

FIG. 8 is a flowchart of an example method for a deal workflow.

FIG. 9 is a flowchart of an example method for processing deals that have file-related tasks.

FIG. 10 is a flowchart of an example method for adaptive role-based leasing transaction management.

FIG. 11 illustrates an example login user interface.

FIG. 12 illustrates an example dashboard user interface.

FIG. 13 illustrates an example profile information user interface.

FIG. 14 illustrates an example deals user interface.

FIG. 15 illustrates an example completed-deals user interface.

FIG. 16 illustrates an example inactive-deals user interface.

FIG. 17 illustrates an example deal detail user interface.

FIG. 18 is an example change deal status user interface.

FIG. 19 is an example deal detail user interface.

FIG. 20 illustrates an example deal detail user interface.

FIG. 21 illustrates an example file upload user interface.

FIG. 22 illustrates an updated file upload user interface.

FIG. 23 is an example deal detail user interface.

FIG. 24 illustrates an example activity pane.

FIG. 25 illustrates filtering of activities.

FIG. 26 illustrates a deals contacts user interface.

FIG. 27 illustrates a deals contacts user interface.

FIG. 28 is an example add team member dialog.

FIG. 29 is an example deal notes user interface.

FIG. 30 is an example deal notes user interface.

FIG. 31 is an example deal message user interface.

FIG. 32 is an example portfolio list user interface.

FIG. 33 illustrates an example add portfolio user interface.

FIG. 34 illustrates an example portfolio list user interface.

FIG. 35 is an example portfolio detail user interface.

FIG. 36 illustrates an example add portfolio team member user interface.

FIG. 37 is an example portfolio team user interface.

FIG. 38 is an example add property user interface.

FIG. 39 is an example portfolio detail user interface.

FIG. 40 is an example property detail user interface.

FIG. 41 is an example add listing user interface.

FIG. 42 is an example property detail user interface.

FIG. 43 is an example listing detail user interface.

FIG. 44 is a team members user interface.

FIG. 45 illustrates an add team member user interface.

FIG. 46 illustrates an example user interface for tenant inquiries.

FIG. 47 illustrates an example user interface that includes a stage filter for tenant inquiries.

FIG. 48 illustrates an example user interface for filtering tenant inquiries by a stage status.

FIG. 49 illustrates an example user interface for filtering tenant inquiries using multiple stage status values.

FIG. 50 illustrates an example user interface for filtering tenant inquiries using keywords.

FIG. 51 illustrates an example user interface for filtering tenant inquiries using keywords and stage status values.

FIG. 52 illustrates an example user interface for providing tenant information for a new tenant inquiry.

FIG. 53 illustrates an example user interface for providing information for a new tenant inquiry.

FIG. 54 illustrates an example user interface for associating a property with a tenant inquiry.

FIG. 55 illustrates an example user interface that has been updated to display a newly added tenant inquiry.

FIG. 56 illustrates an example user interface that enables a user to request a focused view of a tenant inquiry.

FIG. 57 illustrates an example user interface for displaying a tenant inquiry in a focused view.

FIG. 58 illustrates an example user interface that presents options for a property associated with a tenant inquiry.

FIG. 59 illustrates an example user interface for editing team members for a property that is associated with a tenant inquiry.

FIG. 60 illustrates an updated user interface for editing team members for a property that is associated with a tenant inquiry.

FIG. 61 illustrates an example user interface that has been updated to reflect the addition of a team member to a property associated with a tenant inquiry.

FIG. 62 illustrates an example user interface that presents options for a property associated with a tenant inquiry.

FIG. 63 illustrates an example user interface that has been updated to reflect a change in active properties for a tenant inquiry.

FIG. 64 illustrates an example user interface that displays inactive properties for a tenant inquiry.

FIG. 65 illustrates an example user interface that presents active properties and options for editing a tenant inquiry.

FIG. 66 illustrates an example user interface for editing tenant information for a tenant inquiry.

FIG. 67 illustrates an example user interface that has been updated to reflect changes in tenant information for a tenant inquiry.

FIG. 68 illustrates an example user interface for editing information for a new tenant inquiry.

FIG. 69 illustrates an example user interface that has been updated to display edited tenant inquiry information.

FIG. 70 illustrates an example confirmation user interface for confirming a setting of a tenant inquiry to an inactive state.

FIG. 71 illustrates an example user interface for displaying inactive tenant inquiries.

FIG. 72 illustrates an example confirmation user interface for confirming a setting of an inactive tenant inquiry to an active state.

FIG. 73 illustrates an example user interface that has been updated to reflect a setting of an inactive tenant inquiry to an active state.

FIG. 74 illustrates an example user interface that has been updated to reflect a setting of an inactive tenant inquiry to an active state.

FIG. 75 illustrates an example user interface that includes multiple prospective properties for a tenant inquiry.

FIG. 76 illustrates an example user interface for deal and tenant inquiry metrics.

FIG. 77 is a flowchart of an example method for adaptive role-based tenant inquiry management.

FIG. 78 is a flowchart of an example method for automatically identifying at least one matching property that matches tenant inquiry information.

FIG. 79 illustrates another example of a dashboard user interface.

FIG. 80 illustrates an example inquiries user interface.

FIGS. 81A-81C illustrate example move-to-deal user interfaces.

FIG. 81D illustrates an example inquiry user interface.

FIG. 81E illustrates an example inquiry user interface.

FIG. 81F-G illustrate example deals user interfaces.

### DETAILED DESCRIPTION

A cloud application platform and system can provide services and applications that serve the Commercial Real Estate (CRE) industry by providing a centralized location to include and engage all parties in a lease transaction, from tenant inquiries to property tours to move-in to re-upping a future lease. Existing CRE lease processes can be inefficient, time consuming, and lack transparency. The cloud application platform described herein enables users to manage and more effectively advance a deal, which can save time for brokers, lessors, lessees, and other deal participants. The system can provide landlords with key transaction metrics, which can increase user satisfaction. The platform can include a cloud application that utilizes, for example, a frontend, a backend, a data storage layer, and a cloud platform host.

The user can access the system using one of a set of defined roles, which can include, for example, administrator, company owner, broker, leasing team member, or tenant representative, among others. An administrator can register and invite company owners. Once a company account is defined in the system, a company owner can add leasing team members, who can add listings and perform other actions.

For instance, an onboarding process for a new company can be initiated by an administrator. The administrator can assign markets for a company. A company owner can be sent an invitation to join the system. Leasing team members can also be invited join to the system and can add properties and/or listings to a portfolio. Markets can be defined and used when creating a deal for a specific listing. A tenant representative can be invited to join the system during a deal creation process. As another example, a tenant representative can be invited to join the system during a tenant inquiry process that includes providing and discussing tenant needs and identifying potential matching properties. Other role-based actions can be enabled, as described below.

The system can be configured to capture information from tenant inquiries using a tenant inquiry component of the application. A prospective tenant or a tenant representative may contact a broker and express certain interests or needs for a type of property. The broker can use a set of user interfaces provided by the application to capture the needs expressed by the tenant representative and begin a process of identifying properties that may match or satisfy the tenant inquiry/tenant needs. The broker can manually select matching properties and/or the system can automatically identify matching properties. Properties can be matched based on one or more of an availability date, size, cost, property use type, location, and other suitable factors. The inquiry component can manage activities that occur related to prospective properties that have not yet began more formal deal proceedings. For example, in response to a tenant inquiry, multiple potential properties can be identified, and each property can have activities, such as sending of marketing information, tour scheduling, proposals, etc., that occur and that are managed and tracked by the system. A tenant representative can view identified properties and select candidate properties that may be of interest to the tenant.

Inquiries can have a defined workflow, with different activities that can occur within the workflow. An inquiry workflow can interface and in some cases overlap with workflows and stages in more formal deal processes. For example, activities can be occurring for multiple properties in response to a single tenant inquiry—for example, a prospective tenant may have been sent marketing materials for several properties, toured multiple properties, have other tours scheduled, and/or been presented with initial proposals for different potential properties. At a certain point, the prospective tenant may indicate a more formal interest in a particular property, and, at that point, more formal proceedings can occur and a deal workflow can be initiated that includes other, such as more formal, activities for completing a formal deal with the tenant, including deal negotiation, lease activities, closing, etc. While the tenant is considering different properties, the inquiry workflow can be used to manage preliminary activities during the consideration period. The inquiry workflow can be used when multiple properties are being considered by a tenant, so that multiple formal deal processes are not unnecessarily started while a tenant is still deciding on properties.

A deal completion, for more formal proceedings, can go through various stages, or phases. Deal stages can include, for example, tour, proposal, lease, closing, and revenue stages. In each stage, users who have access to the deal can complete tasks. Some or all tasks can be required for a phase. The system can ensure that all required tasks for a phase are completed in order to proceed to a following phase. In some instances, the system can automate additional systems into the completion of a particular task, such as communication systems, legal document management systems, and others, such that accessing a task entry in the described system can cause other systems and applications to be executed, either within or external to the cloud system. Information about the completion of those tasks can then be provided back to the centralized system, and the particular task can be updated, and in some cases, considered completed. A visual indication of which task is currently being performed can be presented to all users, and users associated with the next task can be automatically notified via any suitable communication channel when the prior task has been completed.

Users of a given role can take part in various use cases that have been enabled for the role. For example, an administrator can create companies, invite owners, add markets, add portfolios for companies, add or freeze users, and view reports. As another example, a company owner can add portfolios, add properties, add listings, create deals, add/manage team members, send electronic messages through the system (e.g., send messages to participants of a deal), add notes, and track deal status. Leasing team members can add portfolios, add properties, add listings, respond to and update tenant inquiries, create deals, send electronic messages through the system (e.g., send messages to participants of a deal), add notes, track deal status, invite tenant representatives to join the system, and update/complete deal activities. Tenant representatives can create or provide information for tenant inquiries, view deals, invite other tenant representatives to join the system, track deal status, update/complete deal activities, upload documents, send messages to deal participants, and add clients. Further, each user with an appropriate role for a current deal or inquiry can be associated with particular tasks for that deal or inquiry, such that the proper team members are associated with and prompted for input and/or actions to complete the current task. Any persons associated with the deal or inquiry can have easy and immediate access to information as to the overall status of the deal or inquiry, where the current task list is, and what items have been or are left to be completed.

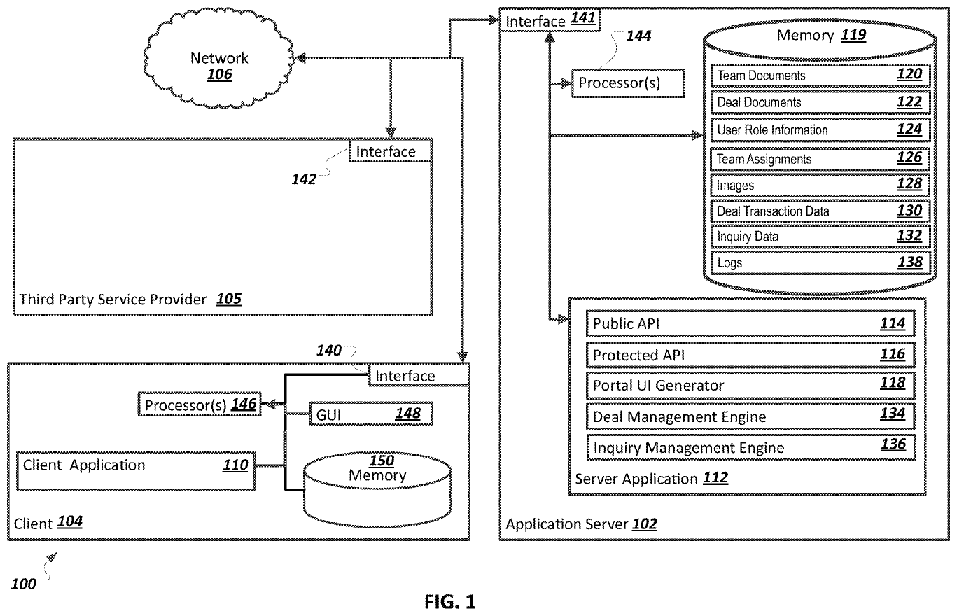

FIG. 1 is a block diagram illustrating an example system 100 for adaptive role-based leasing transaction management. Specifically, the illustrated system 100 includes or is communicably coupled with an application server 102, a client device 104, a third party service provider 105, and a network 108. Although shown separately, in some implementations, functionality of two or more systems or servers may be provided by a single system or server. In some implementations, the functionality of one illustrated system or server may be provided by multiple systems or servers.

A user can use a client application 110 to access a server application 112 provided by the application server 102. The user can be, for example, an administrator, company owner, leasing team member, or tenant representative. The client application 110 can access the server application 112 using one or more APIs (Application Programming Interfaces). For instance, a public API 114 can enable a user to login, reset a login password, register for the system, etc. A protected API 116 can be used for inviting users, adding properties, interacting with deals, and other transactional features. The public API 114 can be accessible without authentication. The protected API 116 can be accessed by an authenticated user. A login process can create an authentication token which can be used in subsequent requests to validate authorized usage.

A portal UI (User Interface) generator 118 can generate and provide a user interface to the client application 110. The user interface, and contents displayed within the user interface, can be based on a role of a logged-in user and on states of various transactions to which the user may be authorized as a participant.

The application server 102 can be configured to serve API requests from the client application 110. The requests can be for either static resources (e.g., HTML (HyperText Markup Language), CSS (Cascading Style Sheets), scripts) or dynamic content (e.g., property information, deal information, inquiry information, etc.). For both static and dynamic content, the application server 102 can be configured to not store such data, but rather store data in or retrieve data from a database (or other data storage layer), such as from memory 119 or disk storage. The application server 102 can check HTTP requests for security issues such as cross-site scripting (XSS) and cross-site request forgery (CSRF) by checking a request origin and required tokens in the request.

The application server 102 can process user requests, validate requests, and store data in the database for example. Stored data can include, for example, team documents 120 that are private to a particular team (e.g., a leasing team), deal documents 122 that are accessible by all participants related to a particular deal, user role information 124 used to determine what users have what roles for which transactions, team assignment information 126 (e.g., that specifies which users are on a particular leasing team), images 128 (of properties, etc.), deal transaction data 130, and inquiry data 132.

Deal transaction data 130 can be managed by a deal management engine 134, which can manage a deal through various deal stages, such as tour, proposal, lease, closing, and revenue stages. The deal management engine 134 can enable authorized users to perform certain actions on a deal, at various stages, based on a user's role and authorizations. Similarly, inquiry data 132 can be managed by an inquiry management engine 136, which can manage tenant inquiries. The inquiry management engine 136 can enable authorized users to perform certain actions on an inquiry, based on a user's role and authorizations. The inquiry management engine 136 can provide tenant inquiry user interfaces for capturing tenant inquiry information. The inquiry management engine can automatically identify properties that match the tenant needs expressed in a tenant inquiry. User interfaces provided by the inquiry management engine 136 can enable users, based on roles and permissions, to interface with and update the tenant inquiry, including progressing an inquiry through various inquiry activities and workflows (e.g., tour scheduling, marketing material sending, initial proposal activities, and selecting a prospective matching property as a property for more formal deal proceedings. Brokers and tenant representatives can each view tenant inquiry information, and can perform different actions based on assigned roles and permissions.

The deal management engine 134 can manage deal and other lease transactions. For instance, the deal management engine 135 can manage and track task/action assignment, reassignment, and completion. Tasks or actions for a deal can be done sequentially and/or in parallel. Each user is allowed to view or act on tasks based on privileges and assignments, which can be based on a user's role. A user can have a different role in different contexts. For example, a user can be a real estate agent who acts as a tenant representative for a first property and acts as a leasing agent for a second property.

Stored data can also include logs 138. The system can maintain detailed logs 138 regarding all activities performed on a deal on inquiry, for instance. Actions performed in the system can be logged in the logs 138 for auditing purposes, for example.

The application server 102 can be part of or associated with a cloud platform, for example. Documents, images, and other data can be stored in secure cloud storage locations (or in other location(s)) in an encrypted format. Transactional data can be stored in a database hosted by the cloud platform. Access to application data can be controlled using the cloud/application platforms.

To secure stored data (e.g., “data at rest”), data can be stored in a database layer of the cloud platform. Database servers can be made accessible only to application servers (e.g., the application server 102) and thereby protected from unauthorized usage. Mirror copies of database(s) and/or file storage(s) can be used for data redundancy and backups, and can be stored in separate geographic location(s) than production version(s).

Documents and images can be stored in the database and/or stored in a secured file or object storage service, with a file or object service being an example of a third party service provider to which the application server 102 can interface. Other third party service providers include third party property management platforms or document signing services.

As used in the present disclosure, the term “computer” is intended to encompass any suitable processing device. For example, although FIG. 1 illustrates a single application server 102, and a single client device 104, the system 100 can be implemented using a single, stand-alone computing device, two or more application servers 102, or two or more client devices 104. Indeed, the application server 102 and the client device 104 may be any computer or processing device such as, for example, a blade server, general-purpose personal computer (PC), Mac®, workstation, UNIX-based workstation, or any other suitable device. In other words, the present disclosure contemplates computers other than general purpose computers, as well as computers without conventional operating systems. Further, the application server 102 and the client device 104 may be adapted to execute any operating system, including Linux, UNIX, Windows, Mac OS®, Java™, Android™, iOS or any other suitable operating system. According to one implementation, the application server 102 may also include or be communicably coupled with an e-mail server, a Web server, a caching server, a streaming data server, and/or other suitable server.

Interfaces 140, 141, and 142 are used by the client device 104, the application server 102, and the third party service provider 105, respectively, for communicating with other systems in a distributed environment—including within the system 100—connected to the network 106. Generally, the interfaces 140, 141, and 142 each comprise logic encoded in software and/or hardware in a suitable combination and operable to communicate with the network 106. More specifically, the interfaces 140, 141, and 142 may each comprise software supporting one or more communication protocols associated with communications such that the network 106 or interface's hardware is operable to communicate physical signals within and outside of the illustrated system 100.

The application server 102 includes one or more processors 144. Each processor 144 may be a central processing unit (CPU), a blade, an application specific integrated circuit (ASIC), a field-programmable gate array (FPGA), or another suitable component. Generally, each processor 144 executes instructions and manipulates data to perform the operations of the application server 102. Specifically, each processor 144 executes the functionality required to receive and respond to requests from the client device 104, for example.

Regardless of the particular implementation, “software” may include computer-readable instructions, firmware, wired and/or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, Java™, JavaScript®, Visual Basic, assembler, Perl®, any suitable version of 4GL, as well as others. While portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

The application server 102 includes the memory 119. In some implementations, the application server 102 includes multiple memories. The memory 119 may include any type of memory or database module and may take the form of volatile and/or non-volatile memory including, without limitation, magnetic media, optical media, random access memory (RAM), read-only memory (ROM), removable media, or any other suitable local or remote memory component. The memory 119 may store various objects or data, including caches, classes, frameworks, applications, backup data, business objects, jobs, web pages, web page templates, database tables, database queries, repositories storing business and/or dynamic information, and any other appropriate information including any parameters, variables, algorithms, instructions, rules, constraints, or references thereto associated with the purposes of the application server 102.

The client device 104 may generally be any computing device operable to connect to or communicate with the application server 102 via the network 106 using a wireline or wireless connection. In general, the client device 104 comprises an electronic computer device operable to receive, transmit, process, and store any appropriate data associated with the system 100 of FIG. 1. The client device 104 can include one or more client applications, including the client application 110. A client application is any type of application that allows the client device 104 to request and view content on the client device 104. In some implementations, a client application can use parameters, metadata, and other information received at launch to access a particular set of data from the application server 102. In some instances, a client application may be an agent or client-side version of the one or more enterprise applications running on an enterprise server (not shown).

The client device 104 further includes one or more processors 146. Each processor 146 included in the client device 104 may be a central processing unit (CPU), an application specific integrated circuit (ASIC), a field-programmable gate array (FPGA), or another suitable component. Generally, each processor 146 included in the client device 104 executes instructions and manipulates data to perform the operations of the client device 104. Specifically, each processor 146 included in the client device 104 executes the functionality required to send requests to the application server 102 and to receive and process responses from the application server 102.

The client device 104 is generally intended to encompass any client computing device such as a laptop/notebook computer, wireless data port, smart phone, personal data assistant (PDA), tablet computing device, one or more processors within these devices, or any other suitable processing device. For example, the client device 104 may comprise a computer that includes an input device, such as a keypad, touch screen, or other device that can accept user information, and an output device that conveys information associated with the operation of the application server 102, or the client device 104 itself, including digital data, visual information, or a GUI 148.

The GUI 148 of the client device 104 interfaces with at least a portion of the system 100 for any suitable purpose, including generating a visual representation of the sourcing application 110. In particular, the GUI 148 may be used to view and navigate various Web pages, or other user interfaces. Generally, the GUI 148 provides the user with an efficient and user-friendly presentation of business data provided by or communicated within the system. The GUI 148 may comprise a plurality of customizable frames or views having interactive fields, pull-down lists, and buttons operated by the user. The GUI 148 contemplates any suitable graphical user interface, such as a combination of a generic web browser, intelligent engine, and command line interface (CLI) that processes information and efficiently presents the results to the user visually.

Memory 150 included in the client device 104 may include any memory or database module and may take the form of volatile or non-volatile memory including, without limitation, magnetic media, optical media, random access memory (RAM), read-only memory (ROM), removable media, or any other suitable local or remote memory component. The memory 150 may store various objects or data, including user selections, caches, classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the client device 104.

There may be any number of client devices 104 associated with, or external to, the system 100. For example, while the illustrated system 100 includes one client device 104, alternative implementations of the system 100 may include multiple client devices 104 communicably coupled to the application server 102 and/or the network 106, or any other number suitable to the purposes of the system 100. Additionally, there may also be one or more additional client devices 104 external to the illustrated portion of system 100 that are capable of interacting with the system 100 via the network 106. Further, the term “client”, “client device” and “user” may be used interchangeably as appropriate without departing from the scope of this disclosure. Moreover, while the client device 104 is described in terms of being used by a single user, this disclosure contemplates that many users may use one computer, or that one user may use multiple computers.

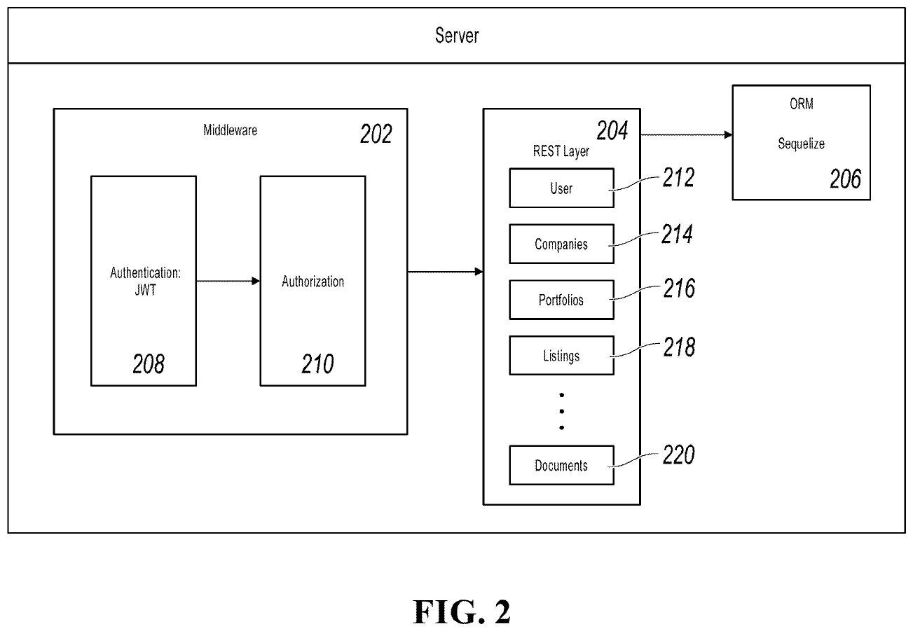

FIG. 2 illustrates an example server 200. In some implementations, the server 200 is a Node.JS (Node JavaScript) server. The server 200 includes a middleware layer 202, a REST (Representational State Transfer) layer 204, and an ORM (Object Relational Mapping) layer 206, among other components.

The middleware layer 202 can intercept and validate incoming traffic sent to the server 200, such as to validate whether a request is made by a valid user with appropriate access. An authentication component 208 can determine whether a requestor has a valid authentication token (e.g., that is provided to a user when the user successfully logs in to the application). In some implementations, the authentication component can perform JWT (JSON Web Token) authentication.

In general, various security features can be implemented in the application. For instance, authentication features can be enabled, whereby to use the system, a user needs to provide a username and a password. In some examples, OAuth is used for authentication. Authorization can be implemented, by an authorization component 210, so that users are only given access to interfaces and functionality for which they are authorized. Confidentiality of data can be enforced, whereby sensitive data (e.g., user passwords) is encrypted. Access to documents can be controlled using a secure application programming interface (API). Communication between clients and system server(s) can be encrypted (e.g., using a 2048 bit encryption key at a transport layer).

In further detail, when implementing access control and security, the extent to which data is accessible can be controlled by roles that have been assigned users. Roles can include, for example, system administrator, company owner, leasing team (for portfolios and/or properties), and tenant representative. Some roles enable users having one of those roles to invite other users to the system.

Other security measures can be taken to maintain security for data and the system infrastructure. For example, to protect data in transit, the application can be accessible only via a secured protocol (e.g., HTTPS (HyperText Transfer Protocol Secured protocol, which is based on SSL (Secured Sockets Layer) encryption) https protocol which is based on SSL encryption. In some implementations, a load balancer is used to accept and decrypt HTTPS request, and forward the requests to internal servers. The load balancer can use certificates issued by a certificate authority (CA).

The REST layer 204 can provide REST APIs (Application Programming Interfaces) that are served by the server 200. The REST layer can be modelled according to the platform's main entities (e.g., users 212, companies 214, portfolios 216 (and properties), listings 218, documents 220, deals, inquiries, etc.).

The ORM layer 206 can transform objects into relational database entities (e.g., which can be referred to as “sequelizing” object-based data). Using the ORM layer 206 can result in more domain visibility and development of less boilerplate code.

The server 200 can include or interface with other components, systems, or services. For example, the server 200 can include or use other utilities, including mail utilities, XML (eXtensible Markup Language) processing, image utilities, document signing and services, and messaging services, to name a few examples.

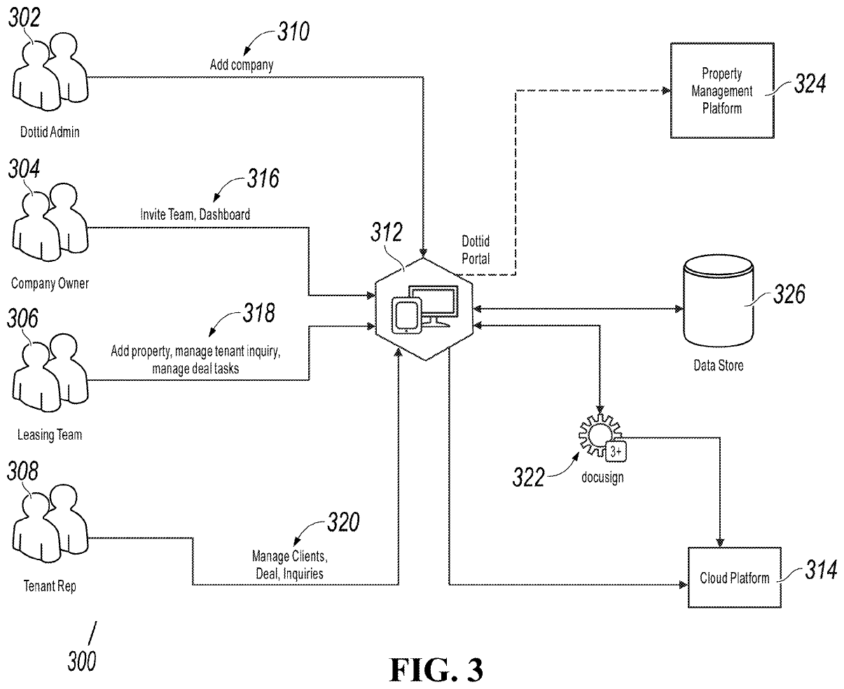

FIG. 3 illustrates an example system 300 that provides role-based access. The system 300 can support various roles. For instance, an administrator role 302, a company owner role 304, a leasing team role 306, and a tenant representative role 308 can be supported. The administrator role 302 can enable an add company activity 310 for a user at a system portal 312. The system portal 312 can be provided using a cloud platform 314.

The company owner role 304 can enable team invitation and dashboard viewing activities 316. The leasing team role 306 can enable property adding, inquiry management, and deal management activities 318. The tenant representative role 308 can enable client, inquiry, and deal management activities 320.

In addition to interfacing with the cloud platform 314, the system portal 312 can interface with other services or providers. For instance, the system portal 312 can interface with a document signing service 322. As another example, the system portal 312 can interface with a third party property management platform 324. A data store 326 can store data for the system.

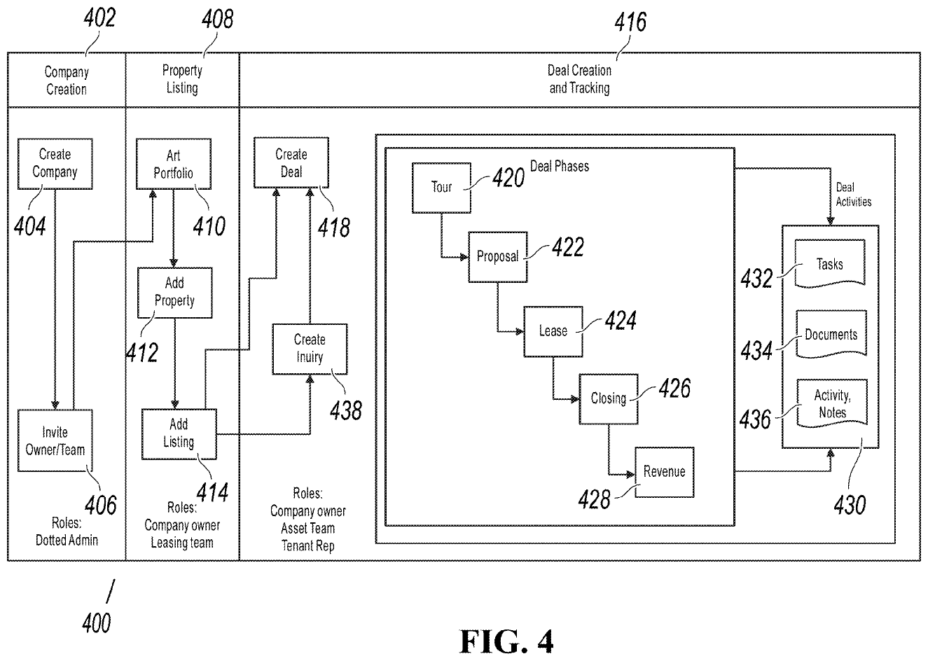

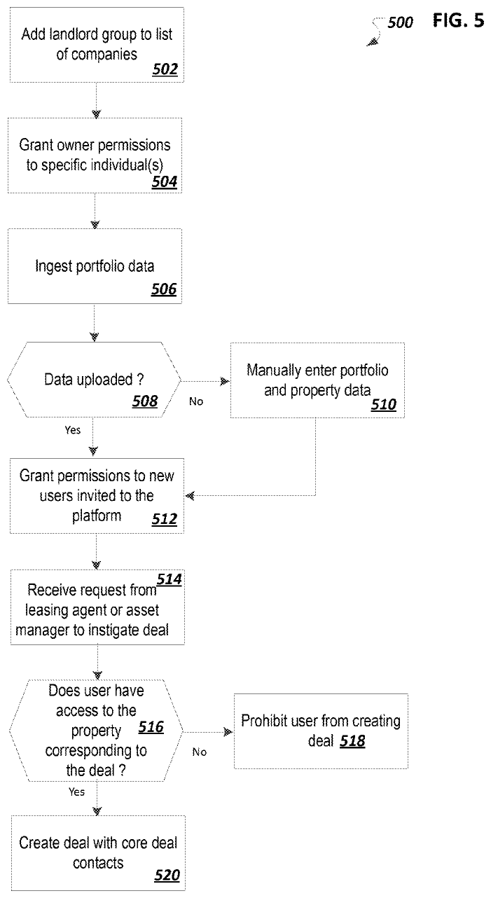

FIG. 4 illustrates an example system 400 for management of various activity phases. Various types of activities can occur for a company that uses the system. A company creation phase 402 can include a create company activity 404 performed by an administrator. The administrator can also use the system to perform an invitation sending activity 404 to a company owner. The company owner, in turn, can invite other users (e.g., a leasing team).

A property listing phase 408 can include an add portfolio activity 410 (which can be performed by an owner or a leasing team member). An add property activity 412 can be performed to add a property to the portfolio. An add listing activity 414 can be performed to create a listing for a property.

A deal creation and tracking phase 416 can include a deal creation activity 418. Once a deal is created, the deal can go through various stages or phases, including a tour stage 420, a proposal stage 422, a lease stage 424, a closing stage 426, and a revenue stage 428. Throughout the deal stages, various deal activities 430 can be performed. For instance, tasks 432 can be completed by various users, documents 434 can be uploaded and viewed, and other activities 436 can be performed, such as note creation, message sending, etc.

Some deals can result from a tenant inquiry. For example, after a property has been listed, the property can be determined to be a match for an inquiry in an inquiry creation stage 438. A tenant inquiry can be created that includes capturing tenant needs for a prospective property. Available properties that match the tenant inquiry information can be identified presented. Various activities can occur related to prospective properties that match the tenant inquiry. For example, tours can occur and proposals can be presented and discussed (the proposals can be, in some cases, less formal than proposals performed in more formal deal stages). A tenant may settle on one of the prospective/proposed properties, and a workflow can shift from tenant inquiry based to more formal deal proceedings, for the selected property.

FIG. 5 is a flowchart of an example method 500 for deal creation. It will be understood that method 500 and related methods may be performed, for example, by any suitable system, environment, software, and hardware, or a combination of systems, environments, software, and hardware, as appropriate. For example, one or more of a client, a server, or other computing device can be used to execute method 500 and related methods and obtain any data from the memory of a client, the server, or the other computing device. In some implementations, the method 500 and related methods are executed by one or more components of the system 100 described above with respect to FIG. 1. For example, the method 500 and related methods can be executed by the deal management engine 134 of FIG. 1.

At 502, a landlord group company is added to a list of companies defined in the system.

At 504, owner permissions are granted to specific individuals associated with the company.

At 506, portfolio data is ingested.

At 508, a determination is made as to whether data was successfully uploaded.

At 510, in response to determining that data was not successfully uploaded, portfolio and property data is manually entered into the system.

At 512, permissions are granted to new users who have been invited to the platform.

At 514, a request is received from a leasing agent user or an asset manager user to instigate a deal.

At 516, a determination is made as to whether the user has access to a property corresponding to the deal.

At 518, in response to determining that the user does not have access to the property, the user is prohibited from creating the deal.

At 520, in response to determining that the user has access to the property, the deal is created.

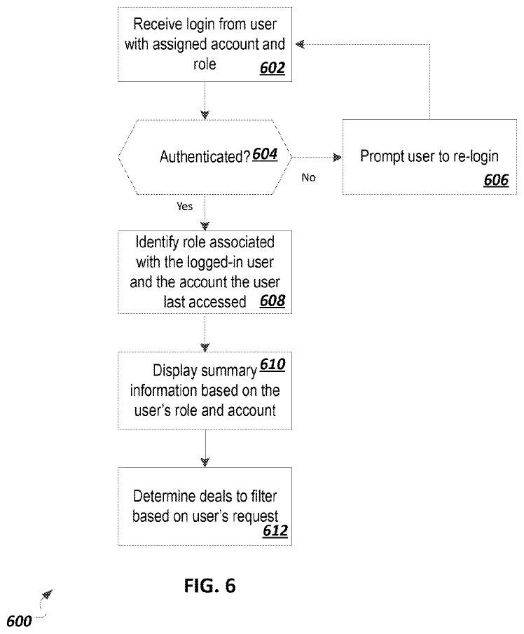

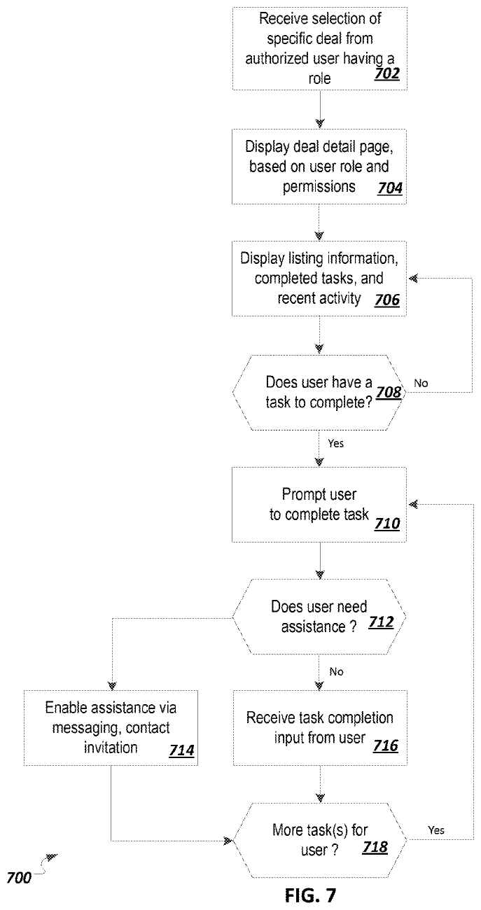

FIG. 6 is a flowchart of an example method 600 for enabling a user to view and interact with assigned deals. It will be understood that method 600 and related methods may be performed, for example, by any suitable system, environment, software, and hardware, or a combination of systems, environments, software, and hardware, as appropriate. For example, one or more of a client, a server, or other computing device can be used to execute method 600 and related methods and obtain any data from the memory of a client, the server, or the other computing device. In some implementations, the method 600 and related methods are executed by one or more components of the system 100 described above with respect to FIG. 1. For example, the method 600 and related methods can be executed by the deal management engine 134 of FIG. 1.

At 602, login information is received from a user who has an assigned account and an assigned role.

At 604, a determination is made as to whether the user is successfully authenticated based on the login information.

At 606, in response to an unsuccessful login, the use is prompted to re-login (e.g., attempt another login).

At 608, in response to a successful login, a role associated with the user and an account last accessed by the user are identified. Displaying information for a last accessed account or last accessed deal can be optional.

At 610, summary information is displayed based on the user's role and account.

At 612, deals to filter are determined based on a user request. Filtering can be optional.

FIG. 7 is a flowchart of an example method 700 for enabling a user to perform actions for a deal. It will be understood that method 700 and related methods may be performed, for example, by any suitable system, environment, software, and hardware, or a combination of systems, environments, software, and hardware, as appropriate. For example, one or more of a client, a server, or other computing device can be used to execute method 700 and related methods and obtain any data from the memory of a client, the server, or the other computing device. In some implementations, the method 700 and related methods are executed by one or more components of the system 100 described above with respect to FIG. 1. For example, the method 700 and related methods can be executed by the deal management engine 134 of FIG. 1.

At 702, selection of a specific deal is received from an authorized user who has a certain role. The user may be presented with a list of deals for which the user is authorized. The list of deals can be generated based on login information and authorization information obtained from a database, for example. The list of deals can include deals that are assigned to the user, or that are associated with the user based on the user's role at a particular company or organization, or for particular properties. The list of deals can be presented to the user and the user can select the specific deal from the list of presented deals.

At 704, a deal detail page is displayed, based on the user role and permissions.

At 706, listing information, completed tasks, and recent activity are displayed, in response to user inputs.

At 708, a determination is made as to whether the user has an assigned task to complete. For example, a query of assigned tasks can be performed to determine whether any completable tasks are assigned to a user. Completable tasks can be tasks that can be completed at the current time. Some tasks are dependent on other tasks, for example, and are marked in a database as completable once dependent task(s) have been completed. Some tasks can be performed in parallel with other tasks. Tasks can be assigned to a user by another user, for example, or automatically based on a set of rules.

In response to determining that the user does not have an assigned task to complete, at 706, listing information, completed tasks, recent activity, or other information remains displayed.

At 710, in response to determining that the user has an assigned task to complete, the user is prompted to complete the assigned task. The user can be prompted in a user interface, for example. As another example, the user may receive an electronic notification (using any suitable communication channel) in another application (e.g., an email application) or a pop-up message on a mobile device. If the notification is presented in another application or on a mobile device, the notification can include a link to access a user interface provided by the centralized system, for access to complete the assigned task.

At 712, a determination is made as to whether the user needs (or has requested) assistance with completing the assigned task.

At 714, in response to determining that the user needs (or has requested) assistance with the assigned task, assistance is enabled (e.g., using one or more of messaging or contact (e.g., other user) invitations.

At 716, after determining that the user does not need assistance, a task completion input is received from the user. The user can provide a task completion input using the user interface of the system, by performing one or more task actions in the user interface or by selecting a user interface control (e.g., a check box) that indicates task completion.

As another example, integration with other systems and operations can occur, to enable task completion, either in whole or in part, by or within outside or external applications. For instance, information may be provided to an external application about a task to be completed. Task information can be provided so that, for example, forms or other inputs of the external application can be populated using task information. Action(s) performed within or by an external application may be simple or detailed, and can be completed in the external application, either automatically or at least in part based on user input from the user. Once completed, a notification or additional action may be performed by the external application, such that the centralized system receives notification or information about the completed task (e.g., a confirmation of completion, or more detailed information, such as a generated or completed form for upload, etc.).

At 718, a determination is made as to whether the user has at least one additional assigned task associated with the selected deal.

In response to determining that the user has at least one additional assigned task associated with the selected deal, the user is prompted, at 712, to complete a next assigned task.

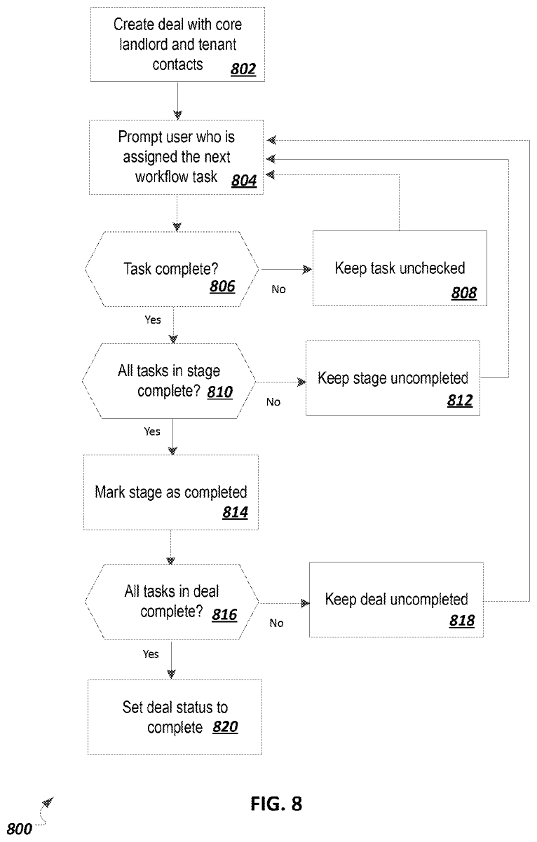

FIG. 8 is a flowchart of an example method 800 for a deal workflow. It will be understood that method 800 and related methods may be performed, for example, by any suitable system, environment, software, and hardware, or a combination of systems, environments, software, and hardware, as appropriate. For example, one or more of a client, a server, or other computing device can be used to execute method 800 and related methods and obtain any data from the memory of a client, the server, or the other computing device. In some implementations, the method 800 and related methods are executed by one or more components of the system 100 described above with respect to FIG. 1. For example, the method 800 and related methods can be executed by the deal management engine 134 of FIG. 1.

At 802, a deal is created and associated with a core landlord (e.g., owner) and tenant contacts (e.g., tenant representatives).

At 804, the user who is assigned a next workflow task is prompted to complete the task. As mentioned above, the user can be prompted in a user interface of the system or the user may receive an electronic notification in another application (e.g., an email application), or a pop-up message on a mobile device, etc. If the notification is presented in another application or on a mobile device, the notification can include a link to access a user interface provided by the centralized system, for access to complete the assigned task.

At 806, a determination is made as to whether the task has been completed. Task completion can occur as described above for FIG. 7, e.g., the user can provide user input(s) indicating that the task has been completed, the user can perform the task directly in the user interface whereby the system knows the task has been completed, or the system can receive a notification or information from another system or application that indicates that the task has been completed.

At 808, in response to determining that the task has not been completed, the task is maintained in an incomplete (e.g., unchecked) state.

At 810, in response to determining that the task has been completed, a determination is made as to whether all tasks in the current stage have been completed.

At 812, in response to determining that not all tasks in the current stage have been completed, the current stage is maintained in an uncompleted state.

At 814, in response to determining that all tasks in the current stage have been completed, the current stage is updated as completed, and a visual indicator associated with a completed status is marked or otherwise indicated.

At 816, a determination is made as to whether all tasks (e.g., all stages) in the deal have been completed.

At 818, in response to determining that not all tasks/stages in the deal have been completed, the deal is maintained in an uncompleted state.

At 820, in response to determining that all tasks/stages in the deal have been completed, a deal status is set to complete.

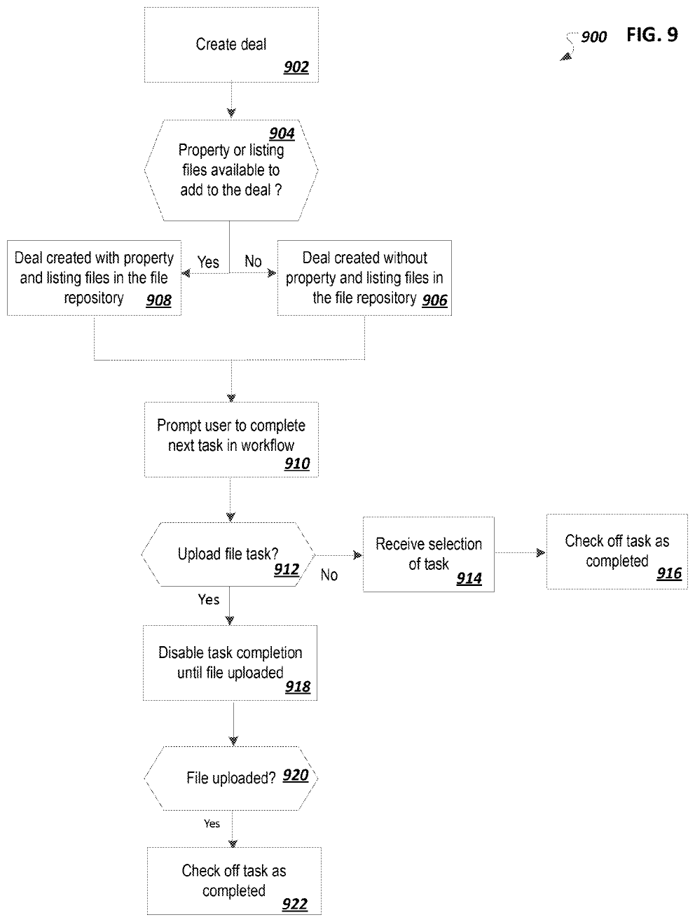

FIG. 9 is a flowchart of an example method 900 for processing deals that have file-related tasks. It will be understood that method 900 and related methods may be performed, for example, by any suitable system, environment, software, and hardware, or a combination of systems, environments, software, and hardware, as appropriate. For example, one or more of a client, a server, or other computing device can be used to execute method 900 and related methods and obtain any data from the memory of a client, the server, or the other computing device. In some implementations, the method 900 and related methods are executed by one or more components of the system 100 described above with respect to FIG. 1. For example, the method 900 and related methods can be executed by the deal management engine 134 of FIG. 1.

At 902, a deal is created in the system.

At 904, a determination is made as to whether property or listing files are available to add to the deal.

At 906, in response to determining that no property or listing files are available to add to the deal, the deal is created without property and listing files being included for the deal in the file repository.

At 908, in response to determining that at least one property or listing file is available to add to the deal, the deal is created as being associated with available property and/or listing file(s) that are included in the file repository.

At 910, a user is prompted to complete a next task in a workflow.

At 912, a determination is made as to whether the task is an upload-file task.

At 914, after determining that the task is not an upload-file task, a task-completion selection is received from the user for the task. As mentioned above, the user can provide user input(s) indicating that the task has been completed, the user can perform the task directly in the user interface, or the system can receive a notification or information from another system or application that indicates that the task has been completed

At 916, the task is marked as completed.

At 918, in response to determining that the task is an upload-file task, task completion is disabled until a file is uploaded for the task.

At 920, a determination is made as to whether a file has been uploaded for the task.

At 922, in response to determining that a file has been uploaded for the task, the task is marked as completed.

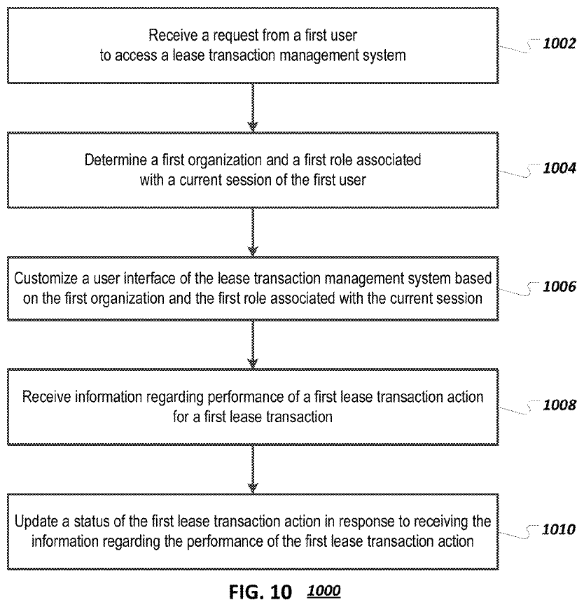

FIG. 10 is a flowchart of an example method 1000 for adaptive role-based leasing transaction management. It will be understood that method 1000 and related methods may be performed, for example, by any suitable system, environment, software, and hardware, or a combination of systems, environments, software, and hardware, as appropriate. For example, one or more of a client, a server, or other computing device can be used to execute method 1000 and related methods and obtain any data from the memory of a client, the server, or the other computing device. In some implementations, the method 1000 and related methods are executed by one or more components of the system 100 described above with respect to FIG. 1. For example, the method 1000 and related methods can be executed by the deal management engine 134 of FIG. 1.

At 1002, a request is received from a first user to access a lease transaction management system.

At 1004, a first organization and a first role associated with a current session of the first user are determined. The first organization can be a leasing agency, a property ownership group, or a tenant agency, to name a few examples. The first role can be a property owner, a leasing team member, or a tenant representative. The first user can have different roles for different organizations or properties. When the first user is associated with more than one organization, determining the first organization associated with the current session can include receiving selection of the first organization from the first user. As another example, the first organization can be determined based on a website address or a login identifier. The first role can be determined based on the first organization and user identifying information.

At 1006, a user interface of the lease transaction management system is customized based on the first organization and the first role associated with the current session. Customizing the user interface includes displaying information for lease transactions that the first user is authorized to view based on the first role and the first organization.

At 1008, information is received regarding performance of a first lease transaction action for a first lease transaction. For instance, a user input provided to the user interface can be received that indicates completion of the first lease transaction action. The first user can be currently assigned to the first lease transaction action and the user input can be received from the first user. As another example, information about performance of the first lease transaction action can be automatically received from an application. The application can be an email application, a calendar application, or another application that is external to the lease management system, in which the first lease transaction action was performed.

When the information regarding performance of the first lease transaction action indicates completion of the first lease transaction action, a next lease transaction action can be determined. At least one assigned user who is assigned to the next lease transaction action can be determined and a notification can be provided to the at least one assigned user regarding the next lease transaction action, such as in the user interface or using an electronic messaging system.

The first lease transaction action can be a last action of a first stage and determining the next lease transaction action can include: updating a stage status of the first stage to be completed, determining a next stage, and determining a first action of the next stage as the next lease transaction action. Stages can include tour, proposal, lease, closing, and revenue. When the first lease transaction action is a last action of a last stage, a status of the first lease transaction can be updated to be completed when information regarding completion of the first lease transaction action is received.

The first lease transaction action can be an uploading of a document to the lease transaction management system. The document can be a shared document, such as a lease, that is accessible by users who are associated with the first lease transaction. As another example, the document can be a team document, such as a proposal draft, that is accessible by members of a team that includes the first user. The document can be inaccessible by users of the lease transaction management system that are not included in the team. The team can be a leasing team, for example.

At 1010, a status of the first lease transaction action is updated in response to receiving the information regarding the performance of the first lease transaction action. For example, the updated status can be stored in the lease transaction management system. The updated status can be displayed in the user interface, to the first user and other users.

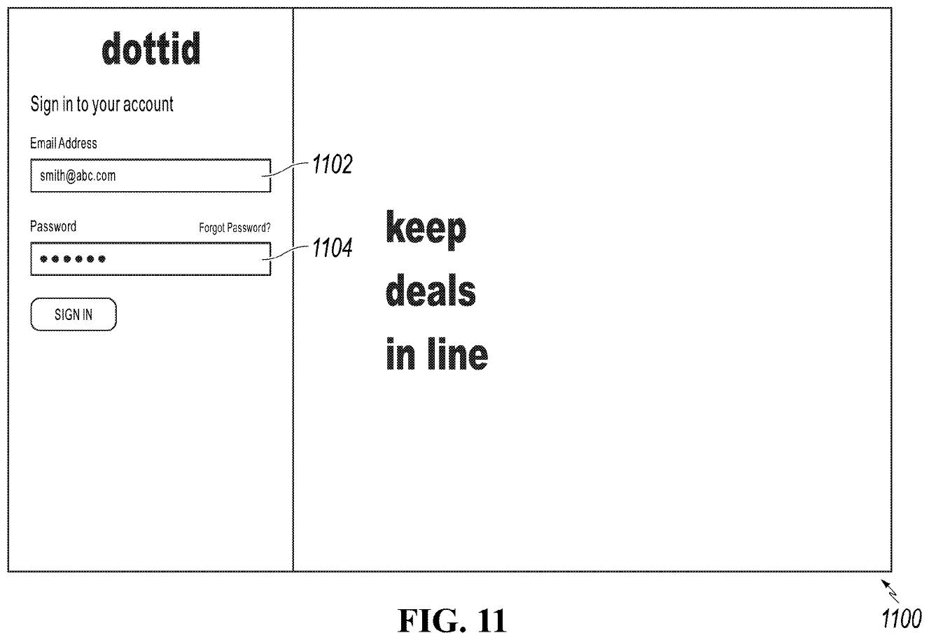

FIG. 11 illustrates an example login user interface 1100. A user can be authenticated before being granted access to the system. For instance, the login user interface 1100 can be presented, and a user can provide an email address 1102 and a password 1104. Users can obtain credentials after being invited to the system (by an administrator or an existing user).

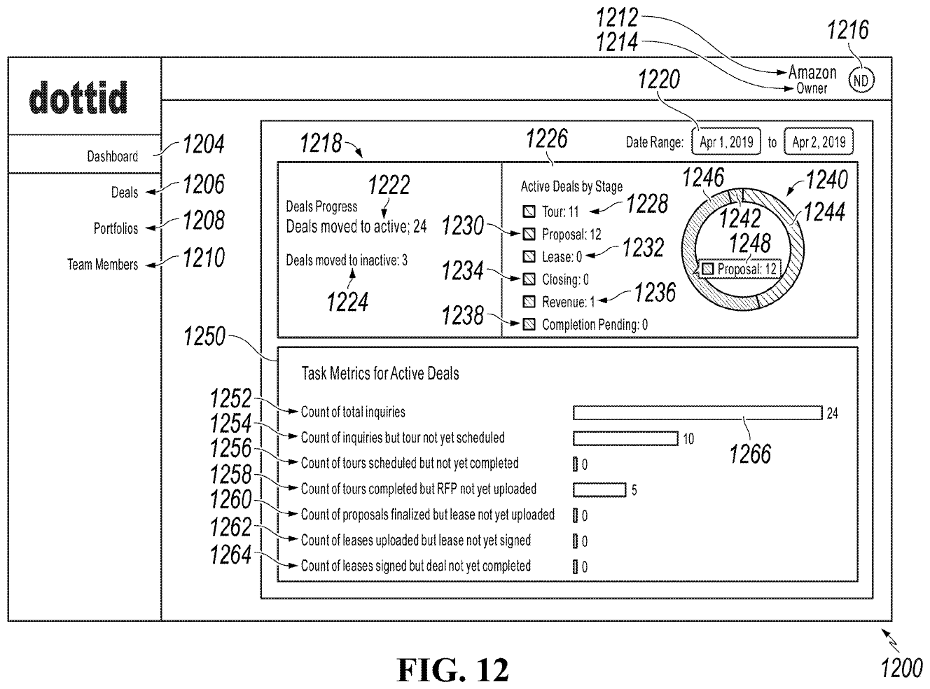

FIG. 12 illustrates an example dashboard user interface 1200. Upon being authenticated, the dashboard user interface 1200 can be presented. A navigation pane 1202 shows a selected dashboard item 1204. The user can navigate to other user interfaces by selecting a deals item 1206, a portfolios item 1208, or a team members item 1210. A company name 1212 (e.g., “Amazon”) of the logged-in user is displayed along with a role 1214 (e.g., owner) and initials 1216 of the user.

A deal progress pane 1218 includes deal status/progress information that can be filtered, for example, using date filter controls 1220. For instance, an active deal count 1222 and an inactive deal count 1224 respectively indicate that twenty four deals are now in an active state and three deals are in an inactive state.

A stage information area 1226 provides information regarding active deals by stage. For instance, an in-tour count 1228, an in-proposal count 1230, an in-lease count 1232, an in-closing count 1234, an in-revenue count 1236, and a completion-pending count 1238 collectively indicate that eleven deals are in the tour stage, twelve deals are in the proposal stage, and one deal is in the revenue stage.

A graphical indicator 1240 visually indicates stage counts and their relative proportion to other stage counts. For instance, an in-revenue portion 1242, an in-tour portion 1244, and an in-proposal portion 1246 correspond to the in-revenue count 1236, the in-tour count 1228, and the in-proposal count 1230, respectively. A popup count 1248 can appear when the user moves over the in-proposal portion 1246, for example.

A metrics pane 1250 shows task metrics for active deals. For instance, a first count 1252 indicates a count of total inquiries, a second count 1254 indicates a count of inquiries that haven't yet resulted in a tour, a third count 1256 indicates a count of tours scheduled but not yet completed, a fourth count 1258 indicates a count of tours completed that have not yet resulted in an upload of a proposal document, a fifth count 1260 indicates a count of finalized proposals where a lease hasn't yet been uploaded, a sixth count 1262 indicates a count of uploaded but unsigned leases, and a seventh count 1264 indicates a count of leases signed where deals have not yet been completed. Each count can have a graphical and numerical display. For instance, a bar chart 1266 graphically indicates a value for the first count 1252.

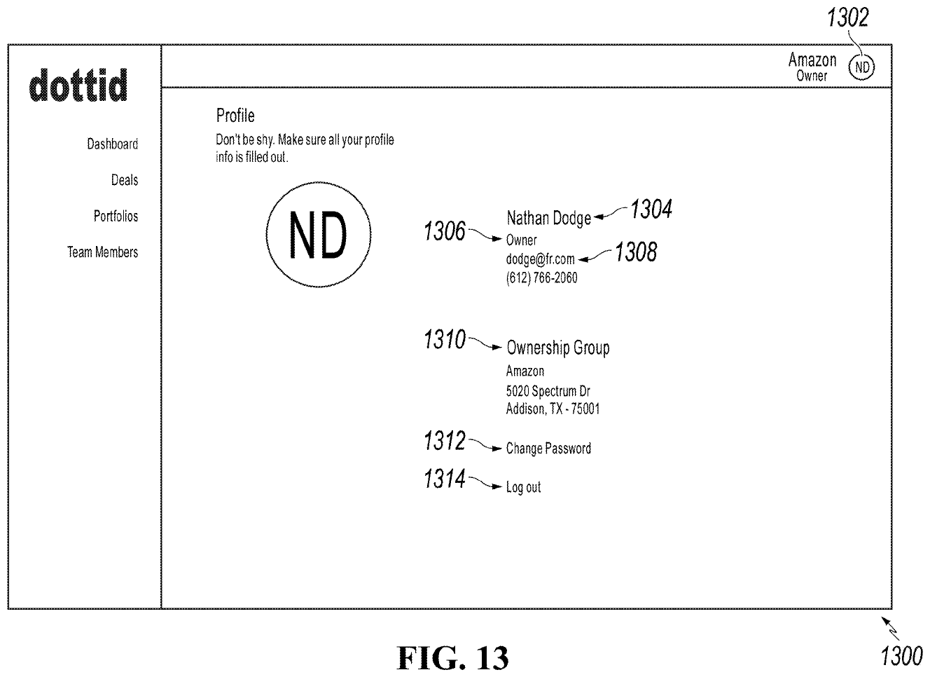

FIG. 13 illustrates an example profile information user interface 1300. The profile information user interface 1300 can be displayed in response to selection of a user initials 1302, for example. The displayed profile includes a user's name 1304, a user role 1306, user contact information 1308 (e.g., email, phone), and owner group information 1310 (e.g., owner name and address). Profile information can be edited using the profile information user interface 1300. The user can change a password using a change-password link 1312. The user can log out using a log out link 1314.

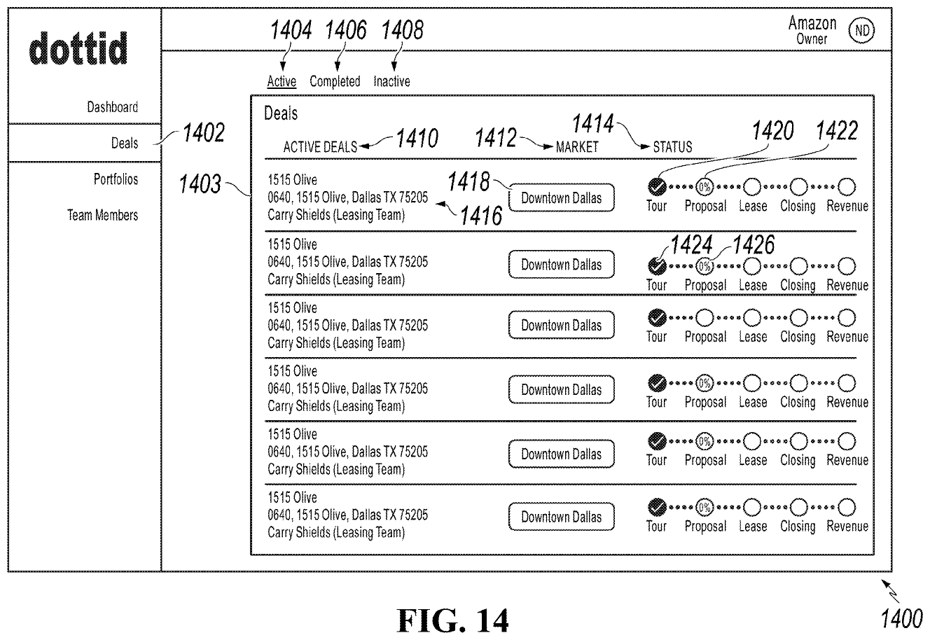

FIG. 14 illustrates an example deals user interface 1400. The deals user interface 1400 can be displayed in response to selection of a deals item 1402. Active, completed, or inactive deals can be displayed in a deals area 1403 by selecting an active link 1404, a completed link 1406, or an inactive link 1408, respectively. Currently, the deals area 1403 displays active deals. The deals area 1403 includes a deals column 1410, a market column 1412, and a status column 1414. The deals column 1410 shows property information for each deal.

For instance, a first row in the deals area 1403 is for a “1515 Olive, unit 0640” property 1416. The market column 1412 lists an applicable market for each deal's property. For instance, the “1515 Olive, unit 0640” property is in a “Downtown Dallas” market 1418. The status column 1414 depicts stage completion and stage progress for each deal. For instance, for the “1515 Olive, unit 0640” property, a tour-completed indicator 1420 indicates that the tour stage has completed and a proposal-progress indicator 1422 indicates that the proposal stage has just started. As another example, in a second row, a tour-completed indicator 1424 and a proposal-progress indicator 1426 respectively indicate that the tour stage has been completed and the proposal stage is 19% complete for a “1515 Olive, unit 0680” property.

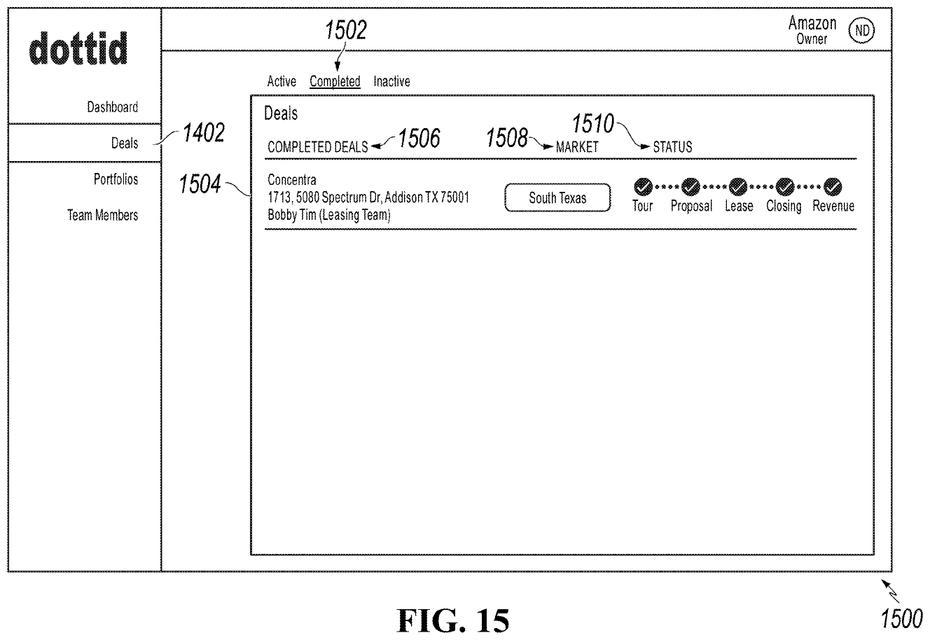

FIG. 15 illustrates an example completed-deals user interface 1500. The completed-deals user interface 1500 can be displayed in response to selection of a completed link 1502. A deals area 1504 displays information about completed deals. The deals area 1504 includes a deals column 1506, a market column 1508, and a status column 1510, which display property, market, and deal status/progress information, as described above.

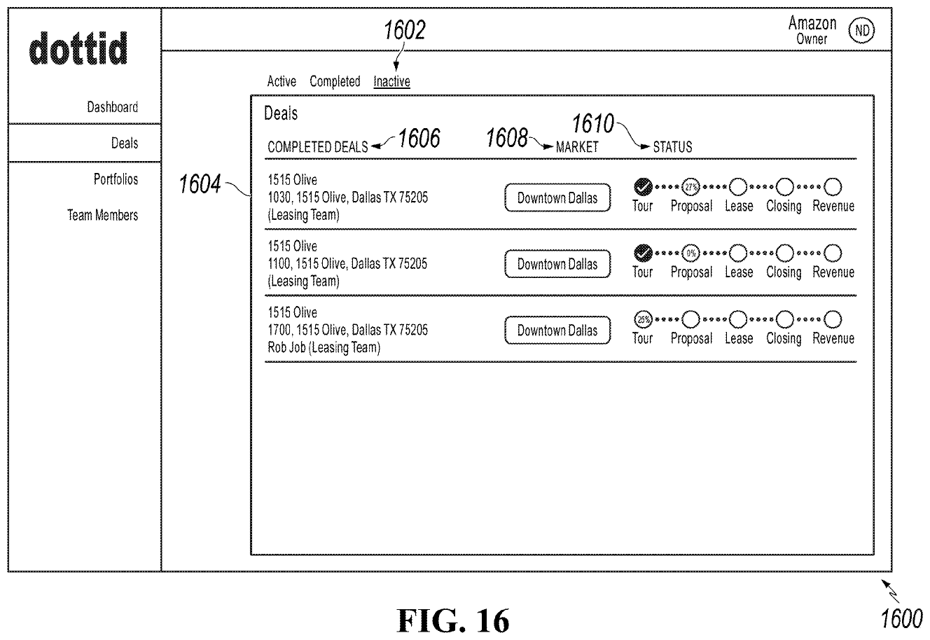

FIG. 16 illustrates an example inactive-deals user interface 1600. The inactive-deals user interface 1600 can be displayed in response to selection of an inactive link 1602. A deals area 1604 displays information about inactive deals. The deals area 1604 includes a deals column 1606, a market column 1608, and a status column 1610, which display property, market, and deal status/progress information, as described above.

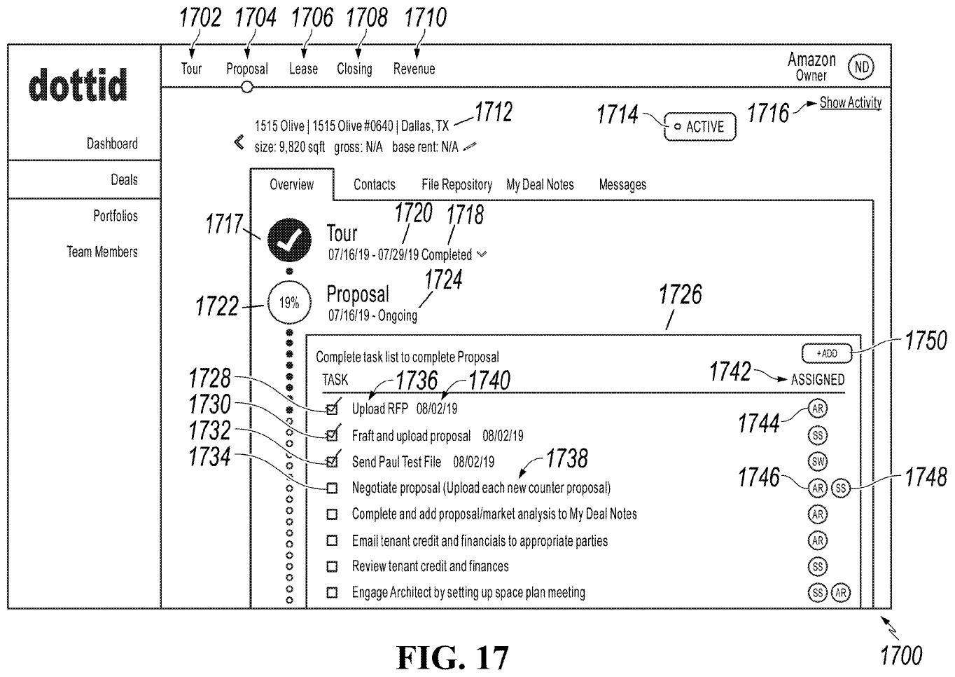

FIG. 17 illustrates an example deal detail user interface 1700. The deal detail user interface 1700 can be displayed in response to selection of a particular deal on the active, completed, or inactive deals user interfaces, for example. Stage links 1702, 1704, 1706, 1708, and 1710 enable a user to see information regarding tour, proposal, lease, closing, or revenue stages, respectively. A listing information area 1712 displays information (e.g., address, size, revenue, and rent information) for a listing associated with the deal. A deal status item 1714 displays a current status (e.g., active) of the deal, and can be used, upon selection, to change the current status to a different status (e.g., inactive). An activity link 1716 can be selected to show logged activity information related to the deal.

A tour stage status item 1717 indicates (e.g., based on a displayed check mark) that the tour stage has been completed for the deal, as does a tour-completed indicator 1718. A date range 1720 indicates date(s) during which tour-stage activities were performed. A proposal stage status item 1722 indicates a completion percentage (e.g., 179%) for the deal for the proposal stage. A date range 1724 indicates a start date and an ongoing status from the proposal stage.

A task area 1726 display task-completion statuses for the proposal stage. For instance, checked-off items 1728, 1730, and 1732 indicate that an upload RFP (Request for Proposal), a draft-and-upload-proposal, and a send file task have been completed. An unchecked item 1734 indicates that a negotiate proposal task has not yet been completed. The unchecked item 1734 is a topmost unchecked item and is therefore a next task. Other unchecked items indicate that other tasks remain for completion. Tasks in the task area 1726 have a task description (e.g., an “Upload RFP” description 1736, or a “Negotiate proposal . . . ” description 1738). Completed tasks are shown with a completion date (e.g., a Aug. 2, 2019 completion date 1740).

An assigned column 1742 displays user identifiers of members who have been assigned to a task. For instance, an indicator 1744 indicates that the user “AR” had been assigned to the completed task associated with the checked-off item 1728 and indicators 1746 and 1748 indicate the user “AR” and the user “SS” are assigned to the task associated with the unchecked item 1734. A new task can be added for the proposal stage by selecting an add button 1750.

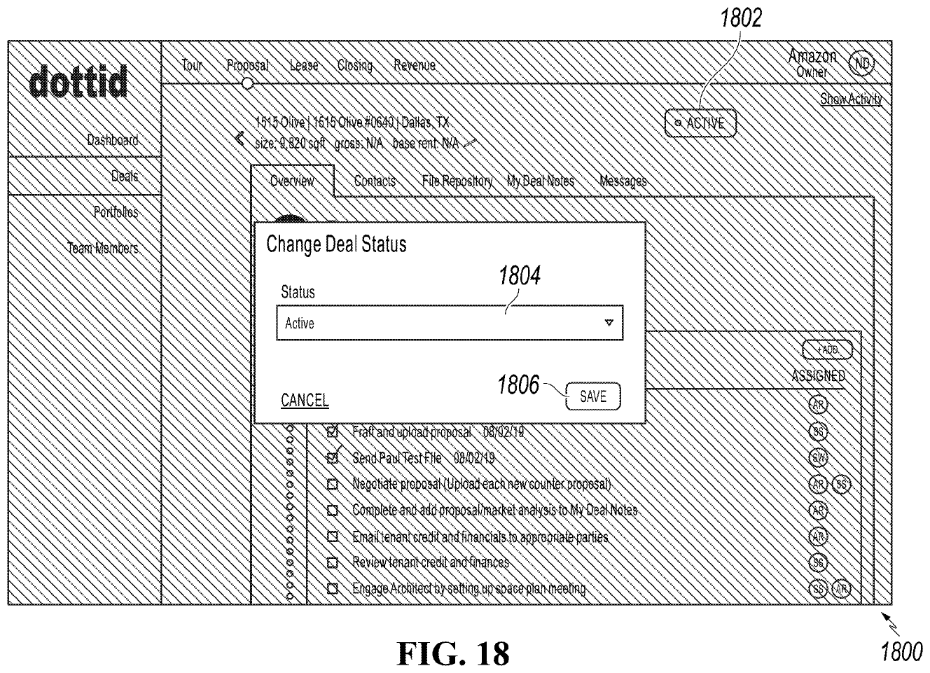

FIG. 18 is an example change deal status user interface 1800. The change deal status user interface 1800 can be displayed in response to selection of a deal status item 1802. The change deal status user interface 1800 includes a selection control 1804 that can be used to select a deal status. For instance, an active deal can be changed to an inactive status. As another example, an inactive deal can be changed to an active status. A status change can be saved by selecting a save button 1806.

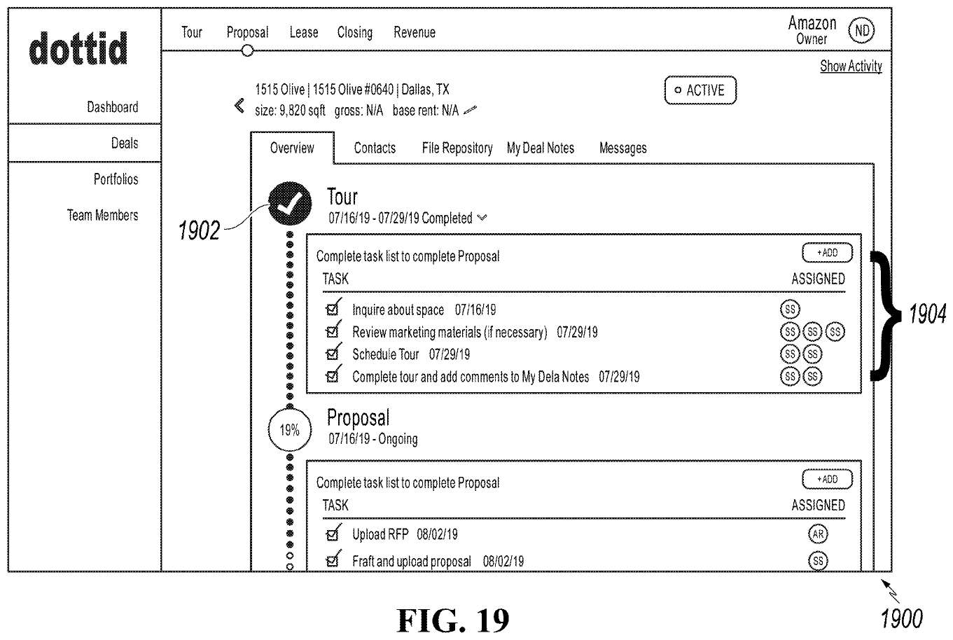

FIG. 19 is an example deal detail user interface 1900. When a deal detail user interface is initially displayed, completed stages may be displayed in a collapsed state. The user can select a stage status indicator 1902 to expand a collapsed stage area. In response to a previous selection of the stage status indicator 1902, a completed tasks area 1904 is displayed. The user can select the stage status indicator 1902 again to return the tour stage area to a collapsed state.

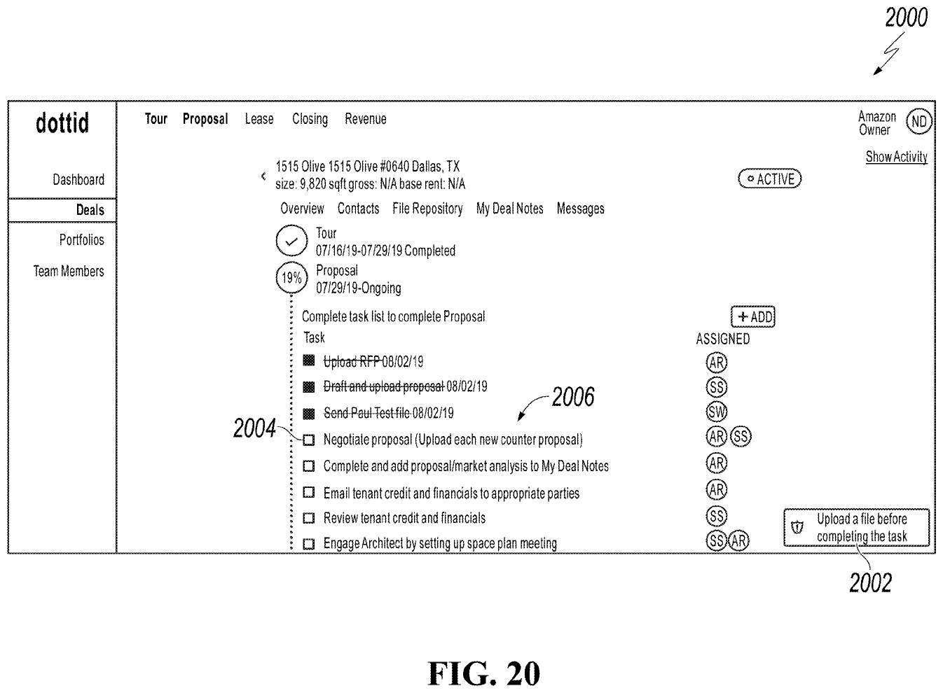

FIG. 20 illustrates an example deal detail user interface 2000. As mentioned, a user can select a check for an uncompleted task to indicate completion of the task. Some tasks can require that a document associated with the task be uploaded before the task can be marked completed. For such a task, the system can prevent the user from completing the task if the required document has not been uploaded. For instance, a check box can be disabled until the document has been uploaded. As another example, the system can display a warning message 2002 if the user selects, before uploading a document, a check box 2004, for a task that requires a document upload. To upload a document, the user can select a task description 2006.

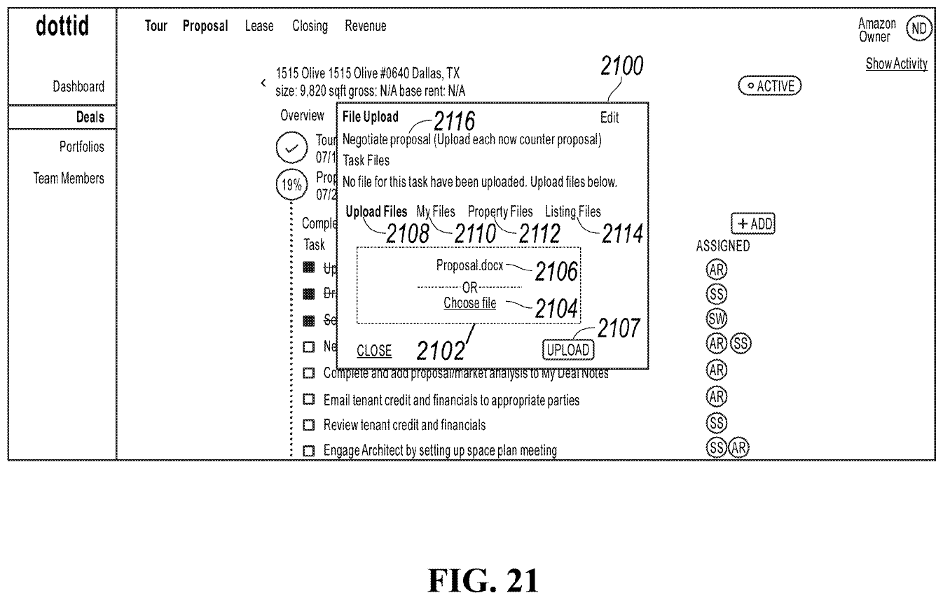

FIG. 21 illustrates an example file upload user interface 2100. The file upload user interface 2100 can be displayed in response to selection of a task that requires (or allows) a file upload, for example. The user can drag a file into a file area 2102 or can select a choose file link 2104, to select a file. For example, the user has selected a proposal document 2106.

The displayed file area 2102 is associated with an upload files tab 2108 that shows files that have been uploaded for a particular task. The file upload user interface 2100 can also display personal files for the current user in response to selection of a my-files tab 2110. Files associated with a property or a listing can be displayed in response to selection of a property-files tab 2112 or a listing files tab 2114, respectively.

In some implementations, the file upload user interface 2100 can display custom information or user interface elements that are particular to a certain type of file. For instance, the file upload user interface 2100 may have been displayed in response to selection of an “upload proposal” task. A checkbox 2116 can be displayed, to enable selection or deselection of an option relating to proposal negotiation (e.g., if the checkbox 2116 is selected, a new counter proposal may need to be uploaded each time a negotiating party responds to a current proposal). After the user has selected a file, the selected file can be uploaded by selecting an upload button 2107.

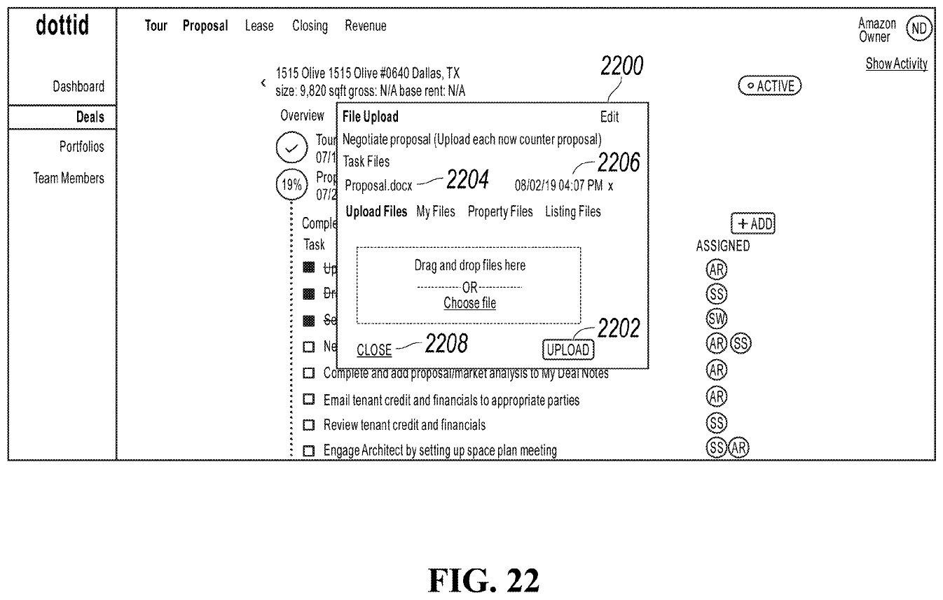

FIG. 22 illustrates an updated file upload user interface 2200. After the user has uploaded a selected file by selecting an upload button 2202, an uploaded file name 2204 is displayed in a task files area 2206. The user can close the updated file upload user interface 2200 using a close link 2208.

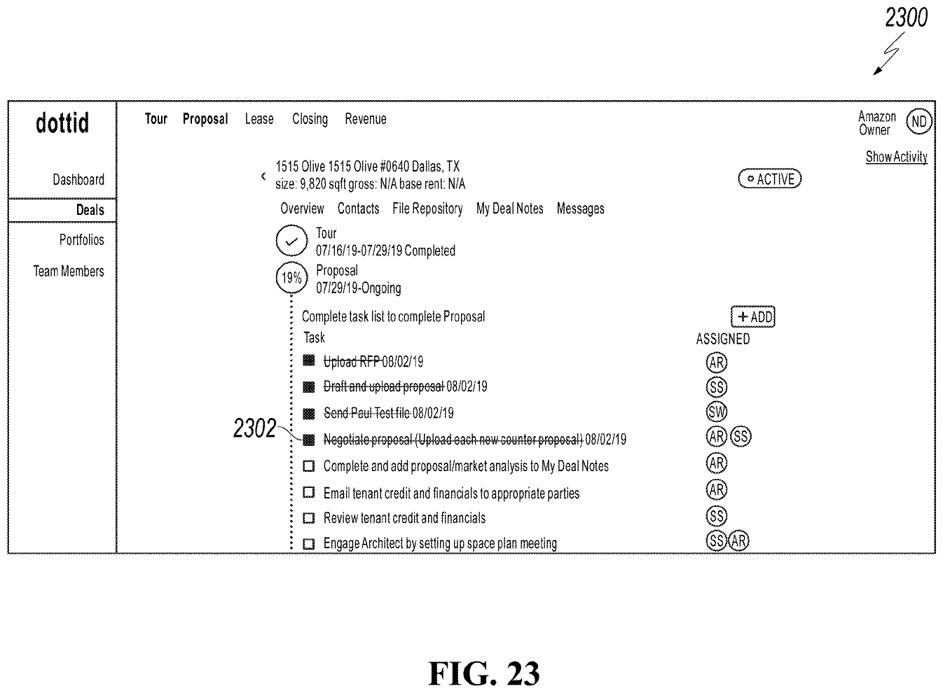

FIG. 23 is an example deal detail user interface 2300. After a user has uploaded a document required for a task, the system can enable the user to complete the task. For example, the user can now select a check box 2302 to complete a negotiate proposal task. In some implementations, the system automatically completes a task, without further user input, after a user uploads a document required for a task. The system can automatically check the check box 2302 (or otherwise display the check box 2302 as selected).

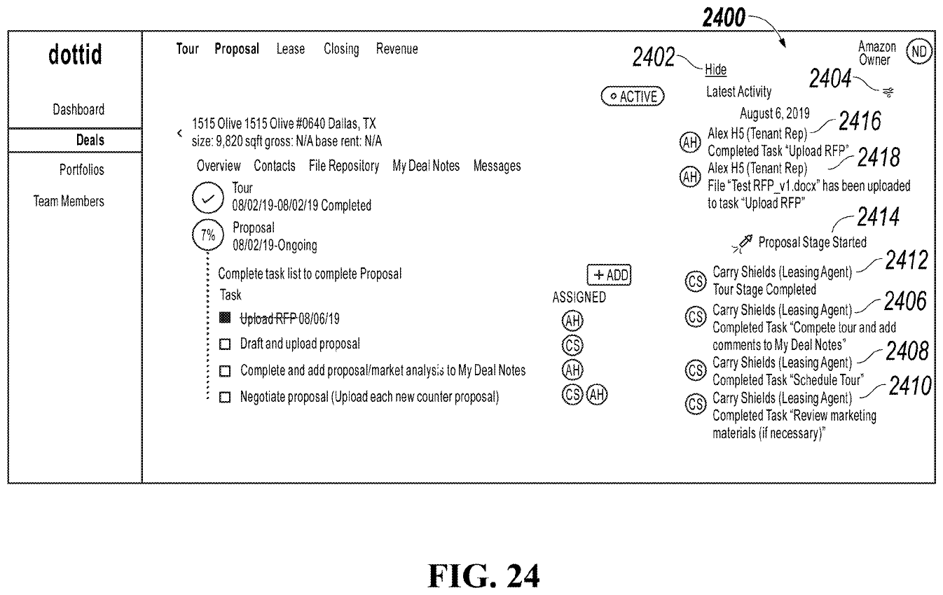

FIG. 24 illustrates an example activity pane 2400. The activity pane 2400 can be displayed in response to selection of a show activity link on a deal detail page, for example. The activity pane 2400 can be hidden again by selecting a hide link 2402. Activity can be filtered by a selected stage by selecting a filter control 2404. Activity entries 2406, 2408, and 2410 show activities that were performed in the tour stage. An activity entry 2412 indicates completion of the tour stage. An activity indicator 2414 indicates a start of the proposal stage. Activity entries 2416 and 2418 show activities that were performed in the proposal stage.

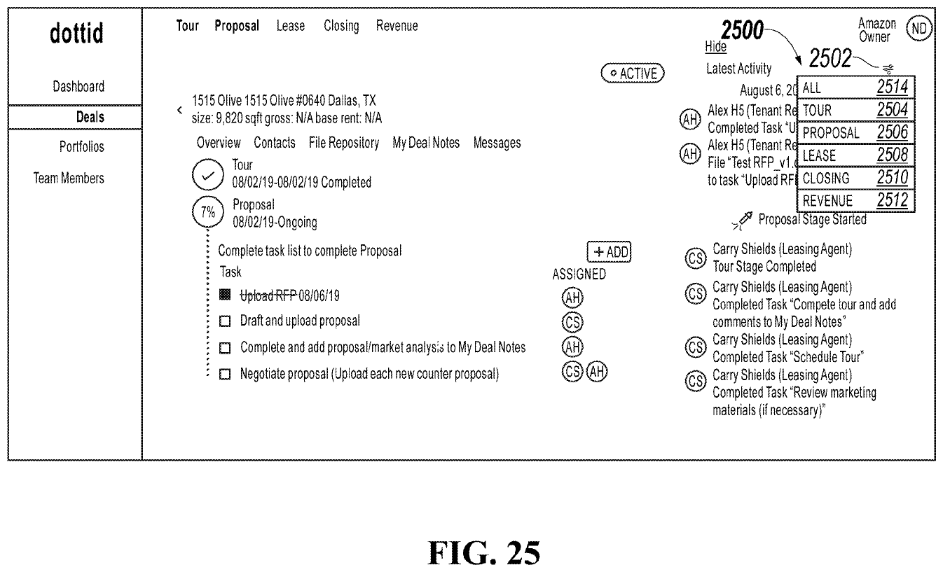

FIG. 25 illustrates filtering of activities. A filter dialog 2500 can be displayed in response to selection of a filter control 2502. The user can select a tour stage 2504, a proposal stage 2506, a lease stage 2508, a closing stage 2510, or a revenue stage to filter displayed activities by a selected stage. As another example, the user can select an “all” item to show activities for all stages (e.g., if a current view is filtered).

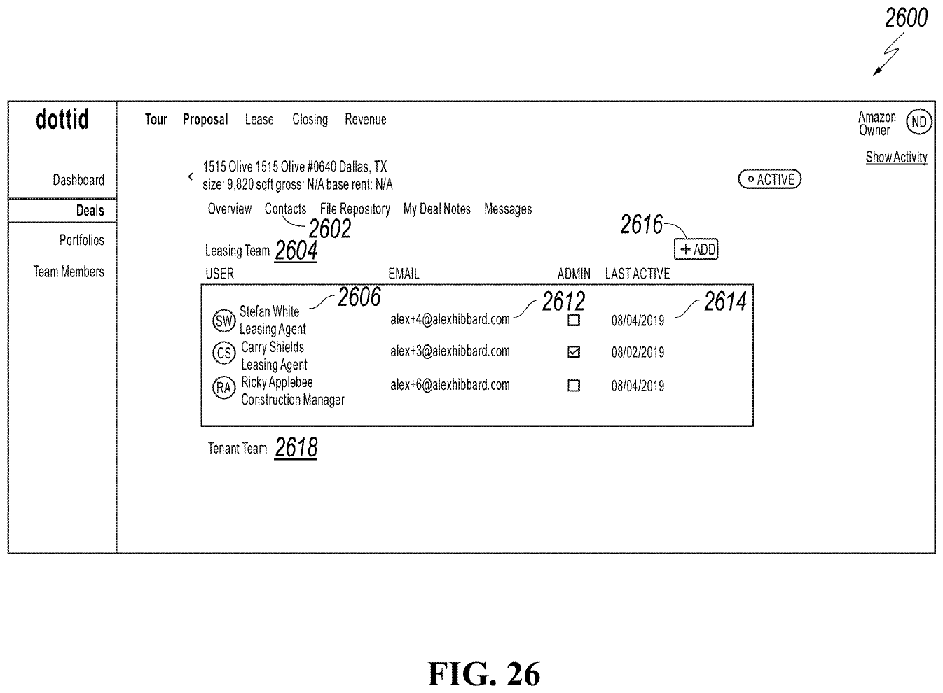

FIG. 26 illustrates a deals contacts user interface 2600. The deals contacts user interface 2600 can be displayed in response to selection of a contacts tab 2602. A leasing team area 2604 displays information for users who are on a leasing team for the selected deal. For each member of the leasing team, the following can be displayed: a user name (e.g., a user name 2606), an email address (e.g., an email address 2608), an administrator indicator (e.g., a non-administrator indicator 2610, an administrator indicator 2612), and a date of last activity (e.g., a date 2614). A user can be added to the leasing team by selecting an add button 2616. Other types of contacts can be displayed. For instance, tenant team members can be displayed in a tenant team area 2618 (e.g., which is partially displayed).

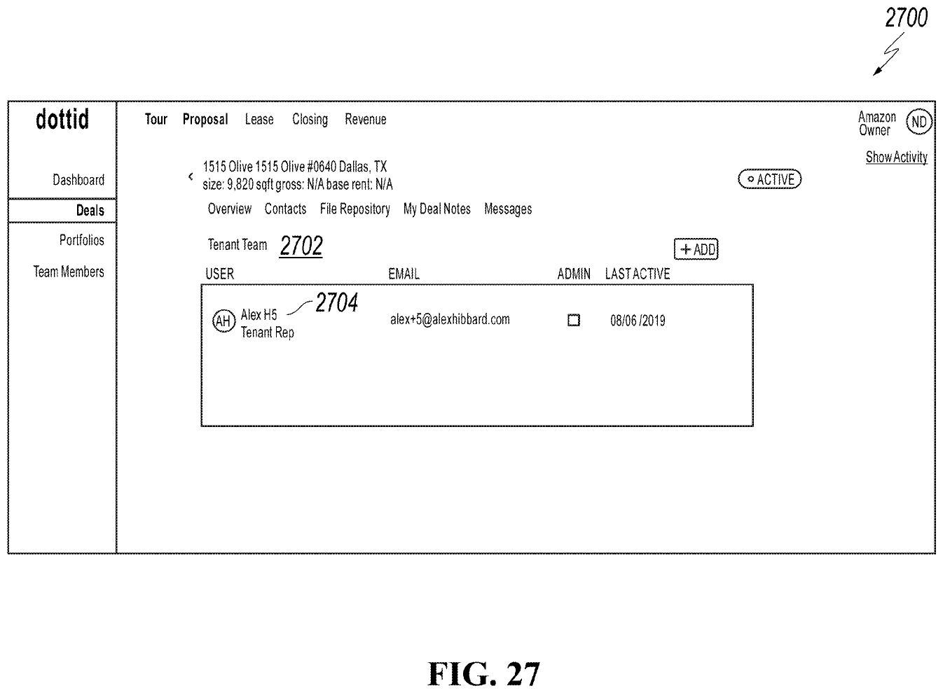

FIG. 27 illustrates a deals contacts user interface 2700. The deals contacts user interface 2700 includes a tenant team area 2702. The tenant team area 2702 includes a tenant team member 2704. The tenant team area 2702 does not include an add button. For example, the role (e.g., owner) of a currently logged in user may not enable adding of tenant team members. Adding of tenant team members can be enabled for a tenant representative, for example, but not for a user with an owner role.

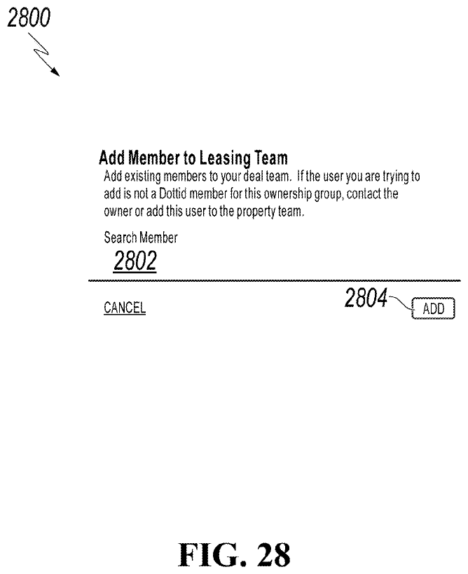

FIG. 28 is an example add team member dialog 2800. The add member dialog can be used to add existing members to a deal team. A search box 2802 can be used to search for a member. An add button 2804 can be used to add the member to the deal team.

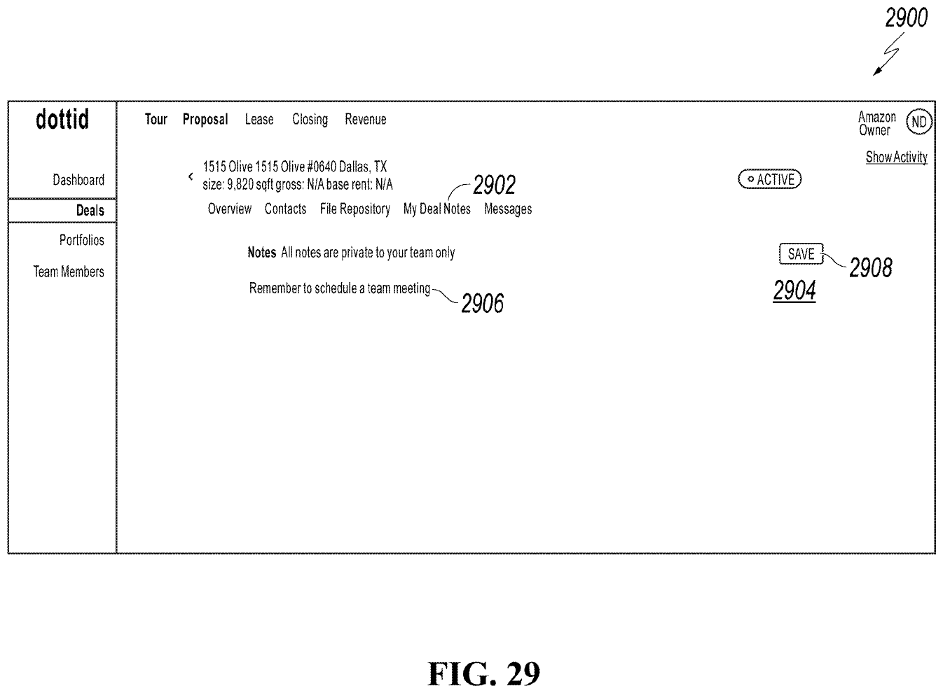

FIG. 29 is an example deal notes user interface 2900. The deal notes user interface can be displayed in response to selection of a deal notes tab 2902. Deal notes can be entered and displayed in a notes area 2904. The notes area 2904 currently displays a note 2906. Entered notes can be saved by selecting a save button 2908. As described below, deal notes can also include team documents.

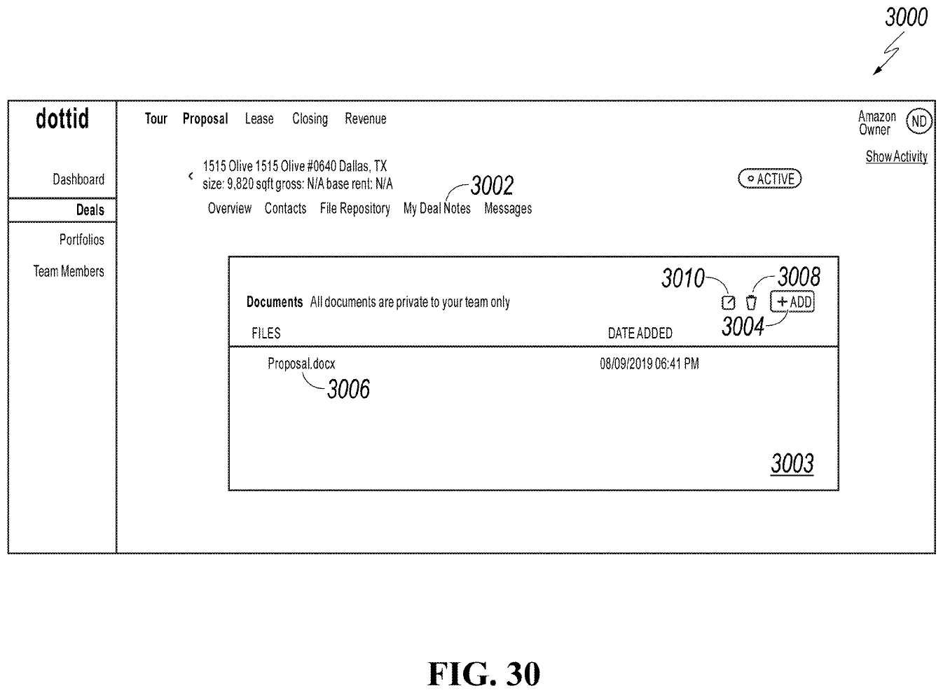

FIG. 30 is an example deal notes user interface 3000. The deal notes user interface can be displayed in response to selection of a deal notes tab 3002. The deal notes user interface 3000 can enable uploading and sharing of team documents that can be seen only by members of a deal team. A team document can be added to a document area 3003 by selecting an add button 3004. For instance, a draft proposal document 3006 has been added as a team document. A team document can be deleted by selecting a delete control 3008. A team document can be shared by selecting a share control 3010.

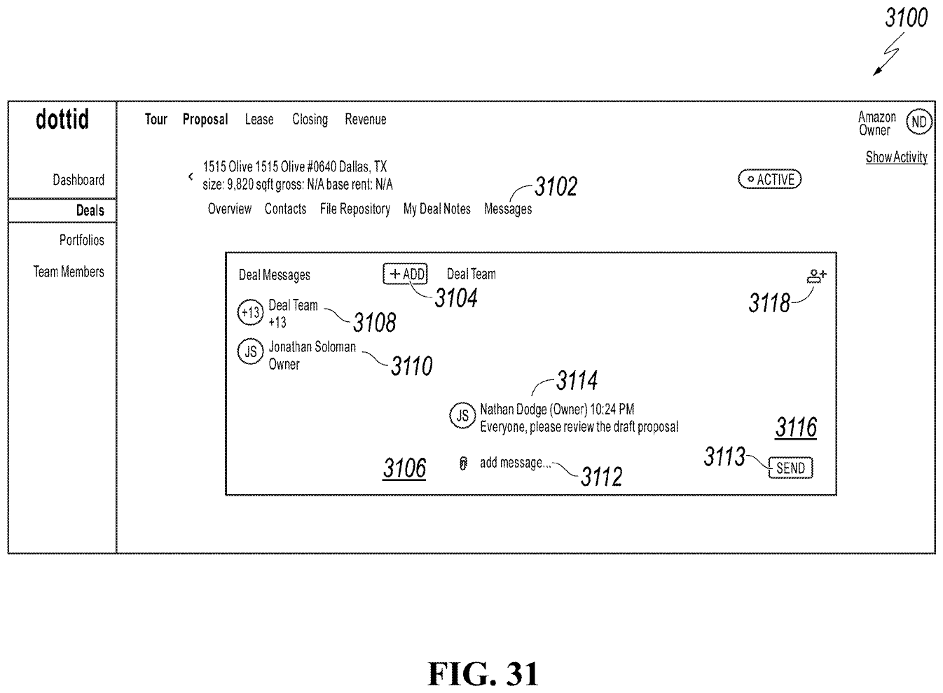

FIG. 31 is an example deal message user interface 3100. The deal notes user interface 3100 can be displayed in response to selection of a messages tab 3102. Message participants can be added by selecting an add button 3104. A participant (or participant list) can be selected in a participants area 3106. For example, a deal team participant list 3108 has been selected. The participants area 3106 also includes a participant 3110. A message can be composed in a composition area 3112 and sent by selecting a send button 3113. Previously sent messages, including a message 3114, are shown in a messages area 3116. Deal members included in a particular chat can be edited using an edit control 3118.

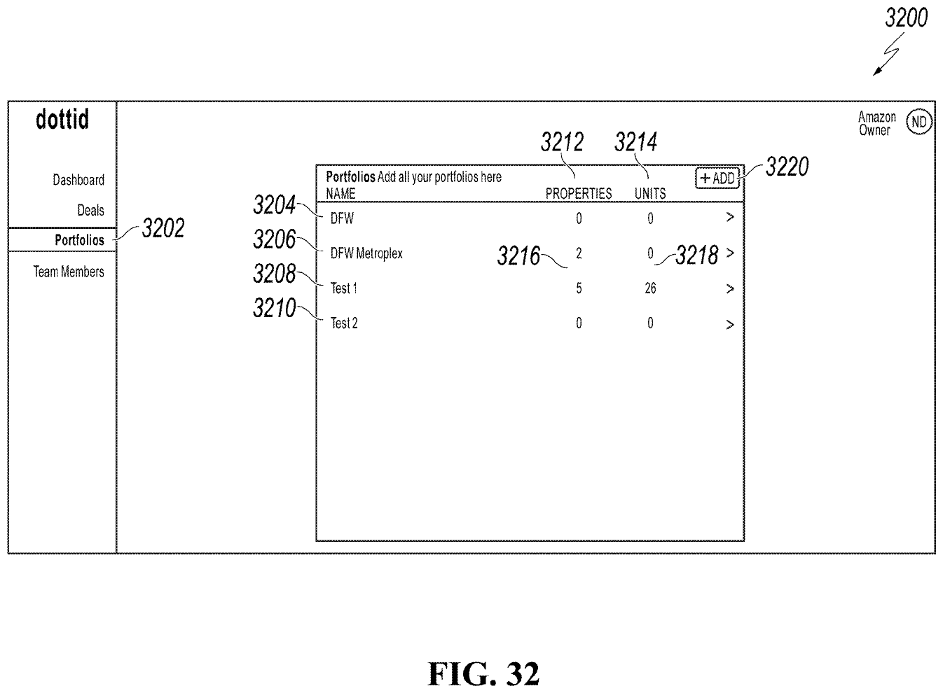

FIG. 32 is an example portfolio list user interface 3200. The portfolio list user interface 3200 can be displayed in response to selection of a portfolios tab 3202. The portfolios list user interface 3200 lists portfolios 3204, 3206, 3208, and 3210. For each listed portfolio, a properties count 3212 and a unit count 3214 are displayed. For example, the portfolio 3208 has a property count 3216 of five and a unit count 3218 of twenty six. A portfolio can be added by selecting an add button 3220.

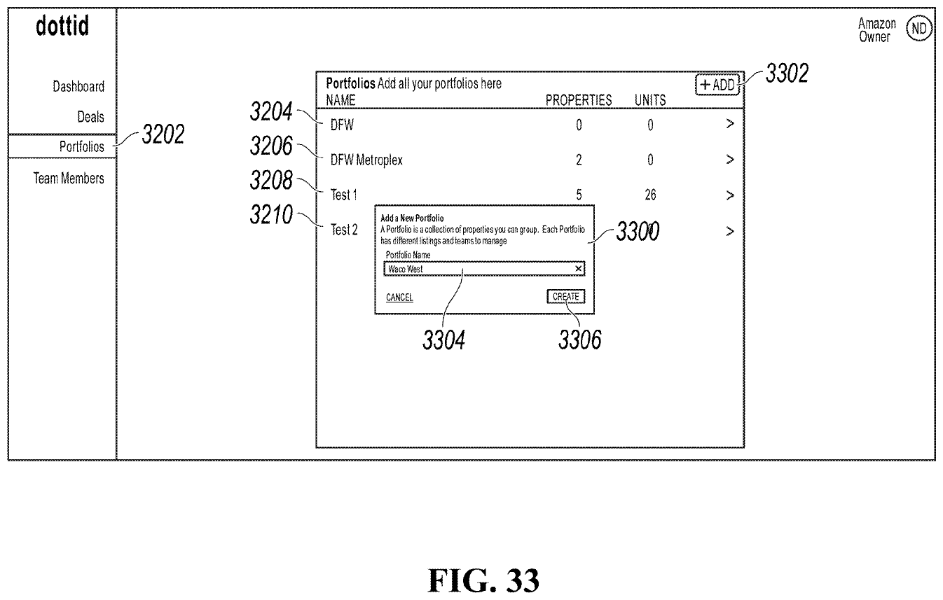

FIG. 33 illustrates an example add portfolio user interface 3300. The add portfolio user interface 3300 can be displayed in response to selection of an add portfolio button 3302, for example. A portfolio name can be entered using a name entry area 3304. The portfolio can be created by selecting a create button 3306.

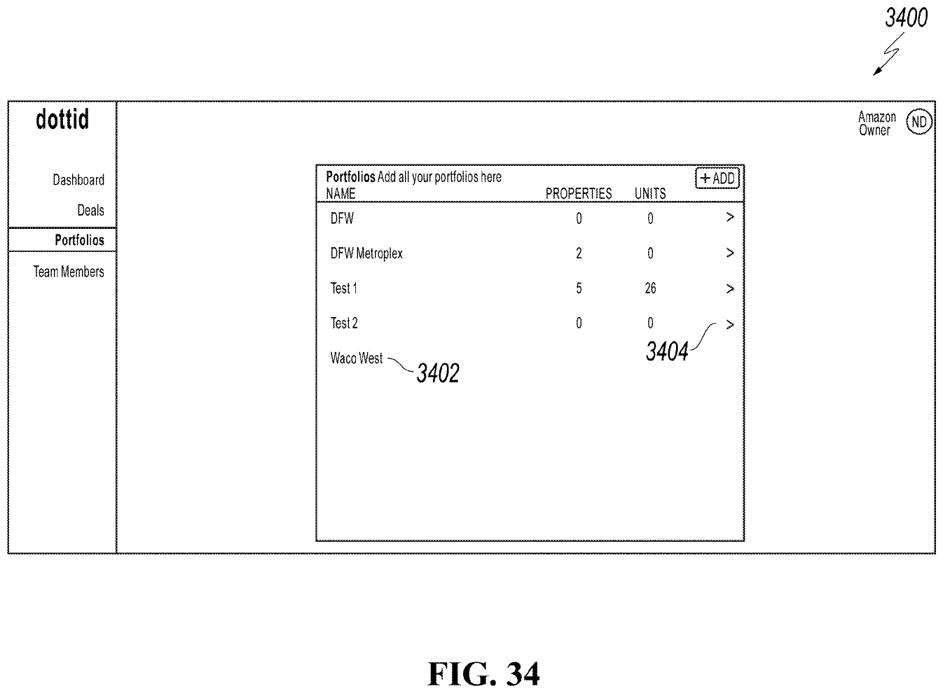

FIG. 34 illustrates an example portfolio list user interface 3400. The portfolio list user interface 3400 now includes a recently-added portfolio 3402. A portfolio detail interface can be displayed to view details of the portfolio 3402 by selecting the portfolio 3402 and/or by selecting a view details control 3404.

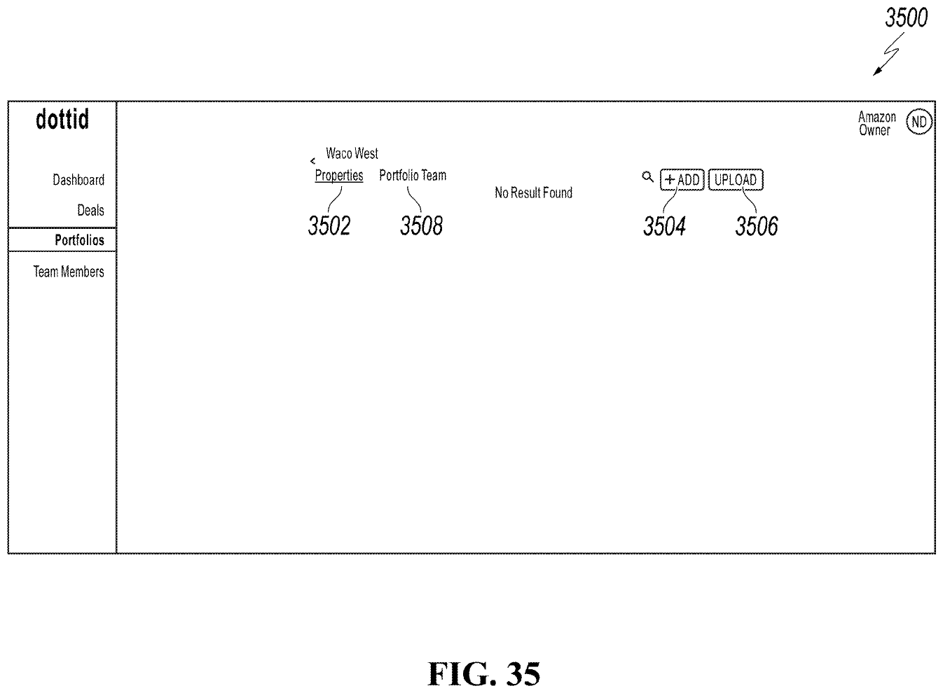

FIG. 35 is an example portfolio detail user interface 3500. The portfolio detail user interface 3500 can be displayed when a portfolio is selected on a portfolio list user interface, for example. Properties included in the portfolio can be viewed by selecting a properties tab 3502. The currently displayed portfolio does not include any properties. Properties can be added by selecting a add property button 3504. Properties can be added based on an uploaded document (e.g., a CSV (Comma Separated Values) file, by selecting an upload button 3506. Portfolio team members for the portfolio can be viewed by selecting a portfolio team tab 3508.

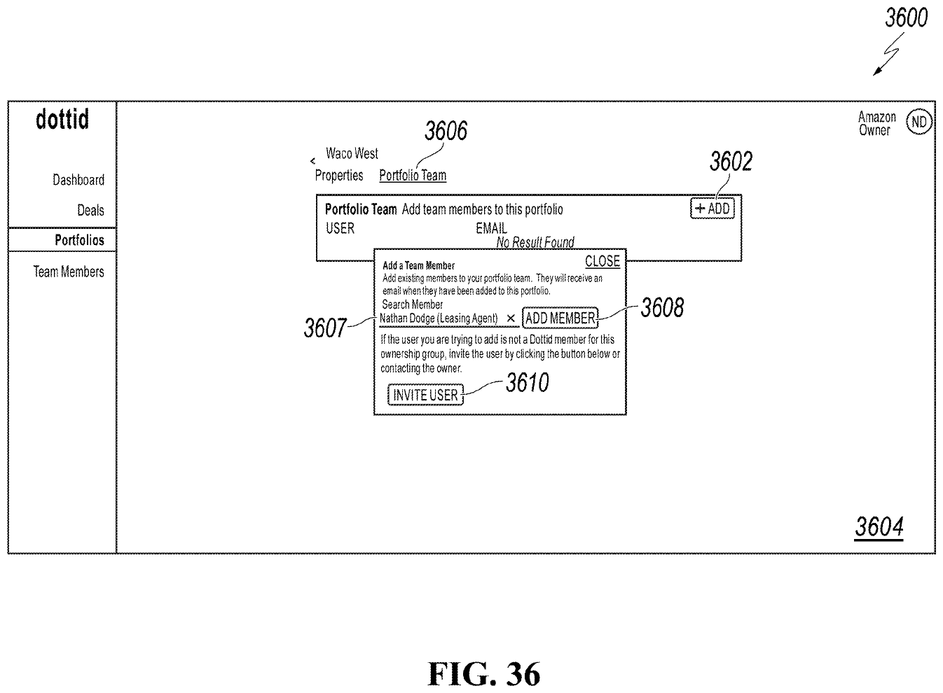

FIG. 36 illustrates an example add portfolio team member user interface 3600. The add portfolio team member user interface 3600 can be displayed in response to selection of an add portfolio team member button 3602 on a portfolio team user interface 3604. The portfolio team user interface 3604 can be displayed in response to selection of a portfolio team tab 3606. The add portfolio team member user interface 3600 includes a search box 3607 which can be used to search for and identify an existing user. The identified user can be added to the portfolio team by selecting an add button 3608. If a user is not currently a system member, the user can be invited to join the system by selecting a join button 3610.

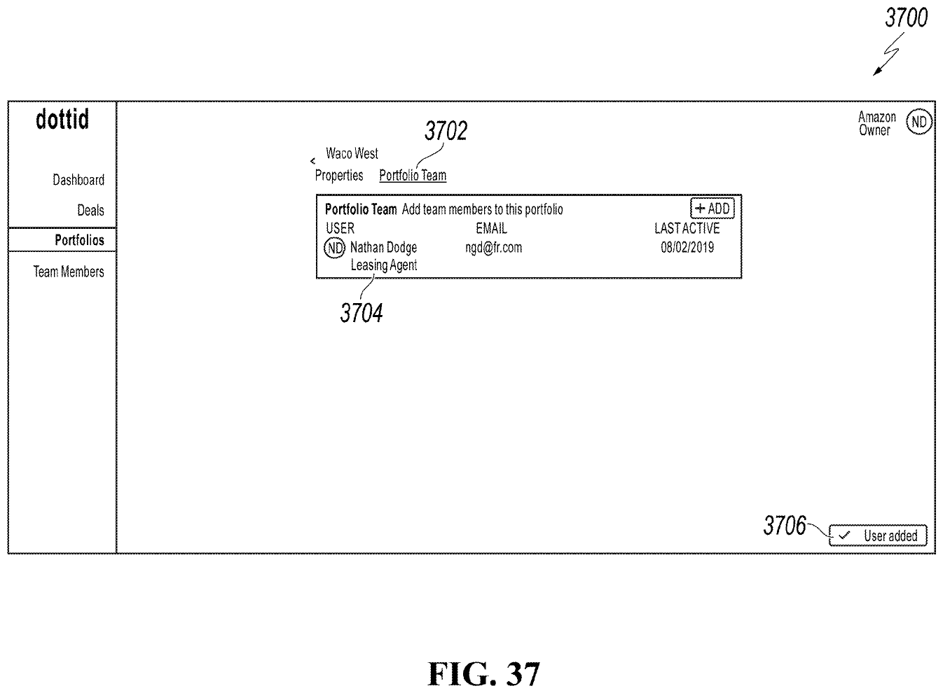

FIG. 37 is an example portfolio team user interface 3700. The portfolio team user interface 3700 includes a member list 3702 that includes a recently-added portfolio team member 3704. A message 3706 confirms that the portfolio team member 3704 was successfully added to the portfolio team.

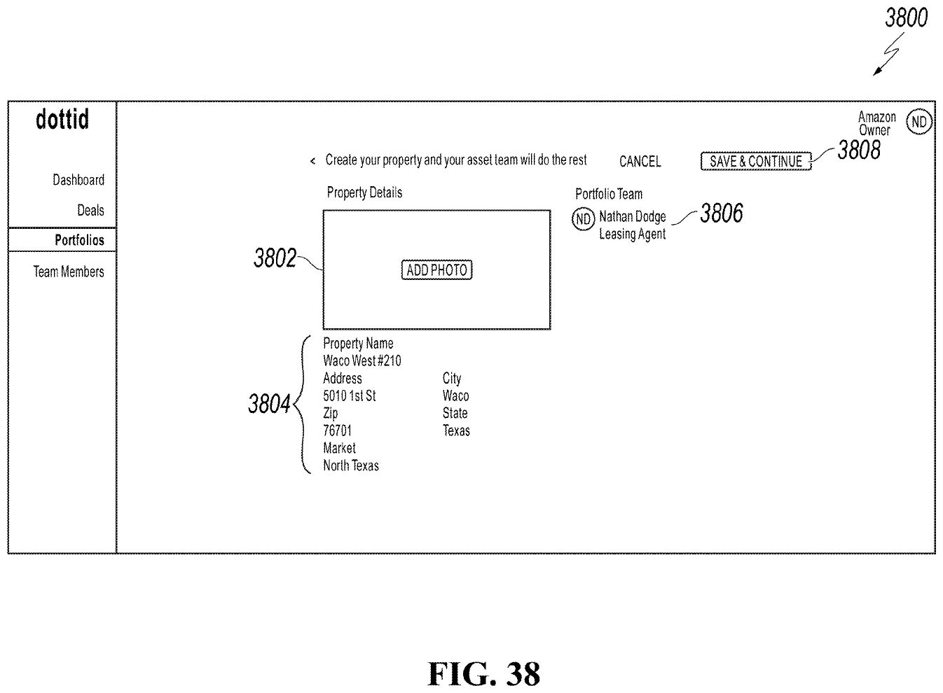

FIG. 38 is an example add property user interface 3800. The add property user interface 3800 can be used to add a property to a portfolio. A photo of the property can be added using an add photo control 3802. Property details 3804, including a property name, address, and market, can be entered. Current portfolio team members for the portfolio to which the property is to be added are displayed in a portfolio team area 3806. Entered/added information can be saved, and the property can be added to the portfolio, by selecting a save button 3808.

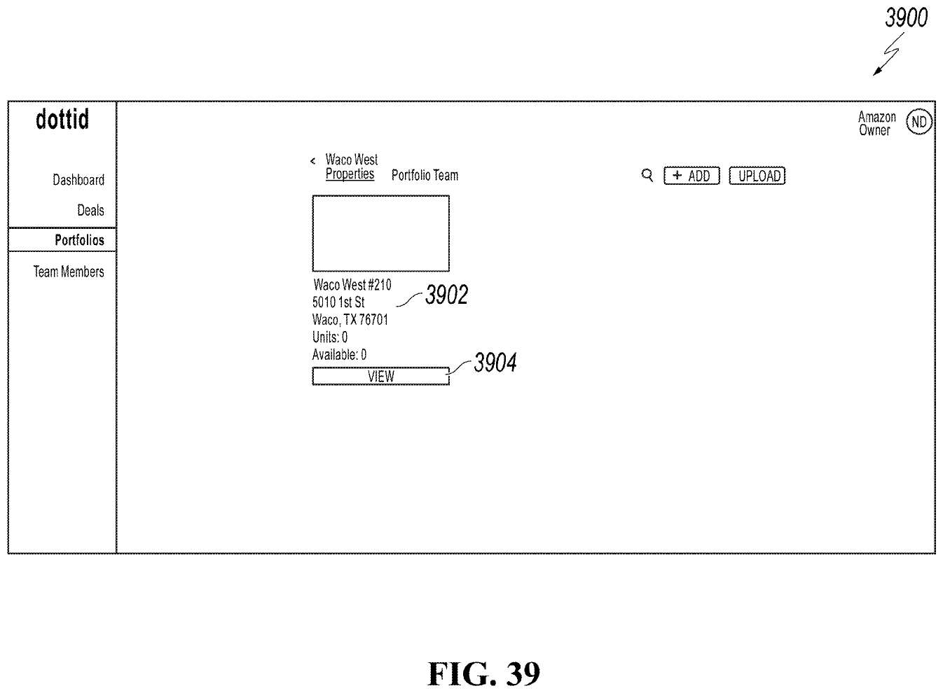

FIG. 39 is an example portfolio detail user interface 3900. The portfolio detail user interface 3900 now lists a property 3902 in a properties list. Details regarding the property can be displayed by selecting a view button 3904.

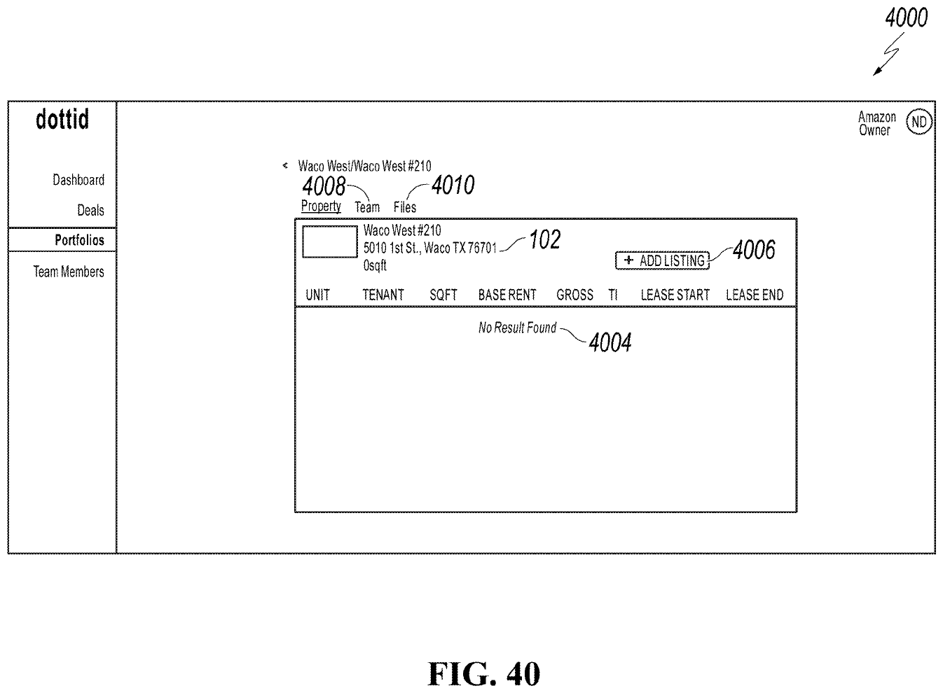

FIG. 40 is an example property detail user interface 4000. The property detail user interface includes a property information area 4002 that displays property name, address, and size information. A listing list displays listings for the property (currently there are no listings for the displayed property, as indicated by a note 4004). A listing can be added by selecting an add listing button 4006. A property team can be displayed by selecting a team tab 4008. Files associated with the property can be displayed by selecting a files tab 4010.

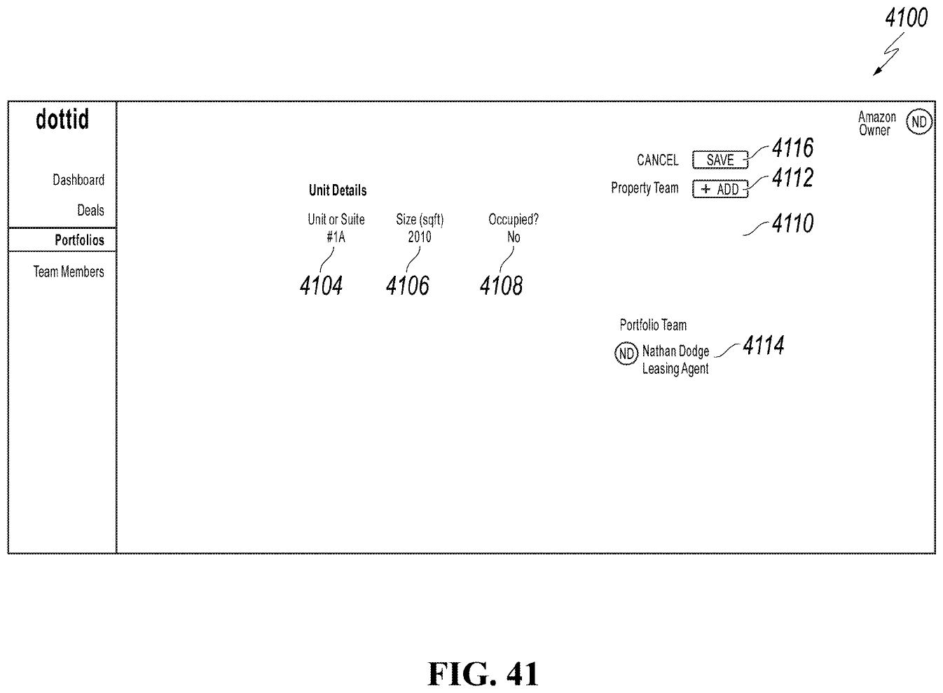

FIG. 41 is an example add listing user interface 4100. The add listing user interface 4100 can be used to add a listing for a property. Unit details can be entered in a unit details area 4102. Unit details can include, for example, a unit identifier 4104, a unit size 4106, and a unit occupancy status 4108. Property team members are displayed in a property team area 4110. Members can be added to the property team using an add button 4112. Portfolio team members are displayed in a portfolio team area 4114. Listing information can be saved by selecting a save button 4116.

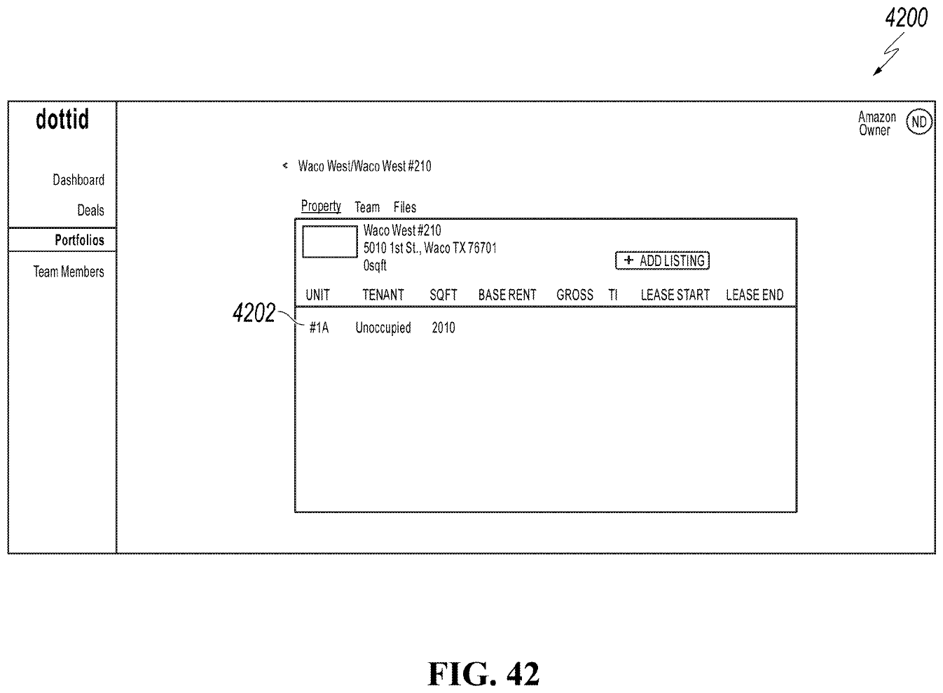

FIG. 42 is an example property detail user interface 4200. The property detail user interface now displays a recently-added listing 4202. The recently-added listing can be selected to have a listing detail user interface displayed.

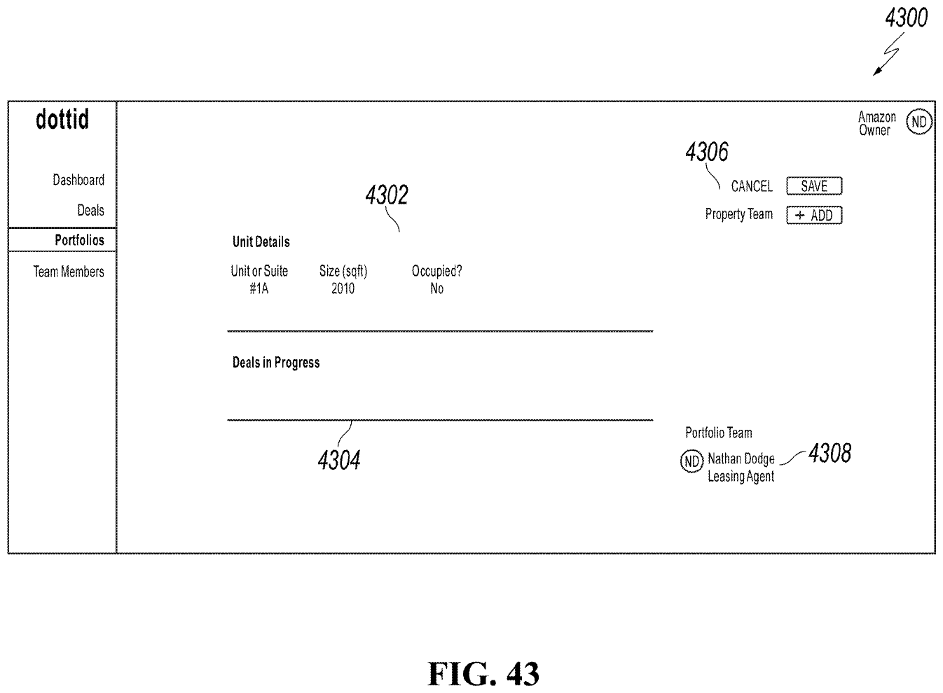

FIG. 43 is an example listing detail user interface 4300. The listing detail user interface 4300 includes a unit details area 4302 that displays information for the listed unit. A deals area 4304 shows deals in progress (if any) for the listing. A property team area 4306 can be used to view or add property team members. A portfolio team area 4308 displays portfolio team members.

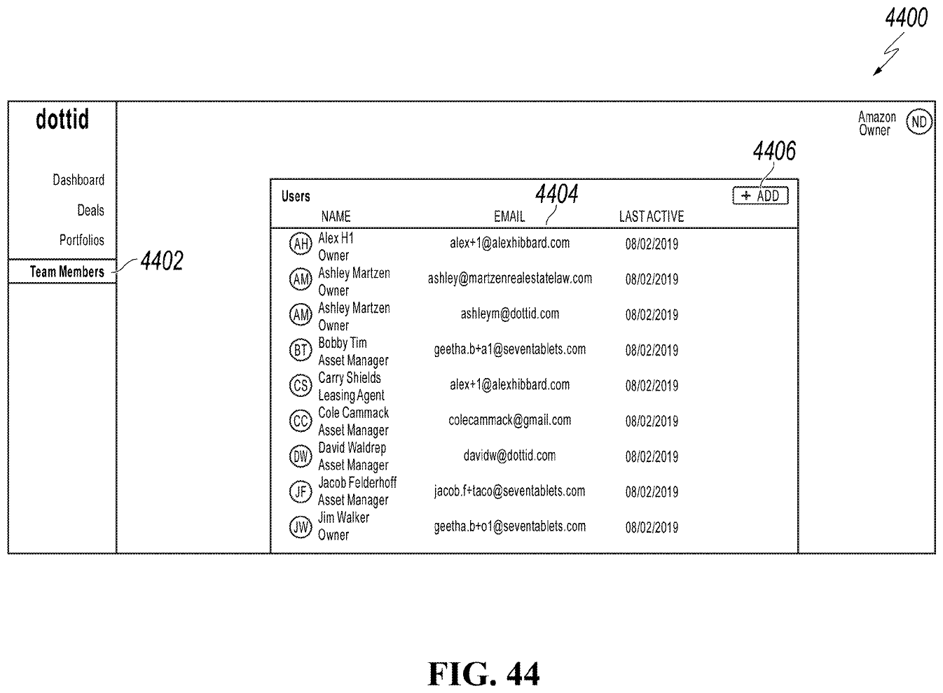

FIG. 44 is a team members user interface 4400. The team members user interface 4400 can be displayed in response to selection of a team members tab 4402. A team member list 4404 displays information for teach team member (e.g., name, email, date of last activity). A new team member can be added by selecting an add button 4406.

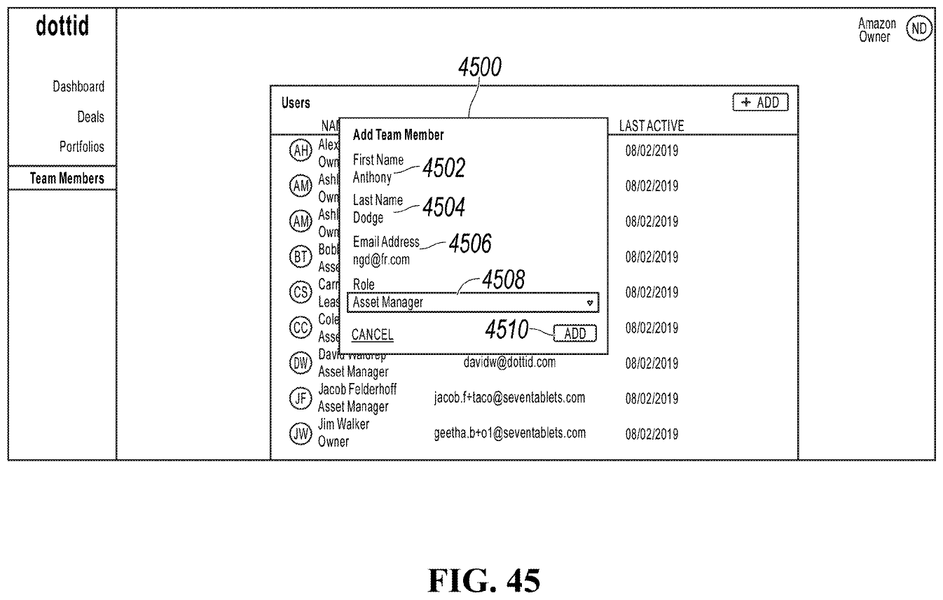

FIG. 45 illustrates an add team member user interface 4500. The add team member user interface 4500 enables input of a first name 4502, a last name 4504, and an email address 4506 of a team member who is to be added. A role selection control 4508 enables selection of a role (e.g., Asset Manager) for the new user. The user can be added in response to selection of an add button 4510. Upon adding the user, the user can receive an invitation to join the system.

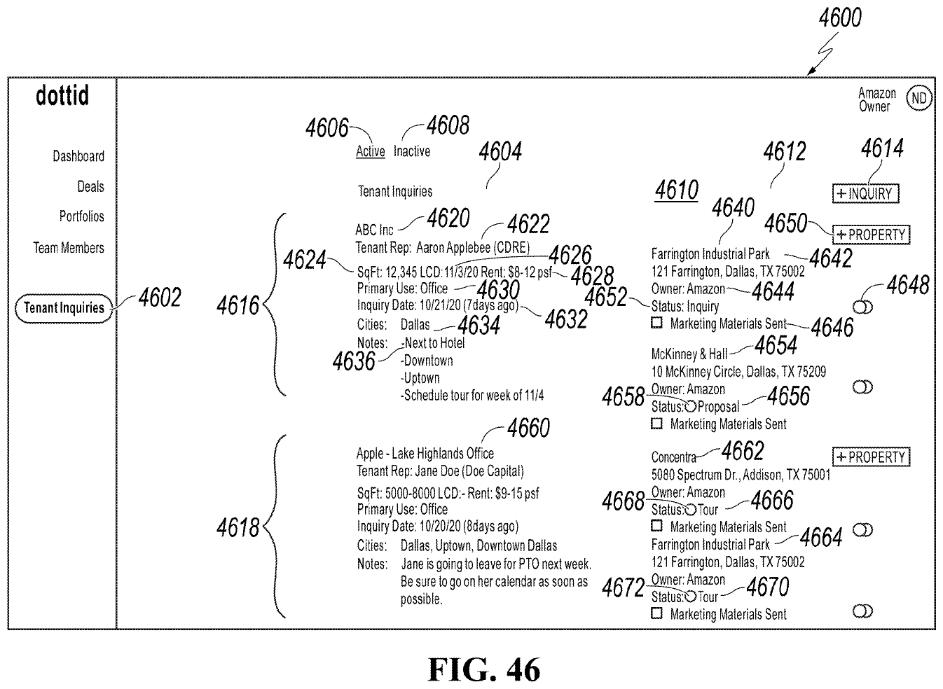

FIG. 46 illustrates an example user interface 4600 for tenant inquiries. A user can select a tenant inquiries item 4602 to cause a tenant inquiry area 4604 to be displayed. Active or inactive inquiries can be displayed in the tenant inquiry area 4604 by selecting an active link 4606 or an inactive link 4608, respectively. Currently, active inquiries are displayed (e.g., active inquiries can be displayed by default when the tenant inquiry area 4604 is initially displayed). A user can search for particular inquiries using a search control 4610. A user can filter currently displayed inquiries by selecting or entering a filter in a filter area 4612. A new inquiry can be added by selecting an add item 4614.

The tenant inquiry area 4604 currently displays a first inquiry area 4616 that displays information for a first inquiry and a second inquiry area 4618 that displays information for a second inquiry. The first inquiry is for a first tenant ABC Inc. 4620 that has a tenant representative 4622 of Aaron Applebee (e.g., of firm CBRE). The first tenant 4620 has stated a square footage need 4624 of 12,345 square feet. A desired lease commencement date 4626 is Nov. 3, 2020. A desired rent amount 4628 is $8-$12 per square foot. A desired space type 4630 is “office”. An ability to change tenant inquiry information, including tenant needs and desires, can be enabled by selection of an edit item 4631.

As indicated by a note 4632, the first inquiry was made seven days ago (e.g., on Oct. 21, 2020). A desired city 4634 is Dallas. A notes section 4636 indicates that the tenant prefers a property that is next to a hotel, is either in downtown or uptown, and that a desired tour date is November 4.

A properties area 4640 displays information on properties that have been identified as potential matches for the first tenant inquiry. Properties can be automatically identified based on previously provided tenant/tenant representative requirements or desires. A Farrington Industrial Park property 4642 has been identified, for example. The property 4642 has an owner 4644. A status item 4646 indicates that marketing materials have not been sent for the property 4642 in response to the first tenant inquiry. Once property materials have been sent, the status item 4646 can be selected and an indication of marketing materials being sent can be stored in the system.

Property team member icons 4648 for the property 4642 can be displayed. Another candidate property can be added for the first tenant inquiry using an add item 4650. A status indicator 4652 indicates that the property 4642 has an inquiry stage status with respect to the first tenant inquiry.

A McKinney & Hall property 4654 has also been identified (or selected) as a property for the first tenant inquiry. A status indicator 4656 indicates that the property 4654 has a proposal stage status with respect to the first tenant inquiry. A completion indicator 4668 indicates the proposal stage is seven percent complete.

The second tenant inquiry is for an Apple-Lake Highlands Office tenant 4660. A Concentra property 4662 and a Farrington Industrial Park property 4664 have been identified (or selected) for the second inquiry. A status indicator 4666 indicates that the property 4662 has a tour stage status with respect to the second tenant inquiry. A completion indicator 4668 indicates the tour stage is twenty five percent complete for the property 4662 with respect to the second tenant inquiry. A status indicator 4670 indicates that the property 4664 has a tour stage status with respect to the second tenant inquiry. A completion indicator 4672 indicates the tour stage is twenty five percent complete for the property 4664 with respect to the second tenant inquiry.

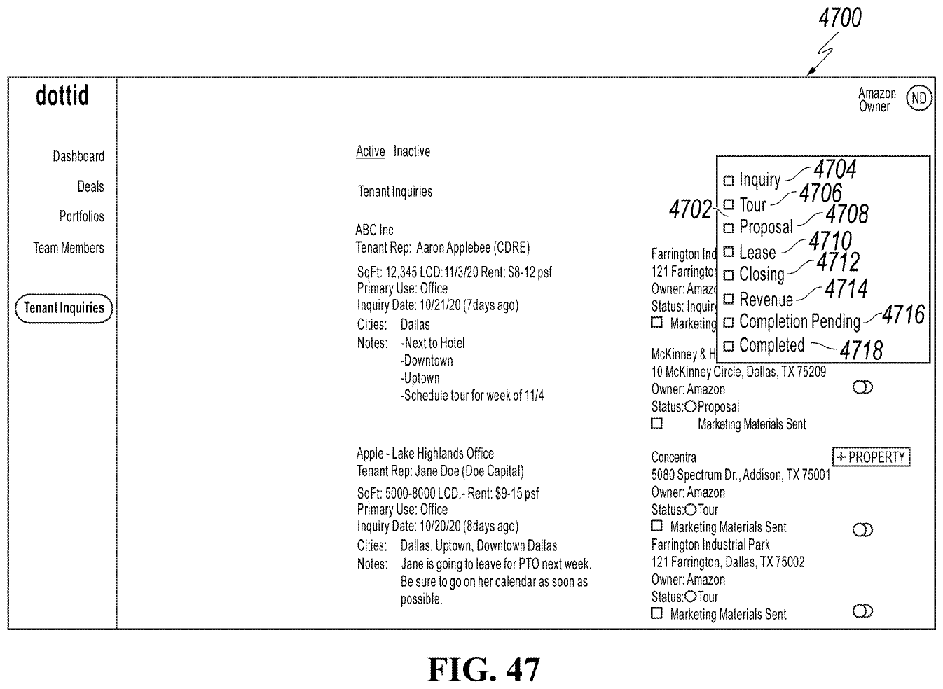

FIG. 47 illustrates an example user interface 4700 that includes a status filter 4702 for tenant inquiries. Tenant inquiries can be filtered by a stage status, for example. Stage status values can include an inquiry stage status (e.g., inquiry 4704), or deal stage statuses (e.g., tour 4706, proposal 4708, lease 4710, closing 4712, revenue or 4714). Other stage statuses can be used, such as completion pending 4716 or completed 4718. One or multiple stage statuses can be selected, to filter the user interface 4700 to display tenant inquiries that have a selected stage status.

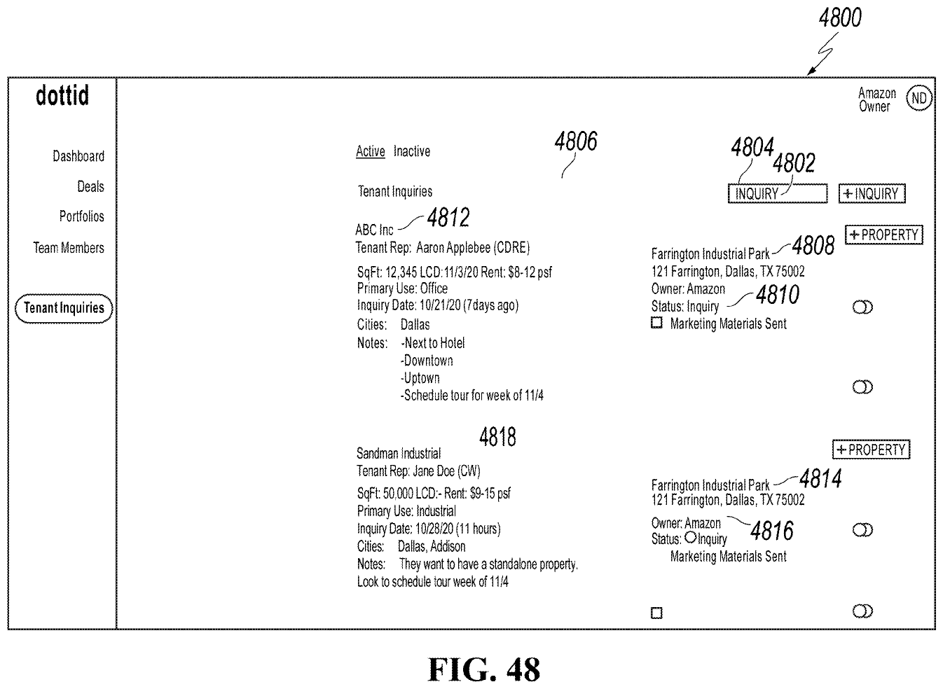

FIG. 48 illustrates an example user interface 4800 for filtering tenant inquires by a stage status. A user has selected (or entered) a stage status 4802 of “inquiry” using a filter control 4804. In response to application of the filter, an inquiry area 4806 is filtered to show a Farrington Industrial Park property 4808 that has a stage status 4810 of inquiry, for a tenant inquiry for an ABC Inc. tenant 4812, and a Farrington Industrial Park property 4814 that has a stage status 4816 of inquiry, for a tenant inquiry for a Sandman Industrial tenant 4818.

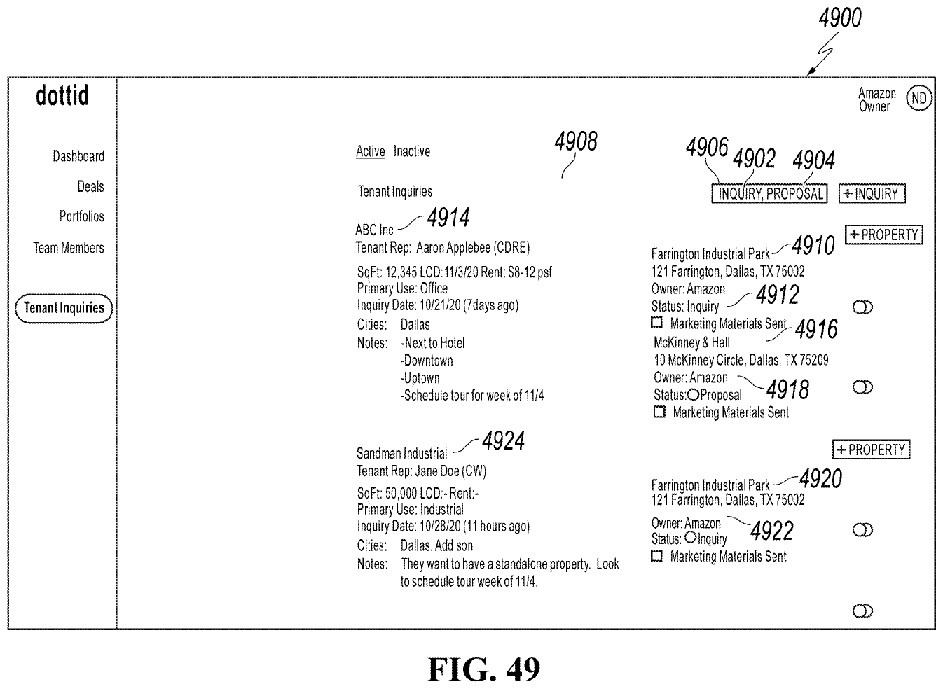

FIG. 49 illustrates an example user interface 4900 for filtering tenant inquiries using multiple stage status values. A user has selected (or entered) a first stage status 4902 of “inquiry” and a second stage status 4904 of “proposal” using a filter control 4906. In response to application of the filter, an inquiry area 4908 is filtered to show a Farrington Industrial Park property 4910 that has a stage status 4912 of inquiry, for a tenant inquiry for an ABC Inc. tenant 4914, a McKinney & Hall property 4916 that has a stage status 4918 of proposal, for the tenant inquiry for the ABC Inc. tenant 4914, and a Farrington Industrial Park property 4920 that has a stage status 4922 of inquiry, for a tenant inquiry for a Sandman Industrial tenant 4924.

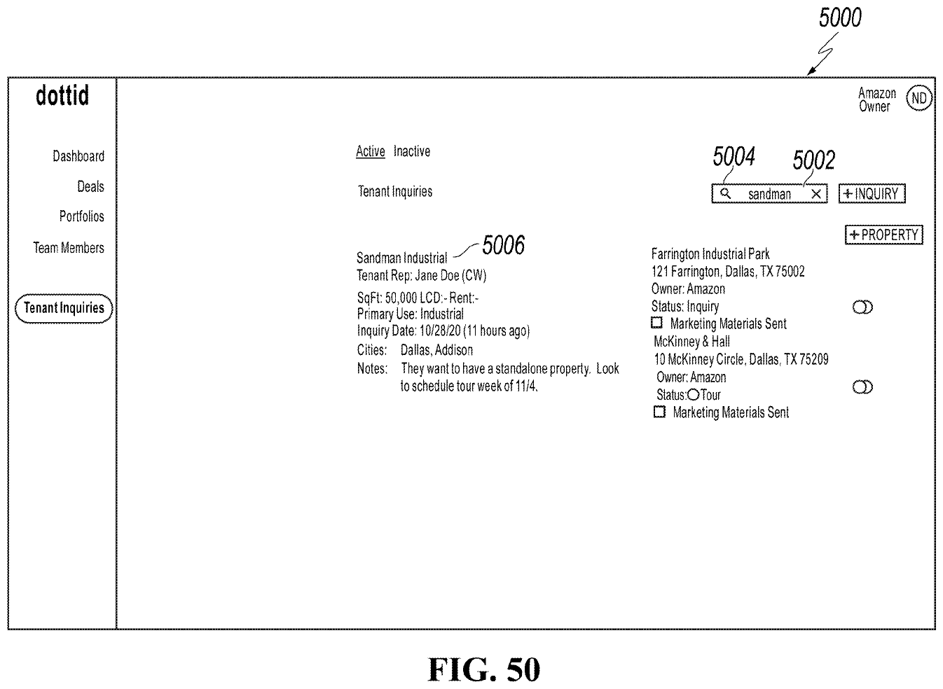

FIG. 50 illustrates an example user interface 5000 for filtering tenant inquiries using keywords. A “sandman” keyword 5002 is entered in the search control 5004. A search for the “sandman” keyword 5002 can be performed in response to selection of a search button (not shown), in response to an enter key selection, in response to focus moving away from the search control 5004, or in response to some other user input. In some implementations, a search is dynamically performed each time keyword(s) in the search control 5004 are changed.

In response to a performed search for the “sandman” keyword 5002, the user interface 5000 is filtered to show a Sandman Industrial property 5006. In some implementations, a search keyword can match various fields, including a tenant name, a property name, a property address, a tenant representative name, a use type, a city, an owner name, or text in a note, to name a few examples. In some implementations, search matches are determined based on a smaller number of fields (e.g., only a tenant name, a tenant name or a property name, or some other combination of one or more fields).

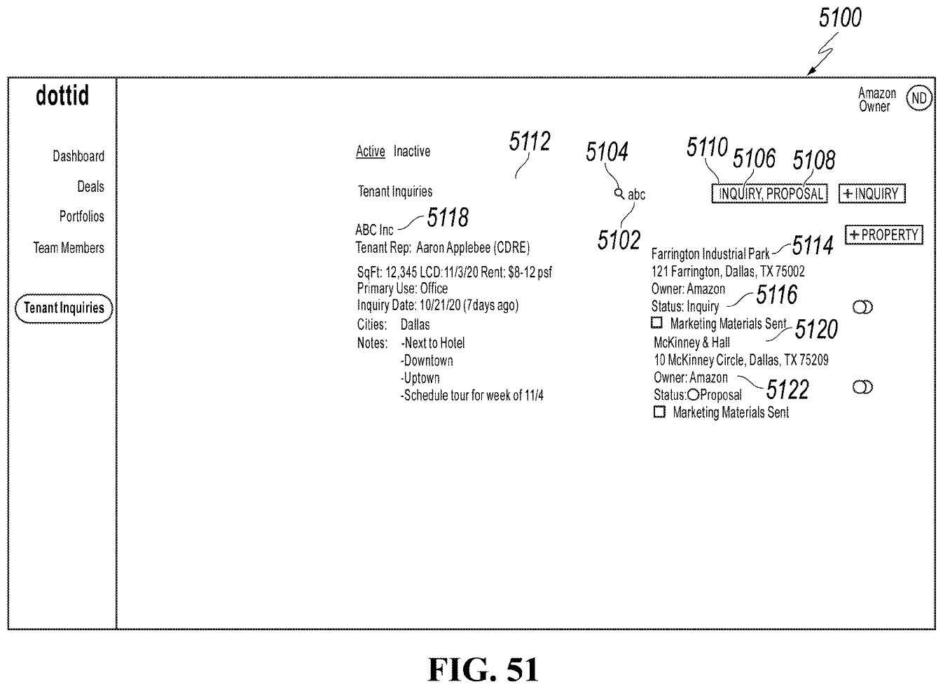

FIG. 51 illustrates an example user interface 5100 for filtering tenant inquiries using keywords and stage status values. An “abc” keyword 5102 is entered in a search control 5104 and an inquiry stage status 5106 and a proposal stage status 5108 are entered in a filter control 5110. The user can either first enter a search keyword and then select one or more stage status values, or can select one or more stage status values and then enter a search keyword. In some implementations, a search is performed and then search results are filtered, or the an inquiry area 5112 is first filtered according to stage status and then by search keyword(s). In some implementations, the user interface 5100 includes a control whereby the user can have a search and a status filter concurrently applied before the inquiry area 5112 is updated to reflect search results and applied filters.

In response to the search for the “abc” keyword 5102 and application of the filter by the inquiry stage status 5106 and the proposal stage status 5108, the inquiry area 5112 is filtered to show a Farrington Industrial Park property 5114 that has a stage status 5116 of inquiry, for a tenant inquiry for an ABC Inc. tenant 5118, and a McKinney & Hall property 5120 that has a stage status 5122 of proposal, for the tenant inquiry for the ABC Inc. tenant 5118.

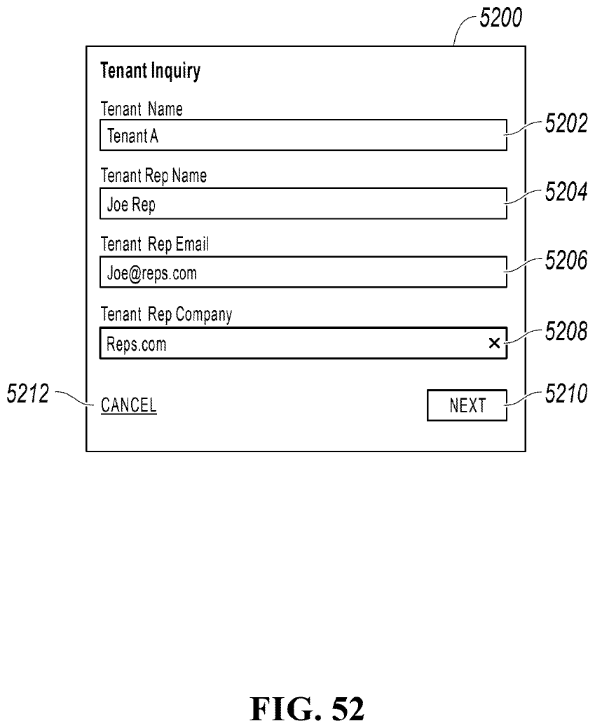

FIG. 52 illustrates an example user interface 5200 for providing tenant information for a new tenant inquiry. A tenant name, a tenant representative name, a tenant representative email, and a tenant representative company can be entered or selected using a tenant name control 5202, a tenant representative name control 5204, a tenant representative email control 5206, and a tenant representative company control 5208, respectively. A next stage of a tenant inquiry creation can be initiated in response to selection of a next stage control 5210. A tenant inquiry creation can be cancelled in response to selection of a cancel link 5212.

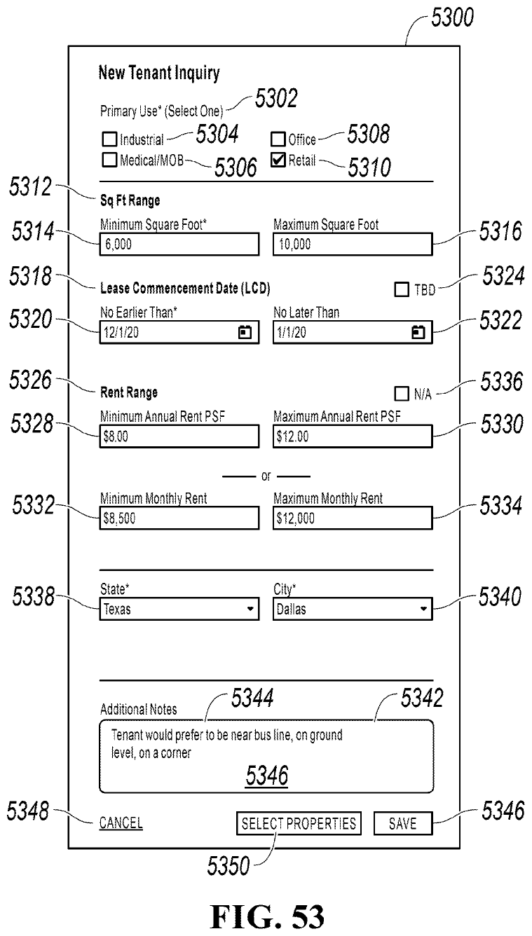

FIG. 53 illustrates an example user interface 5300 for providing information for a new tenant inquiry. A primary use area 5302 can be used to select a primary use of a property type in which a prospective tenant is interested. For example, one or more of an industrial use 5304, a medical use 5306, an office use 5308, or a retail use 5310. In some implementations, the user interface 5300 allows only use type to be selected. In the example user interface 5300, the retail use 5310 has been selected. A square foot range area 5312 can be used to describe property size needs/desires for the prospective tenant. For example, a minimum square foot value 5314 and a maximum square foot value 5316 can be entered.

Lease commencement date (LCD) information can be specified in a LCD area 5318. For example, an earliest lease commencement date 5320 and a latest lease commencement date 5322 can be entered (or selected). If lease commencement date information is not known at a time of inquiry creation, a TBD (To Be Determined) item 5324 can be selected.

A rent range area 5326 can be used to specify acceptable rents for the prospective tenant. For example, a minimum annual rent PSF (Per Square Foot) 5328 and a maximum annual rent PSF 5330 can be entered. As another example, a minimum monthly rent 5332 and a maximum monthly rent 5334 can be entered. In some implementations, a not-applicable item 5336 can be selected, such as if rent ranges are to be (at least not initially) considered for the inquiry. A desired state 5338 and a desired city 5340 can be entered (or selected).

A notes area 5342 can be used to enter additional notes related to the inquiry, such as to describe other tenant needs or preferences. For example, a note 5344 indicates that the prospective tenant would prefer to be near a bus line, on a ground level, on a corner. The entered tenant inquiry information can be saved in response to selection of a save control 5346. Creation of the tenant inquiry can be cancelled in response to selection of a cancel link 5348. A next inquiry step of selecting properties that may be a match for the prospective tenant can be initiated in response to selection of a select-properties control 5350. Tenant information entered or selected using the user interface 5300 can be saved in response to selection of the select-properties control 5350, before the property selection process begins.

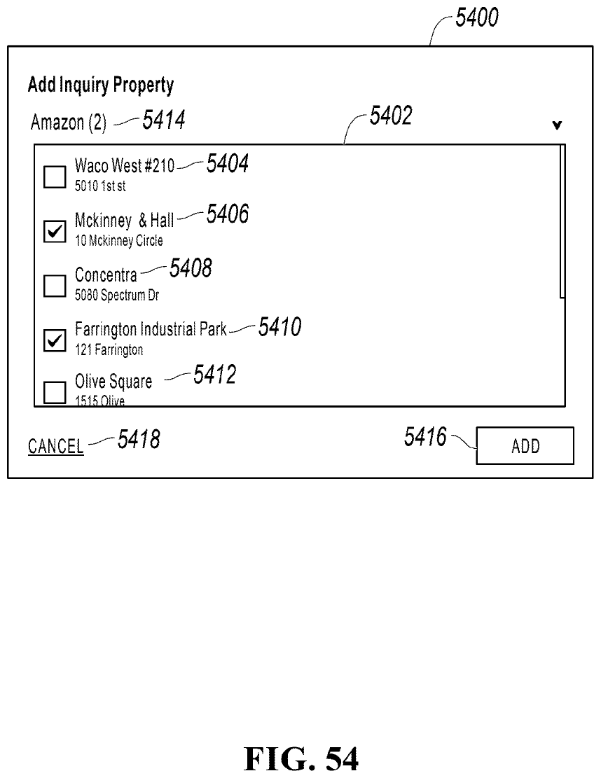

FIG. 54 illustrates an example user interface 5400 for associating a property with a tenant inquiry. Matching properties can be displayed in a prospective properties area 5402. For example, a Waco West property 5404, a McKinney & Hall property 5406, a Concentra property 5408, a Farrington Industrial Park property 5410, and an Olive Square property 5412 are displayed in the prospective properties area 5402. The user can select one or more prospective properties. For example, the McKinney & Hall property 5406 and the Farrington Industrial Park property 5410 have been selected. A count 5414 indicates a count of selected properties. Selected properties can be associated with the inquiry in response to selection of a save control 5416. Property selection can be cancelled in response to selection of a cancel link 5418. After all information for the tenant inquiry including selected candidate properties has been entered and saved, an electronic message (e.g., email) can be automatically generated and sent to the tenant representative associated with the inquiry. The electronic message can include automatically generated language that describes how the selected properties match the parameters of the tenant inquiry. Various other documents, such as draft proposal documents, property descriptions, etc., can be automatically included with the electronic message.

Some or all of the Waco West property 5404, the McKinney & Hall property 5406, the Concentra property 5408, the Farrington Industrial Park property 5410, and the Olive Square property 5412 can be automatically identified by the system as a match for the tenant inquiry. Matching properties can be identified, for example, based on one or more of a lease commencement date, a primary use type, a square foot range, a rent range, a desired location (e.g., state, city, area of city), or based on other factors, such as custom requirements entered when the tenant inquiry is created. In some implementations, the broker can identify and select prospective properties and/or refine or reduce a set of properties automatically selected by the system. For instance, the broker may refine a set of candidate properties based on discussions with the tenant representative, such as to better find a matching property that better or best matches other tenant needs (e.g., tenant needs documented in a notes section).

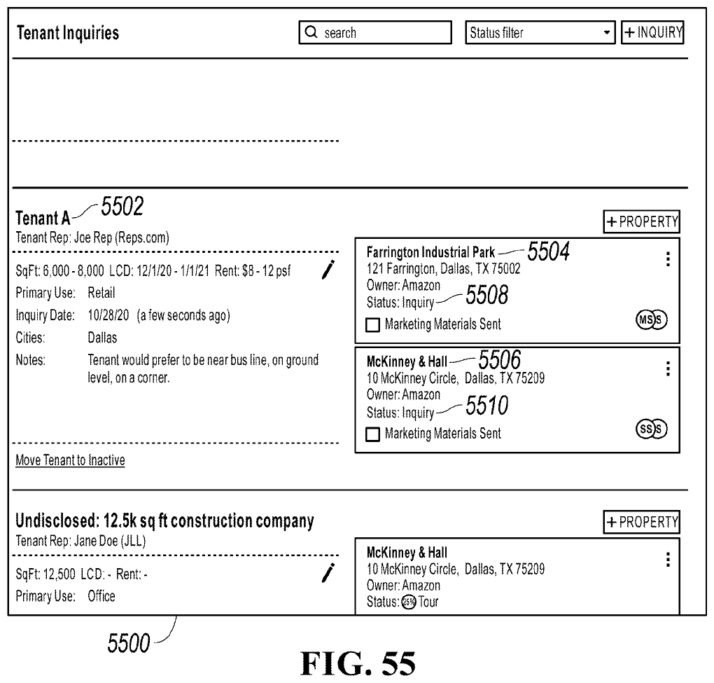

FIG. 55 illustrates an example user interface 5500 that has been updated to display a newly added tenant inquiry. The user interface 5500 can be a tenant inquiries area of a larger user interface or can be a separate user interface. A “Tenant A” tenant inquiry 5502 is displayed in the user interface 5500, along with other previously-created tenant inquiries. A Farrington Industrial Park property 5504 and a McKinney & Hall property 5506 have been associated with the tenant inquiry 5502. The Farrington Industrial Park property 5504 and the McKinney & Hall property 5506 each have “inquiry” stage statuses (e.g., as illustrated by stage status values 5508 and 5510, respectively).

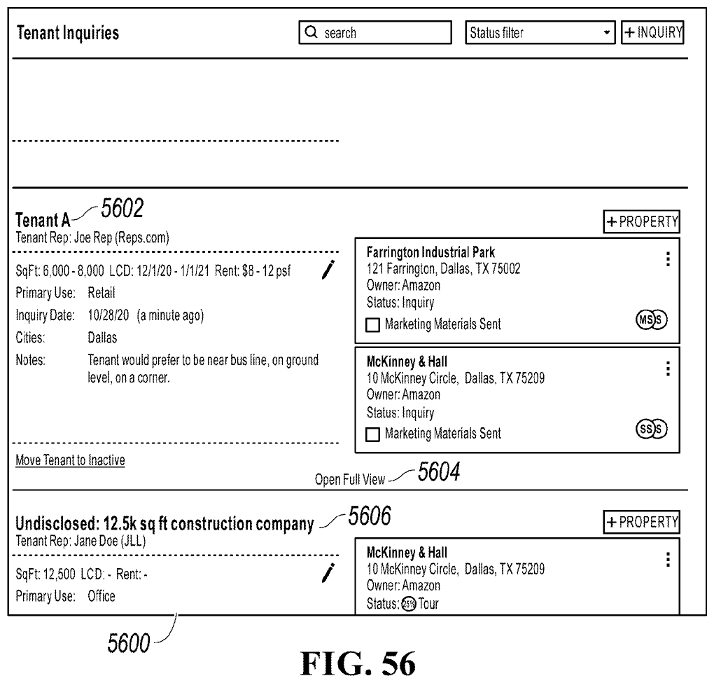

FIG. 56 illustrates an example user interface 5600 that enables a user to request a focused view of a tenant inquiry. For example, the user can hover over a Tenant A inquiry 5602 to cause an open-full-view link 5604 to be displayed. The open-full-view link 5604 can be selected to view the Tenant A inquiry 5602 in a focused view. The focused view can include information for the Tenant A inquiry and not information for other inquiries, such as an inquiry 5606.

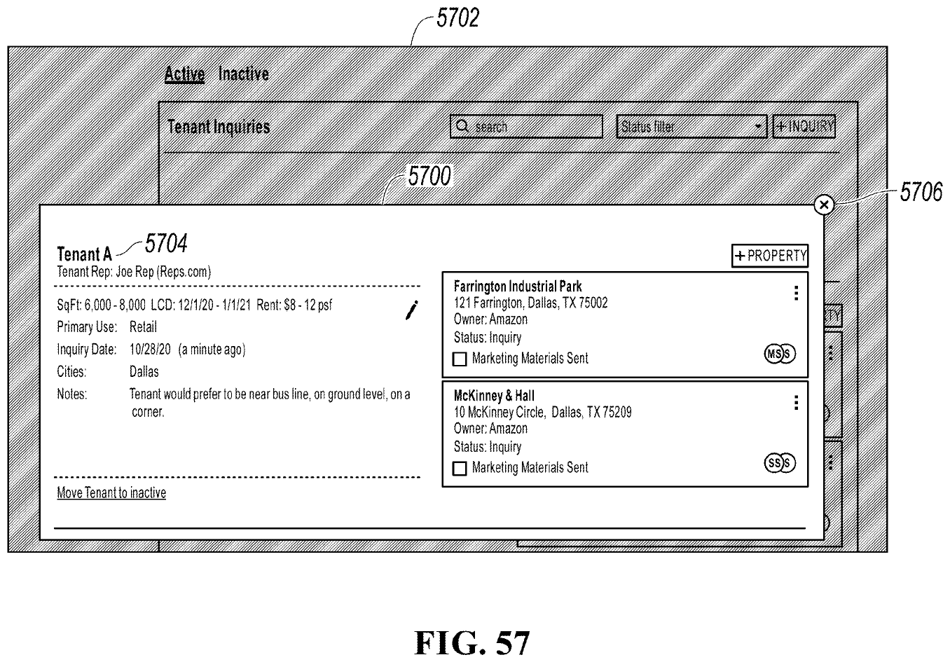

FIG. 57 illustrates an example focused view user interface 5700 for displaying a tenant inquiry in a focused view. The focused view user interface 5700 can be displayed in response to selection of an open-full-view link (as described above with respect to FIG. 56). In some implementations, the focused view user interface 5700 is displayed on top of a tenant inquiries user interface 5702. The focused view user interface 5700 displays information for a single tenant inquiry (vs information for multiple inquiries that may be displayed in the tenant inquiries user interface 5702). For instance, the focused view user interface 5700 displays information for a Tenant A inquiry 5704. The focused view user interface 5700 can be closed, and the tenant inquiries user interface 5702 can be redisplayed, in response to selection of a close item 5706.

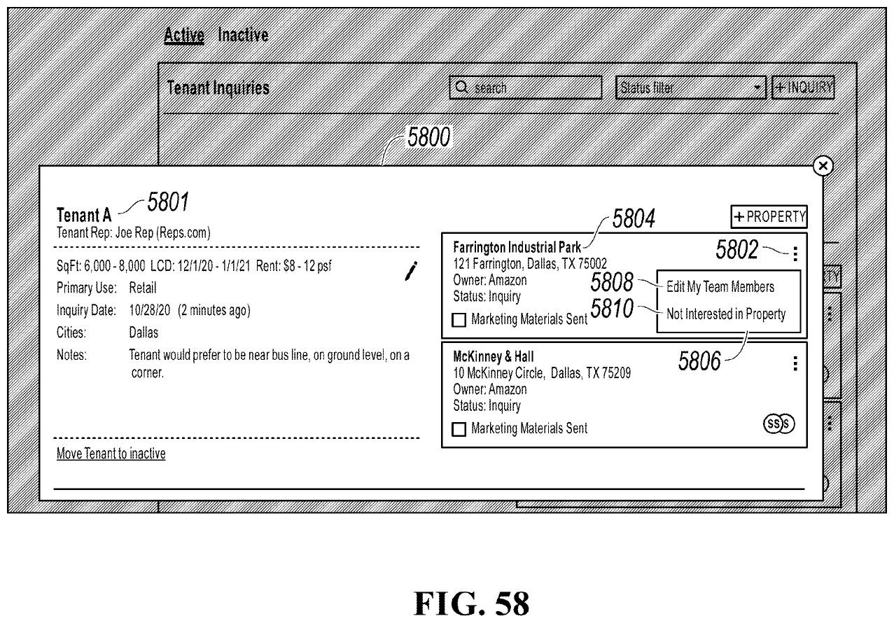

FIG. 58 illustrates an example user interface 5800 that presents options for a property associated with a tenant inquiry. A property menu can be selected for each property associated with a tenant inquiry 5801. For instance, a property menu control 5802 can be selected for a property 5804 (and/or a similar property menu control can be selected for other properties). Selecting the property menu control 5802 can result in display of a property menu 5806. The property menu 5806 includes an “Edit My Team Members” item 5808 and a “Not Interested in Property” item 5810. The Edit My Team Members item 5808 can be selected to view/edit team members associated with the property 5804. The Not Interested in Property item 5810 can be selected to move the property to an inactive state with respect to the tenant inquiry 5801.

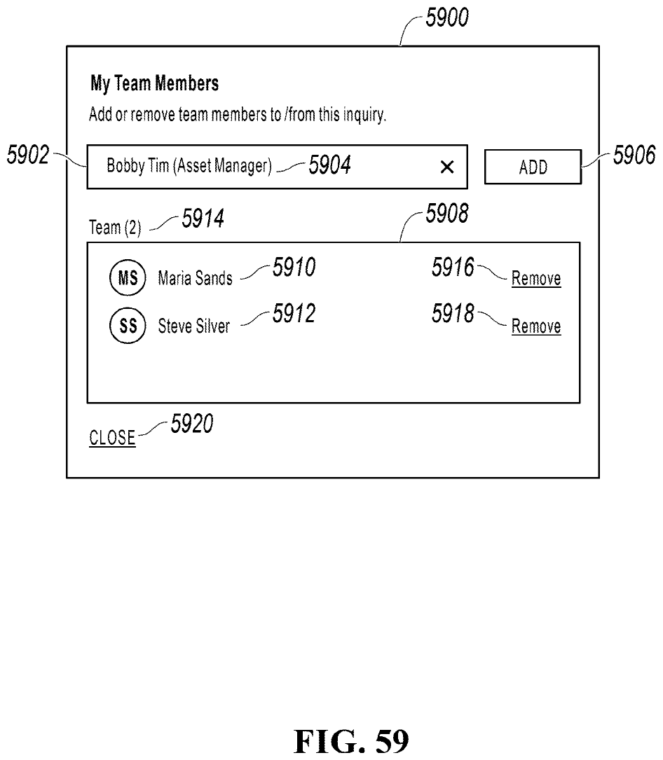

FIG. 59 illustrates an example user interface 5900 for editing team members for a property that is associated with a tenant inquiry. The user interface 5900 can be displayed in response to selection of a menu associated with a given property, so when the user interface 5900 is displayed, a particular property for an inquiry can be established as a property with which team members selected using the user interface 5900 are to be associated.

Team members for a property can update a property's status with respect to the inquiry, and perform other actions. The user can enter or select a team member to associate with the property using a team member control 5902. For example, Bobby Tim 5904 has been selected. An entered or selected team member can be added using an add control 5906. A team area 5908 shows current team members. For example, Maria Sands 5910 and Steve Silver 5912 are current team members. A team count 5914 shows a count of current team members (e.g., currently there are two team members). Current team members can be removed using remove links 5916 or 5918, respectively. The user interface 5900 can be closed using a close link 5920.

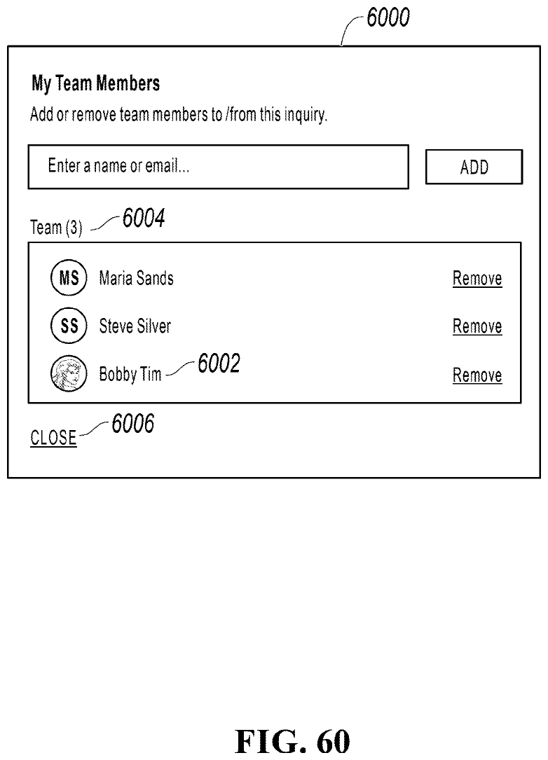

FIG. 60 illustrates an updated user interface 6000 for editing team members for a property that is associated with a tenant inquiry. The updated user interface 6000 displays a just-added team member Bobby Tim 6002. The team member Bobby Tim 6002 may have been added as described above with respect to FIG. 59. A team member count 6004 has been updated to show a current, larger count of team members. The user interface 6000 can be closed using a close link 6006.

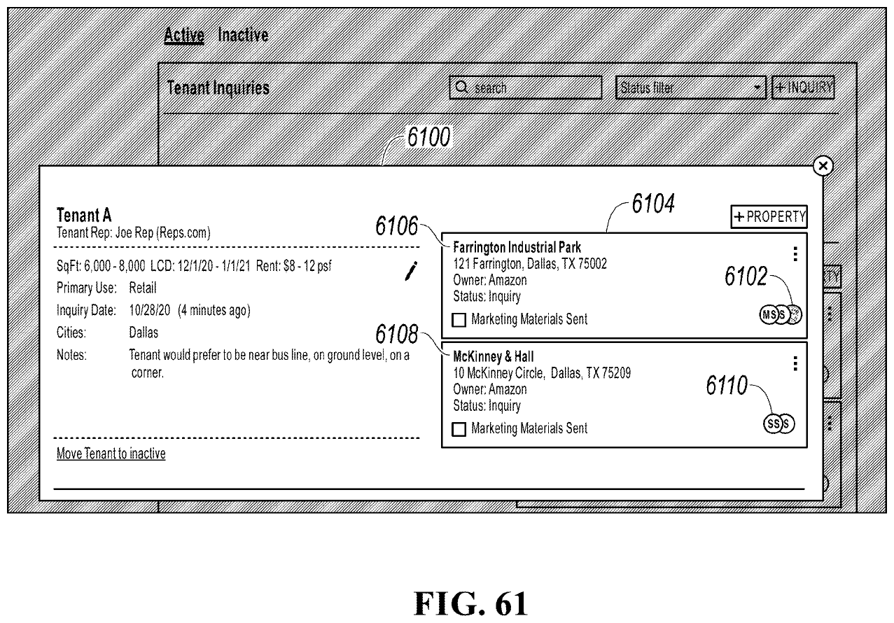

FIG. 61 illustrates an example user interface 6100 that has been updated to reflect the addition of a team member to a property associated with a tenant inquiry. In response to addition of a new team member, a new team member icon 6102 for the added member (e.g., Bobby Tim) is displayed in a property area 6104 for a property 6106 to which the team member was added. In some implementations, the team member is added to the specific property, and not to other properties. For example, team members for a property 6108 have not been adjusted in response to addition of the new team member, as shown by maintained team member icons 6110 for the property 6108.

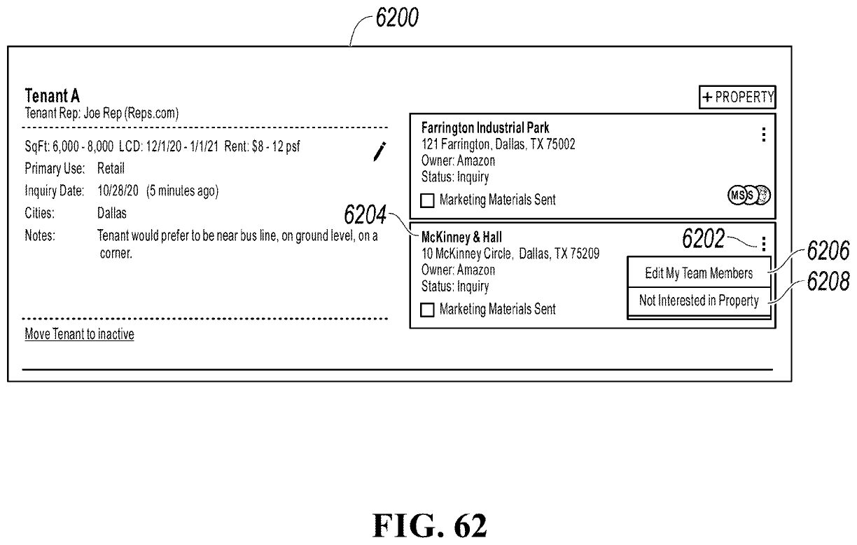

FIG. 62 illustrates an example user interface 6200 that presents options for a property associated with a tenant inquiry. In response to selection of a property menu control 6202 for a property 6204, a property menu 6206 can be displayed, which includes, among other items, a Not Interested in Property item 6208. A team member can determine, or can be told, that the prospective tenant is not interested in the property 6204 (at least for the current inquiry). Accordingly, the user can select the “Not Interested In Property” item 6208 on the property menu 6206 if the tenant is no longer interested in the property 6204 (or if the property 6204 is otherwise determined to not be a match for the inquiry).

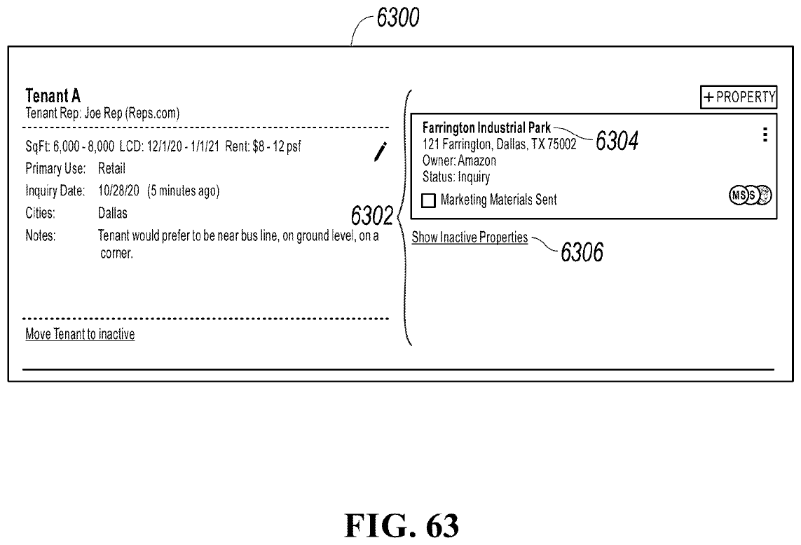

FIG. 63 illustrates an example user interface 6300 that has been updated to reflect a change in active properties for a tenant inquiry. As described above with respect to FIG. 63, the user may have selected a Not Interested in Property item if the prospective tenant is not interested in a property for a given inquiry. After the user has selected the “Not Interested In Property” item for a property, the property can be removed from the user interface 6300. For example, a property area 6302 includes a property 6304 but not a McKinney & Hall property (e.g., corresponding to the property 6204 in FIG. 62). The McKinney & Hall property can be moved to an inactive state. A Show Inactive Properties link 6306 can be selected to view inactive properties.

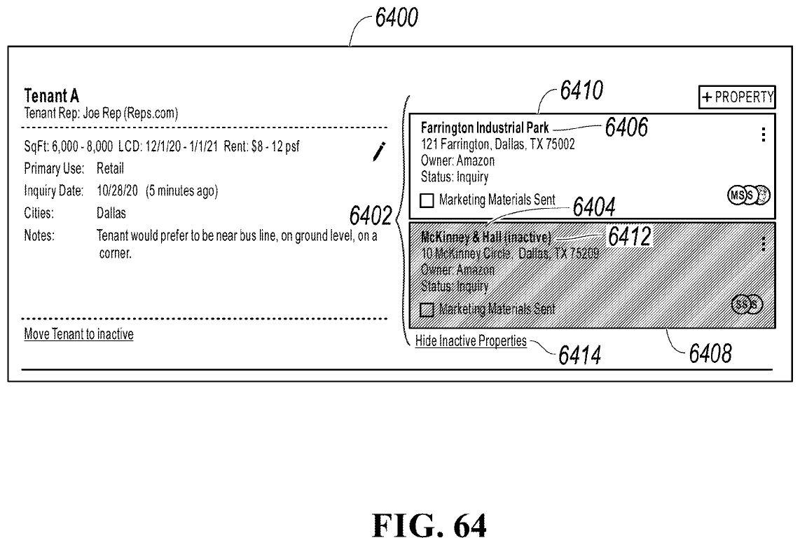

FIG. 64 illustrates an example user interface 6400 that displays inactive properties for a tenant inquiry. After selection of a Show Inactive Properties link, inactive properties can be displayed in a properties area 6402. For example, an inactive property 6404 is now displayed. The inactive property 6404 can be displayed in a style that is different from active properties such as an active property 6406. For example, a property area 6408 for the inactive property 6404 can be displayed with a different background than a background used for a property area 6410 used for the active property 6406. For example, the property area 6408 can have a shaded background. The inactive property 6404 is shown with an inactive status 6412. Inactive properties, including the inactive property 6404 can be hidden again in response to selection of a Hide Inactive Properties link 6414.

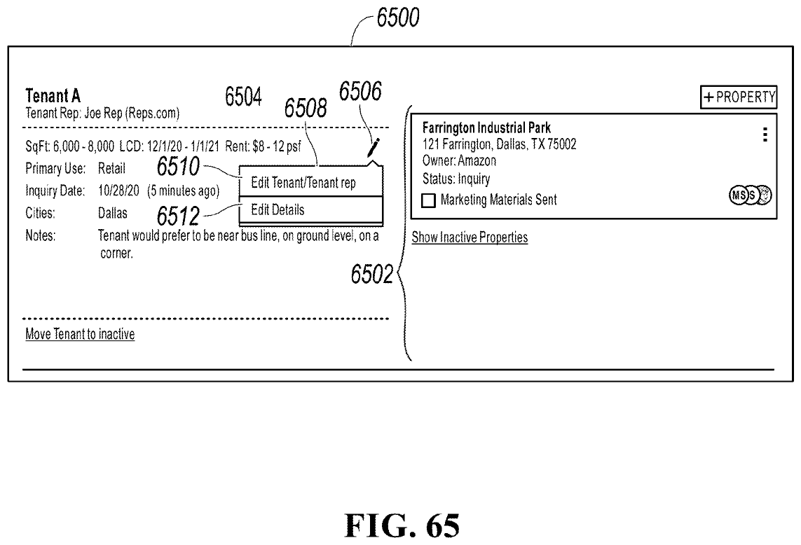

FIG. 65 illustrates an example user interface 6500 that shows active properties and presents options for editing a tenant inquiry. After selection of a Hide Inactive Properties link in a properties area 6502 (e.g., as described above with respect to FIG. 64), inactive properties are no longer displayed in the properties area 6502. In an inquiry information area 6504, a user can select an edit control 6506 to have an edit menu 6508 displayed. The edit menu 6508 includes items related to editing a tenant inquiry. For example, the edit menu 6508 includes an Edit Tenant/Tenant Rep menu item 6510 and an Edit Details menu item 6512. The Edit Tenant/Tenant Rep menu item 6510 can be selected to edit tenant and/or tenant representative information related to the inquiry. The Edit Details menu item 6512 can be selected to edit other details regarding the tenant inquiry.

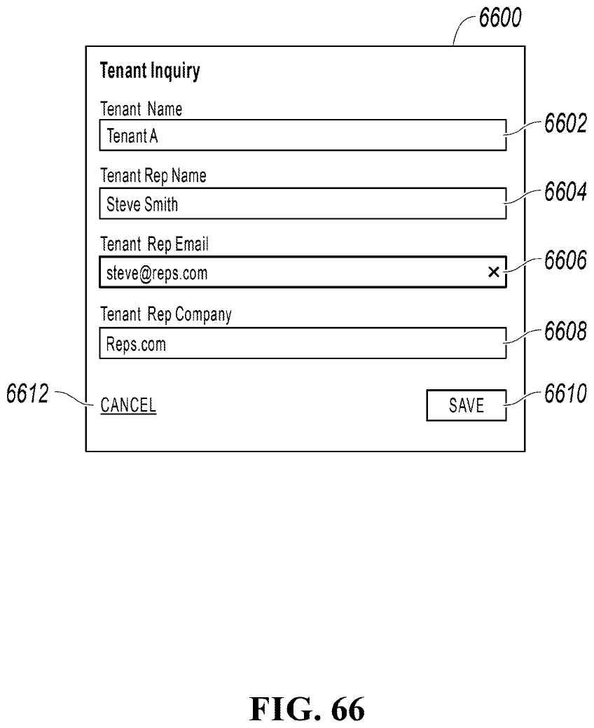

FIG. 66 illustrates an example user interface 6600 for editing tenant information for a tenant inquiry. The user interface 6600 can enable the user to edit tenant and tenant representative information. The Edit Tenant Details user interface is similar to the user interface 5200 described above with respect to FIG. 52.

A tenant name, a tenant representative name, a tenant representative email, and a tenant representative company can be edited using a tenant name control 6602, a tenant representative name control 6604, a tenant representative email control 6606, and a tenant representative company control 6608, respectively.

For example, a new tenant representative name and tenant representative email address have been entered in the tenant representative name control 6604 and the tenant representative email control 6606, respectively. Edited information can be saved in response to selection of a save control 6610. An edit operation can be cancelled in response to selection of a cancel link 6612.

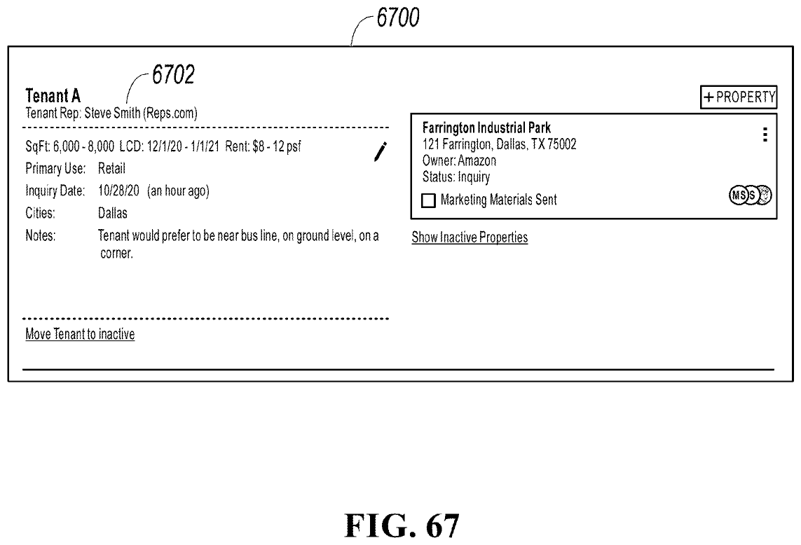

FIG. 67 illustrates an example user interface 6700 that has been updated to reflect changes in tenant information for a tenant inquiry. After tenant information has been changed, the user interface 6700 may change to reflect at least some of the updated information. For example, an updated tenant representative name of “Steve Smith” 6702 is displayed.

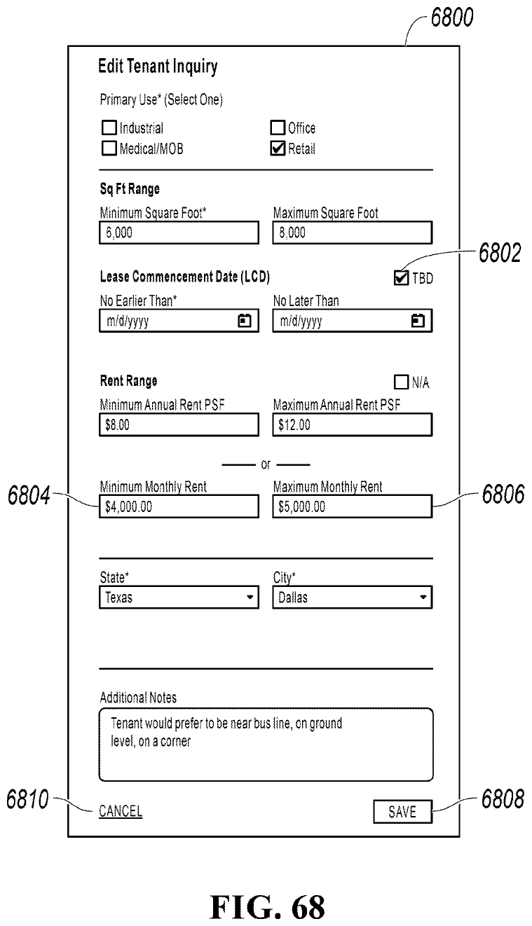

FIG. 68 illustrates an example user interface 6800 for editing information for a new tenant inquiry. The user interface 6800 is similar to the user interface 5300 described above with respect to FIG. 53. The user can use the user interface 6800 to change previously-provided information. For example, the user has selected a TBD control 6802 to specify that a lease commencement date is to be determined at a later date. The user has entered a value of $4,000 in a minimum month rent control 6804 and a value of $5,000 in a maximum monthly rent control 6806, which replace previously entered values for minimum and maximum rents per square foot. Edited information can be saved in response to selection of a save control 6808. An edit operation can be cancelled in response to selection of a cancel link 6810.

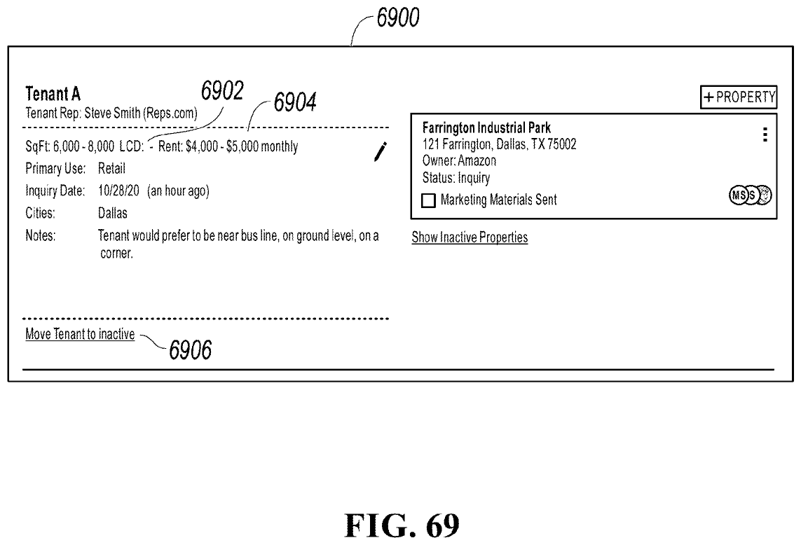

FIG. 69 illustrates an example user interface 6900 that has been updated to display edited tenant inquiry information. For example, an empty lease commencement date value 6902 can be displayed in response to a user selecting TBD for a lease commencement date. As another example, updated rent criteria 6904 is displayed, which can be displayed in place of previous (now changed) information in the tenant inquiry.

In some implementations, a user can select a Move Tenant to Inactive link 6906 to mark the tenant inquiry as inactive. A tenant inquiry can be moved to an inactive state if a prospective tenant has put a project on hold, or has communicated a lack of interest (at least temporarily) in completing a deal. As another example, a tenant inquiry can be marked as inactive if a prospective tenant has been unresponsive for a certain period of time. Other reasons can cause a tenant inquiry to be marked as inactive.

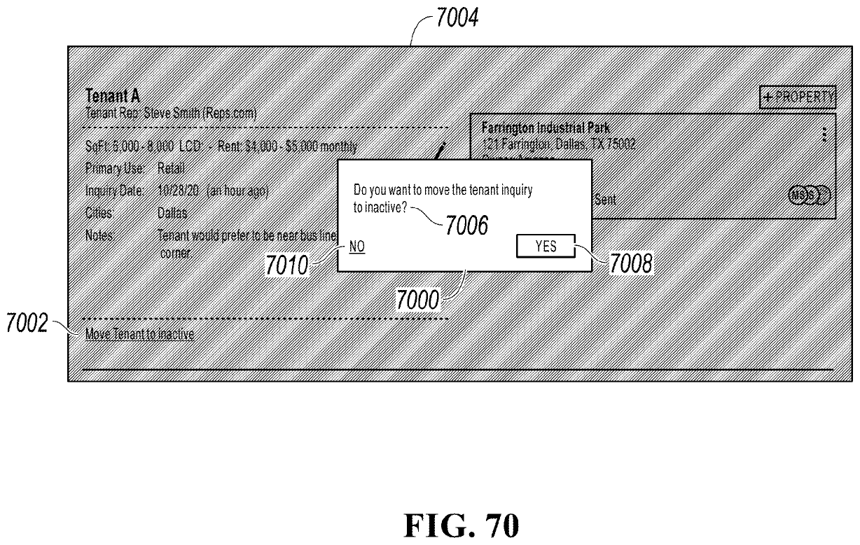

FIG. 70 illustrates an example confirmation user interface 7000 for confirming a setting of a tenant inquiry to an inactive state. In response to selection of a Move Tenant to Inactive link 7002 (e.g., on a tenant information user interface 7004), the confirmation user interface 7000 can be displayed. A confirmation prompt 7006 can be displayed to ask the user if they are sure that they want to move the tenant inquiry to an inactive state. The user can confirm that they want to move the tenant inquiry to an inactive state by selecting a Yes item 7008. The user can cancel out of moving the tenant inquiry to an inactive state by selecting a cancel link 7010.

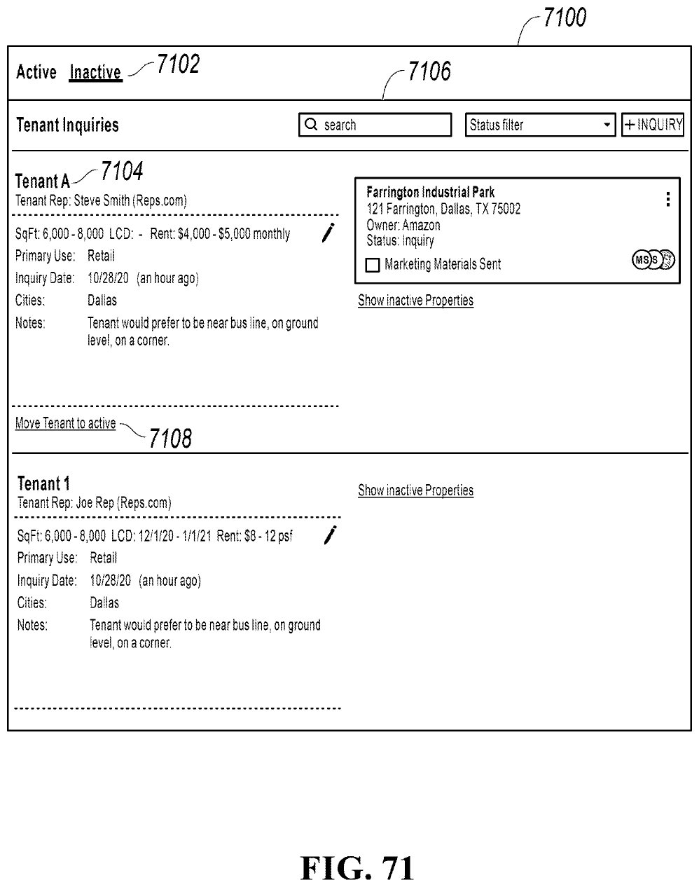

FIG. 71 illustrates an example user interface 7100 for displaying inactive tenant inquiries. After a Move Tenant to Inactive link has been selected for a tenant inquiry, the user can view the inactive tenant inquiry by selecting an Inactive link 7102. For example, a tenant inquiry for a tenant 7104, is included in an inactive tenant inquiry area 7106. The user can move the tenant inquiry for the tenant 7104 to an active state by selecting a Move Tenant to active link 7108.

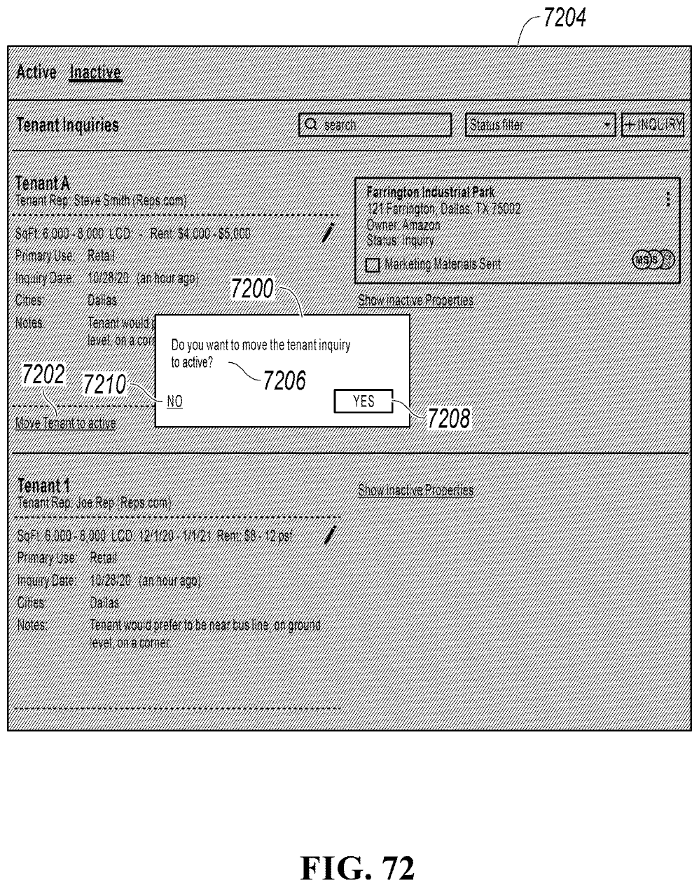

FIG. 72 illustrates an example confirmation user interface 7200 for confirming a setting of an inactive tenant inquiry to an active state. In response to selection of a Move Tenant to Active link 7202 (e.g., on a tenant information user interface 7204), confirmation user interface 7200 can be displayed. A confirmation prompt 7206 can be displayed to ask the user if they are sure that they want to move the tenant inquiry to an active state. The user can confirm that they want to move the tenant inquiry to an active state by selecting a Yes item 7208. The user can cancel out of moving the tenant inquiry to an active state by selecting a cancel link 7210.

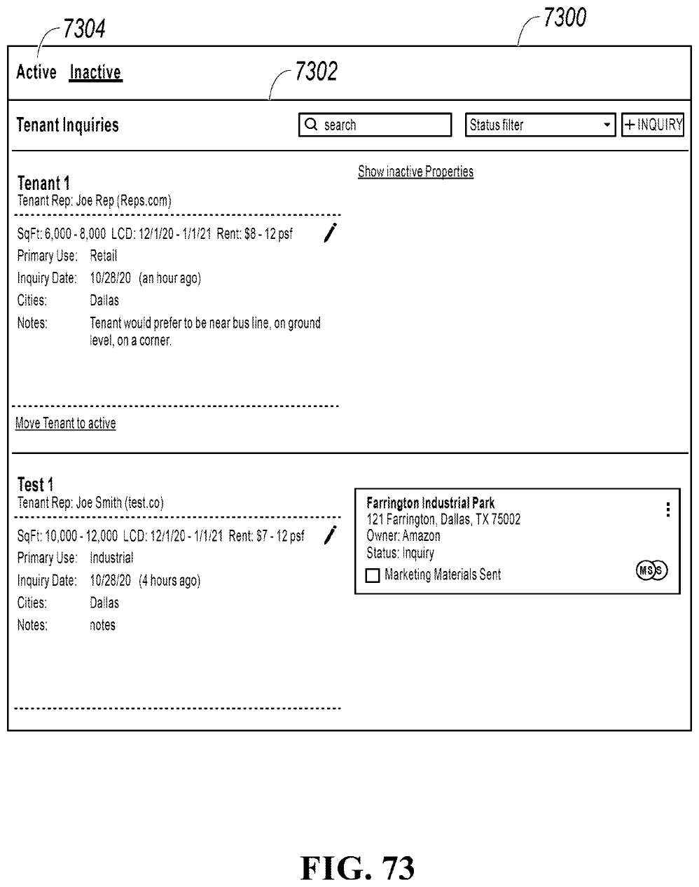

FIG. 73 illustrates an example user interface 7300 that has been updated to reflect a setting of an inactive tenant inquiry to an active state. In response to selection of a Move Tenant to Active link for a tenant inquiry, the tenant inquiry can be removed from an inactive tenant inquiries area 7302. For example, a tenant inquiry for a “Tenant A” tenant is no longer displayed in the inactive tenant inquiries area 7302. The user can view the now active tenant inquiry by selecting an Active item 7304.

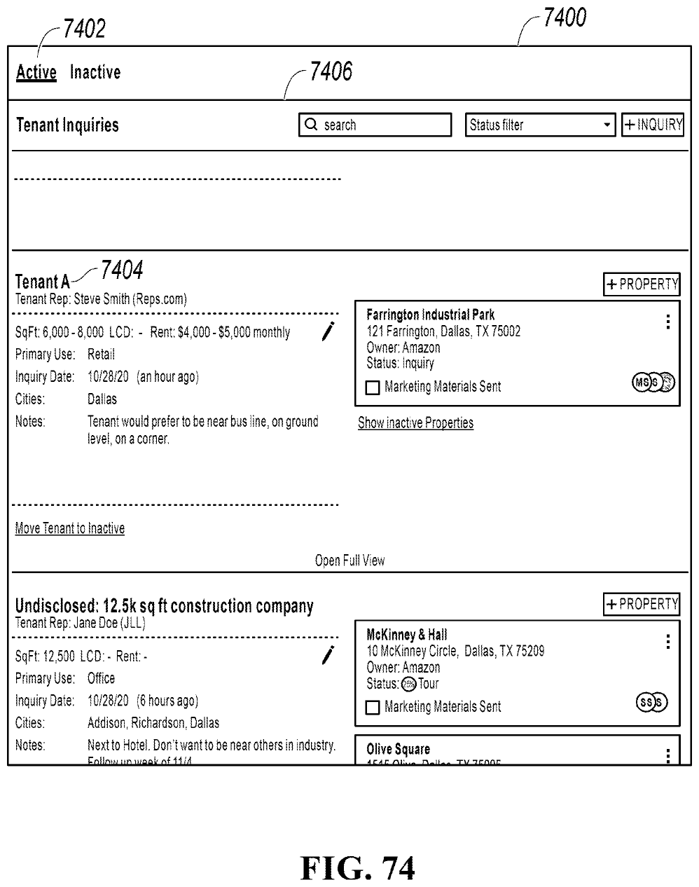

FIG. 74 illustrates an example user interface 7400 that has been updated to reflect a setting of an inactive tenant inquiry to an active state. The user has selected an active link 7402. In response to selection of the active link 7402, a tenant inquiry associated with a tenant 7404 is now included in an active tenant inquiries area 7406. The tenant inquiry associated with the tenant 7404 can be now included in the active tenant inquiries area 7406 after the user had selected a Move Tenant to Active link, for example.

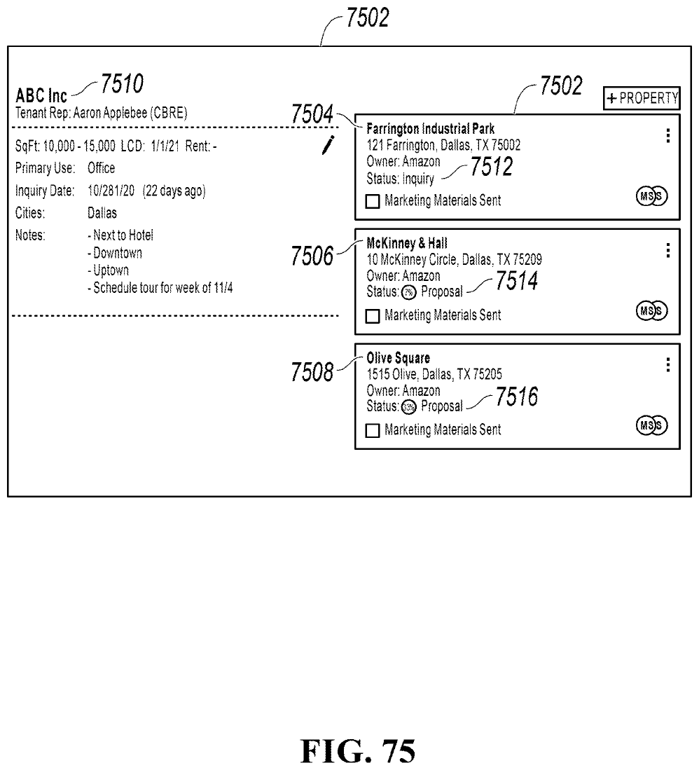

FIG. 75 illustrates an example user interface 7500 that includes multiple prospective properties for a tenant inquiry. For instance, as shown in a properties area 7502, a first property 7504, a second property 7506, and a third property 7508 have been identified (and/or selected) as matching properties for an ABC Inc. tenant 7510. The inquiry management engine 136 can manage separate workflows for each identified property, including management of separate statuses for each property. For instance, the first property 7504 currently has an inquiry status 7512, the second property 7506 has a proposal status 7514 (at seven percent completion), and the third property 7508 has a proposal status 7516 (at thirty three percent completion). When a tenant decides to move forward on formal deal proceedings for one of the first property 7504, the second property 7506, or the third property 7508, a deal workflow can be established for the property and the deal management engine 134 can manage the deal workflow for the property as the property advances through more formal deal-related stages.

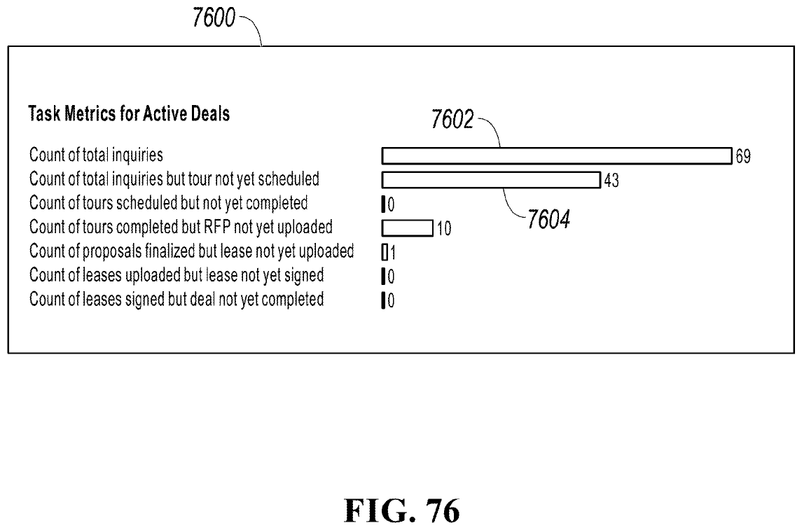

FIG. 76 illustrates an example user interface 7600 for deal and tenant inquiry metrics. As described above with respect to FIG. 12, metrics can be presented for deals. Additionally, and as shown in the user interface 7600, metrics can be generated and presented for tenant inquiries as well as for deals. For instance, a first metric 7602 is a count of total inquiries. A second metric 7604 is a count of inquiries for which a tour has not yet been scheduled. Other metrics can be tracked and presented. For instance, a count of inquiries for which marketing materials have not been sent can be generated and presented. As another example, a count of inquiries that have associated proposals can be tracked and displayed.

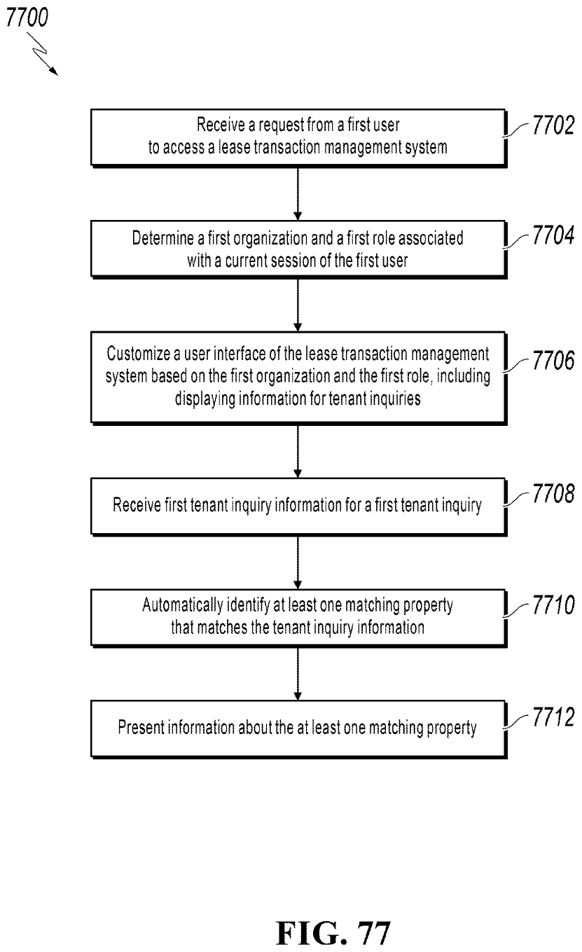

FIG. 77 is a flowchart of an example method 7700 for adaptive role-based tenant inquiry management. It will be understood that method 7700 and related methods may be performed, for example, by any suitable system, environment, software, and hardware, or a combination of systems, environments, software, and hardware, as appropriate. For example, one or more of a client, a server, or other computing device can be used to execute method 7700 and related methods and obtain any data from the memory of a client, the server, or the other computing device. In some implementations, the method 7700 and related methods are executed by one or more components of the system 100 described above with respect to FIG. 1. For example, the method 7700 and related methods can be executed by the inquiry management engine 136 of FIG. 1.

At 7702, a request is received from a first user to access a lease transaction management system.

At 7704, a first organization and a first role associated with a current session of the first user are determined. The first organization can be a leasing agency, a property ownership group, or a tenant agency, to name a few examples. The first role can be a property owner, a leasing team member, a broker, or a tenant representative. The first user can have different roles for different organizations or properties. When the first user is associated with more than one organization, determining the first organization associated with the current session can include receiving selection of the first organization from the first user. As another example, the first organization can be determined based on a website address or a login identifier. The first role can be determined based on the first organization and user identifying information.

At 7706, a user interface of the lease transaction management system is customized based on the first organization and the first role associated with the current session, including the displaying of information for tenant inquiries that the first user is authorized to view based on the first role and the first organization.

At 7708, first tenant inquiry information for a first tenant inquiry for a first prospective tenant is received, through the user interface. The first tenant inquiry information can be new tenant inquiry information and the first tenant inquiry can be a new tenant inquiry. As another example, the first tenant inquiry information can be updated tenant inquiry information, the first tenant inquiry can an existing inquiry, and the stored tenant inquiry information for the first tenant inquiry can be updated with the first tenant inquiry information. The first tenant inquiry information can include one or more of a primary use type, a property size specification, a lease commencement date range, a desired location, or a rent specification.

At 7710, at least one matching property that matches the tenant inquiry information is automatically identified. Automatically identifying the at least one matching property can include identifying at least one property that matches updated stored tenant inquiry information for the first tenant inquiry, when the first tenant inquiry information is updated tenant inquiry information. Automatically identifying the at least one matching property can include identifying one or more properties that match one or more of a primary use type, a property size specification, a lease commencement date range, a desired location, or a rent specification of the first tenant inquiry. Additionally or alternatively, a user can select a property as a match for tenant inquiry.

At 7712, information about the at least one matching property is presented, in the user interface, to the first user. The user interface can enable action(s) to be performed, related to the first tenant inquiry or about properties that have been identified for the first tenant inquiry. For example, the sending of marketing materials for the property can be initiated and recorded. A user can indicate whether the tenant has expressed interest in (or has indicated a lack of interest in) a given property. A tenant inquiry can be marked as active or inactive. As described below, a user can select a property for formal deal proceedings, from among multiple candidate properties identified for a tenant inquiry. Other types of actions can be performed.

Information regarding performance of an action relating to the first tenant inquiry can be received, by the application or system. The user interface can be updated to reflect performance of the action relating to the first tenant inquiry. Receiving information regarding performance of the action can include receiving a user input provided to the user interface that indicates completion of the action. The first user may be assigned to the first tenant inquiry and the user input may be received from the first user. Receiving information regarding performance of the first action can include automatically receiving information from an application.

The information regarding performance of the action can indicate completion of the action and a next action for the first tenant inquiry can be determined. At least one assigned user who is assigned to the next action can be determined. A notification can be provided to the at least one assigned user regarding the next action. The notification can be provided in the user interface, as an electronic message, or through some other means. The action can be a last action of a first stage of a tenant inquiry workflow. Determining the next action can include updating a stage status of the first stage to be completed, determining a next stage, and determining a first action of the next stage as the next action. Stages of the tenant inquiry workflow can include inquiry, tour, and proposal.

Different properties associated with the first tenant inquiry can have different stage statuses. For example, a first property can have an inquiry status, a second property can have a tour status, and a third property can have a proposal status. When multiple properties are associated with the first tenant inquiry, a selection of a particular property (e.g., a first property) for formal deal proceedings can be received. For example, a tenant or tenant representative can finalize selection of a property for a lease, from among multiple candidate properties.

In response to receiving selection of a property for formal deal proceedings, a deal workflow process for the property can be initiated and the first tenant inquiry can be marked as completed. A deal workflow process can have at least some different stages than the first tenant inquiry. For example, the deal workflow process can include lease, revenue, and completion stages, among other different stages. In some implementations, a current stage of the first tenant inquiry is mapped to a corresponding stage of the deal workflow process, and the deal workflow process can continue at the corresponding stage of the deal workflow process. For example, a property associated with the first tenant inquiry can be in a proposal stage, and upon selection of the property for formal deal proceedings, a deal workflow process can be initiated for the property in a deal proposal stage. Some of the activities completed for the property in an inquiry proposal stage can be moved to or otherwise associated with corresponding actions of a deal proposal stage, for example. A deal proposal stage (and/or a deal tour stage) can have at least some of the same activities as a corresponding tenant inquiry proposal (or inquiry tour stage), respectively.

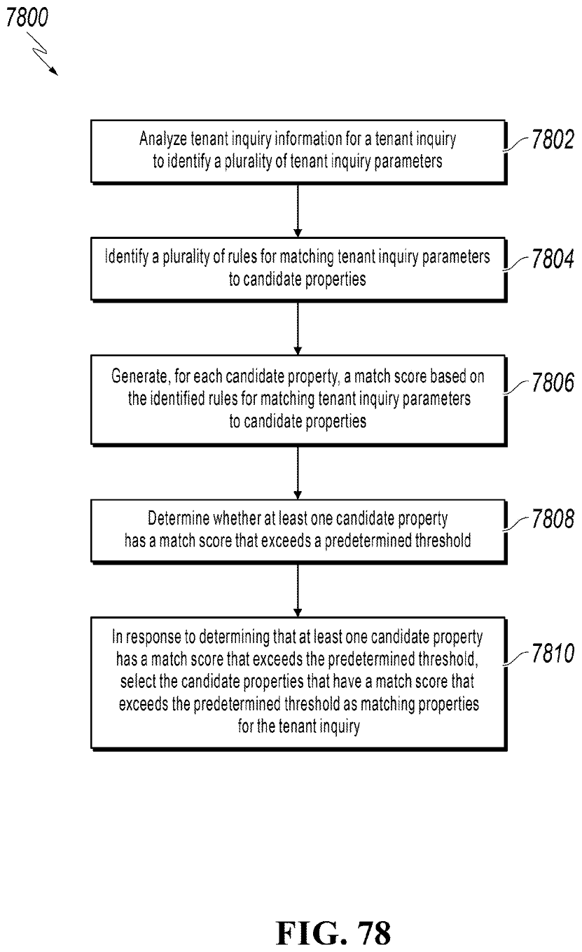

FIG. 78 is a flowchart of an example method 7800 for automatically identifying at least one matching property that matches tenant inquiry information. It will be understood that method 7800 and related methods may be performed, for example, by any suitable system, environment, software, and hardware, or a combination of systems, environments, software, and hardware, as appropriate. For example, one or more of a client, a server, or other computing device can be used to execute method 7800 and related methods and obtain any data from the memory of a client, the server, or the other computing device. In some implementations, the method 7800 and related methods are executed by one or more components of the system 100 described above with respect to FIG. 1. For example, the method 7800 and related methods can be executed by the inquiry management engine 136 of FIG. 1.

At 7802, tenant inquiry information for a tenant inquiry is analyzed to identify a plurality of tenant inquiry parameters. Tenant inquiry parameters can include a primary use type, a property size specification, a desired location, a desired lease commencement date, and a rent specification.

At 7804, a plurality of rules for matching tenant inquiry parameters to candidate properties are identified. Rules may be used to assign different weights for different tenant inquiry parameters. Some tenant inquiry parameters may have higher weight than others, in general, and some tenant inquiry parameters may have a higher weight for a particular prospective tenant, or a particular tenant inquiry, than for other tenant inquiry parameters. For example, unless configured otherwise, a rent parameter may have a higher weight than a property size parameter. As another example, for a particular tenant or a particular tenant inquiry, a property size parameter may have a higher weight than a rent parameter.

The plurality of rules can indicate that tenant inquiry parameters that are marked as required must match a candidate property for the candidate property to be considered a match. For instance, a required tenant inquiry parameter can include a location value that represents a required location for a candidate property. For instance, a tenant may insist that a property be located in the city of Dallas. As another example, a tenant may indicate that a lease commencement date is required, or that the lease commencement date is flexible. A tenant inquiry creation (and/or modification) user interface can enable a user to specify which tenant inquiry parameters are required, to assign weights to tenant inquiry parameters, or to otherwise configure rule(s) for how the tenant inquiry is to be matched to candidate properties.

At 7806, a match score is generated, for each candidate property, based on the identified rules for matching tenant inquiry parameters to candidate properties. The match score for a candidate property can be an aggregate score that is based on a degree of match of each of multiple tenant inquiry parameters to corresponding parameter values for the property. If a candidate property does not meet a required tenant inquiry parameter, the match score for that candidate property can be set, e.g., to zero, or some other value less than the predetermined threshold.

At 7808, a determination is made as to whether at least one candidate property has a match score that exceeds a predetermined threshold. If no candidate properties have a match score that exceeds the predetermined threshold, a notification can be presented. In some implementations, the system enables the user to manually select a property that, for example, a broker may believe to be a potential fit for a tenant, even if the automatically-generated match score for the property does not exceed the predetermined threshold. In some implementations, a same predetermined threshold is used for all tenants and for all tenant inquiries. In some implementations, different predetermined thresholds can be used for different tenants and/or different tenant inquiries. In some implementations, if no candidate properties have a match score that exceeds a first predetermined threshold, a second, lower predetermined threshold can be used and a determination can be made as to whether any candidate properties have a match score that exceeds the second, lower predetermined threshold. For instance, a secondary search can be performed, if a first search does not return results.

At 7810, in response to determining that at least one candidate property has a match score that exceeds the predetermined threshold, the one or more candidate properties that have a match score that exceeds the predetermined threshold are selected as matching properties for the tenant inquiry. As described above, information about the one or more matching properties can be presented, e.g., in a user interface in which a tenant inquiry is being viewed.

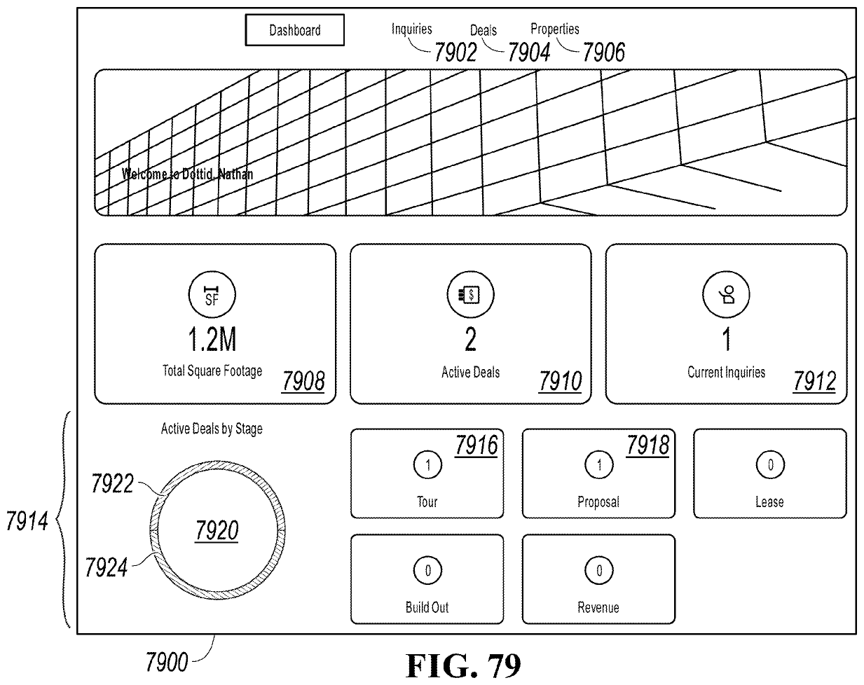

FIG. 79 illustrates another example of a dashboard user interface 7900. The user can access information about deals, inquiries, or properties using links 7902, 7904, and 7906, respectively. Summary statistics show a total square footage 7908, an active deal count 7910, and a current inquiry count 7912, respectively. Other summary statistics can be shown, such as a property count, etc.

A stage area 7914 displays information indicating counts of deals by stages. For example, a tour stage count 7916 and a proposal stage count 7918 indicate that there is currently one deal in a tour stage and one deal in a proposal stage, respectively. The tour stage count 7916 and the proposal stage count 7918 are reflected in a chart 7920, in chart portions 7922 and 7924, respectively.

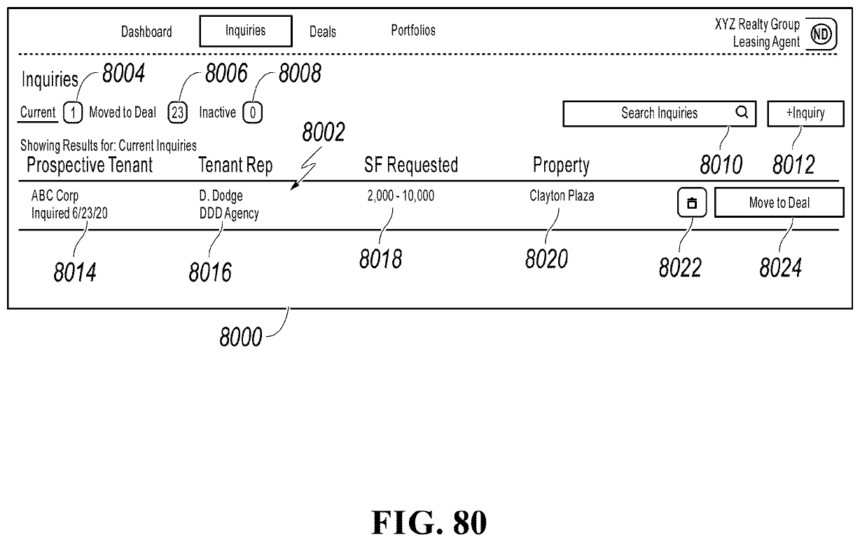

FIG. 80 illustrates an example inquiries user interface 8000. The inquiries user interface 8000 can be displayed in response to selection of the inquiries link 7902 of FIG. 79, for example. The inquiries user interface 8000 can be considered as a form of customer relationship management (CRM), for managing prospective customers (e.g., tenants). An inquiry area 8002 displays information for current inquiries.

A current inquiry count 8004 indicates that there is one current inquiry. A moved-to-deal count 8006 indicates that twenty three inquiries have previously been transitioned to respective deals. An inactive count 8008 indicates that no inquiries are currently inactive. The user can search for inquiries using a search control 8010 and add a new inquiry using an add inquiry control 8012.

The inquiry area 8002 is displaying an inquiry for an ABC Corp prospective tenant 8014, with a tenant representative 8016 of D. Dodge from DDD Agency, a requested square footage 8018 of 2,000-10,000 square feet, and a candidate property 8020 of Clayton Plaza. The inquiry for ABC Corp can be deleted using a delete control 8022. The inquiry for ABC Corp can be moved to (e.g., transitioned to) a deal in response to user selection of a move-to-deal control 8024.

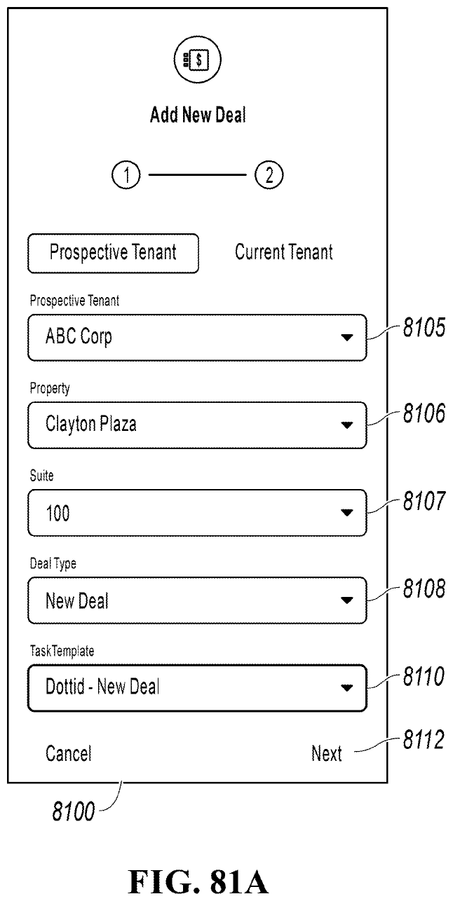

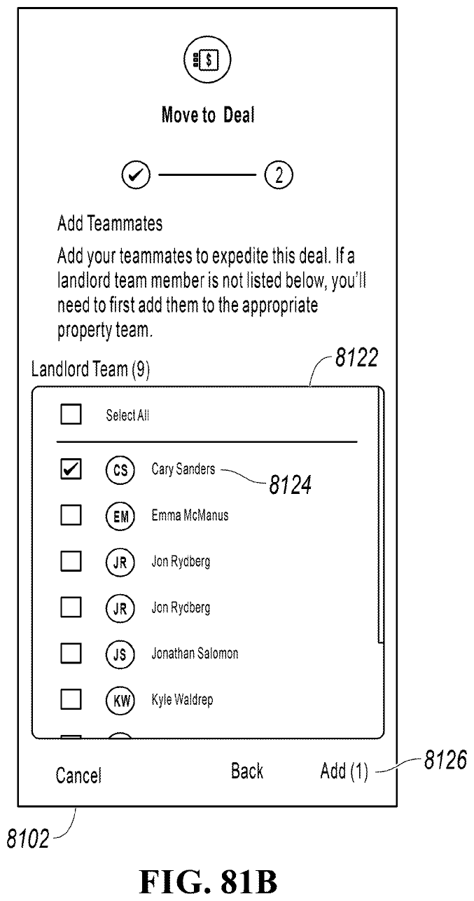

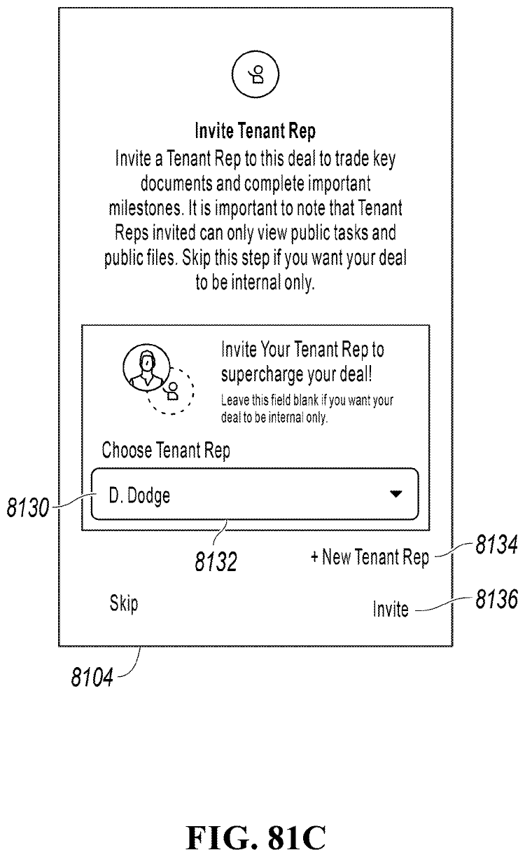

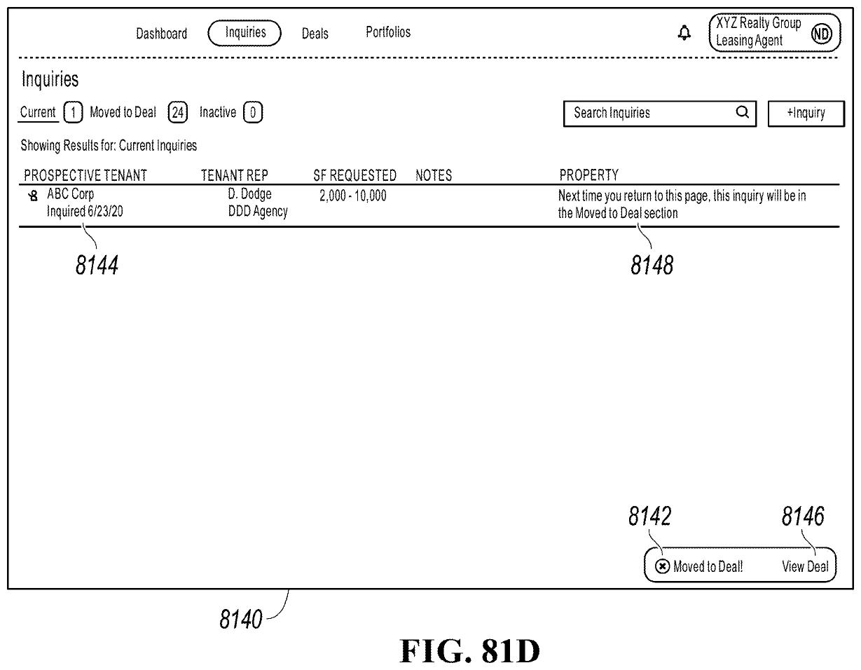

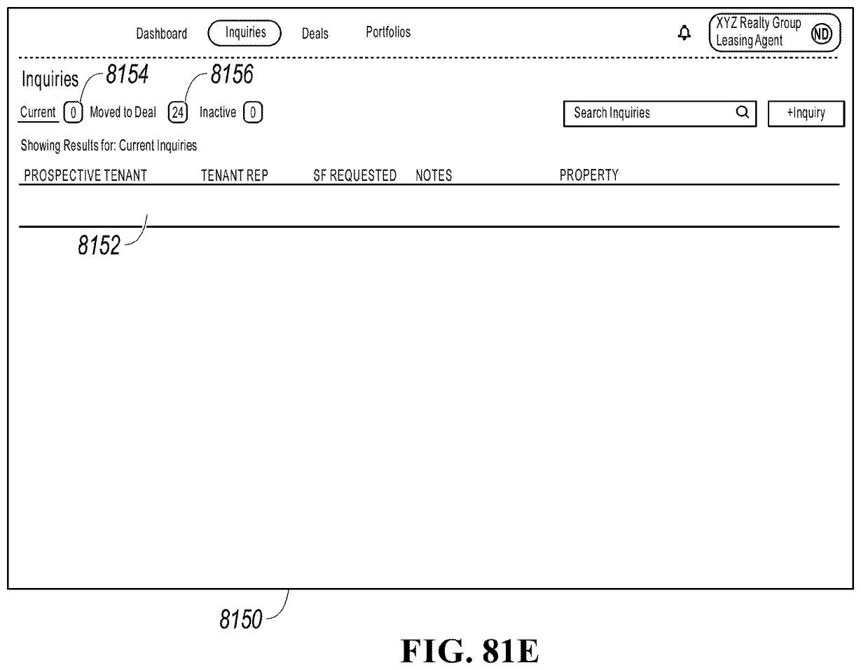

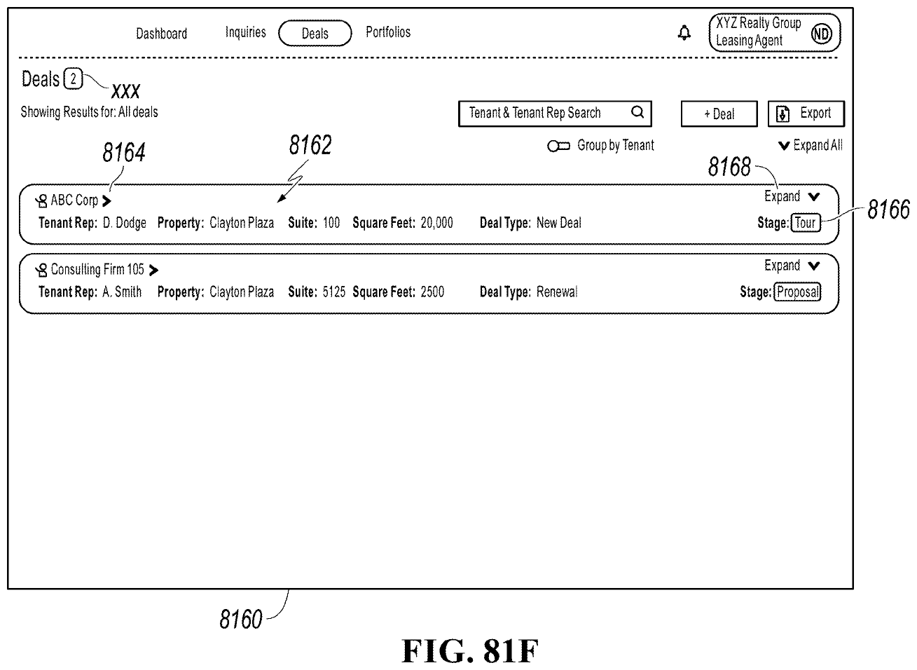

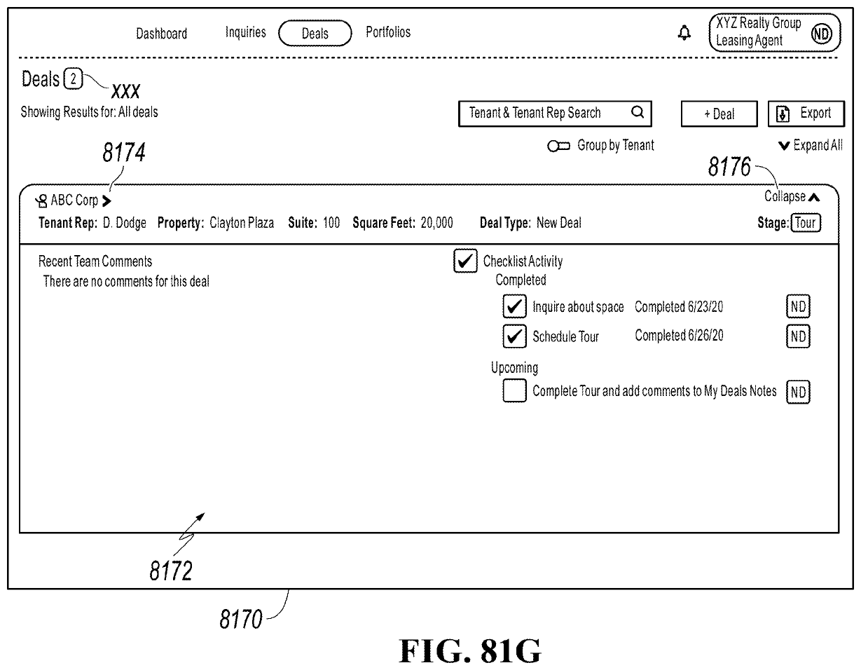

FIGS. 81A-81C illustrate example move-to-deal user interfaces 8100, 8102, and 8104, respectively. The move-to-deal user interface 8100 of FIG. 81A can be displayed in response to user selection of the move-to-deal control 8024 of FIG. 80, for example. Prospective tenant information 8105, property information 8105, and suite information 8107 can be populated upon display of the move-to-deal user interface 8100 (e.g., using information from a selected inquiry) and/or can be entered (or changed) by the user.

A deal type 8108 can be defaulted as “new deal.” Other deal types can include renewal, expansion, contraction, assignment, or termination. A task template 8110 can be used to set up a set of predefined tasks for the new deal. Templates are described in more detail below. A link 8112 can be selected to proceed to a next step of the move-to-deal process.

For example and as shown in the move-to-deal user interface 8102 of FIG. 81B, the user can select teammates, e.g., for a landlord team for the new deal, using a teammate selection area 8122. For example, a team member 8124 has been selected. Selected teammates can be added to the deal in response to selection of an add control 8126.

The move-to-deal user interface 8104 of FIG. 81C can be displayed after teammates have been added to the deal. The user interface 8104 enables the user to invite a tenant representative to the new deal. For example, the user has selected a tenant representative 8130 using a tenant representative selection control 8132. A new tenant representative can be added to the system using an add tenant representative control 8134.

FIG. 81D illustrates an example inquiry user interface 8140. A message 8142 indicates that the inquiry for the ABC Corp prospective tenant 8144 has been moved to (e.g., transitioned to) a deal. The user can select a link 8146 to view the created deal. A note 8148 indicates that when the user next loads the inquiry user interface 8140, the inquiry for the ABC Corp will no longer be displayed in the inquiry user interface 8140 (e.g., since the inquiry no longer exists after being transitioned to a deal).

FIG. 81E illustrates an example inquiry user interface 8150. The inquiry user interface 8150 can be loaded after the previously discussed inquiry for the ABC Corp has been moved to a deal. An inquiry area 8152 is currently empty (e.g., no current inquiries, as reflected by a current inquiries count 8154 of zero). A moved-to-deal count 8156 has been incremented by one (e.g., as compared to the moved-to-deal count 8006 described above with respect to FIG. 80).

FIG. 81F illustrates an example deals user interface 8160. The deals user interface 8160 includes a deal entry 8162 for an ABC Corp tenant 8164 (e.g., with the ABC Corp tenant 8164 now considered as a tenant rather than as a prospective tenant, after the prior inquiry has been transitioned to a deal). As indicated by a stage indicator 8166, the deal is at a tour stage. Other deal information can be displayed in response to selection of an expand link 8168.

FIG. 81G illustrates an example deals user interface 8170. The deals user interface 8170 shows an expanded deal information area 8172 for a deal for an ABC Corp tenant 1874. The expanded deal information area 8172 can be collapsed in response to user selection of a collapse link 8176.

Other approaches can be used for inquiries and deals. For example, the system can automatically create an inquiry in response to receiving a direct message from a tenant (e.g., an email or some other type of message) that the system determines is inquiry-related. The automatically created inquiry can be created with a same creation date as an initial inquiry related email or message. Content from other messages in a same conversation can be added to the inquiry (e.g., as notes).

The preceding figures and accompanying description illustrate example processes and computer-implementable techniques. But system 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the operations in these processes may take place simultaneously, concurrently, and/or in different orders than as shown. Moreover, system 100 may use processes with additional operations, fewer operations, and/or different operations, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A computer implemented method comprising:
receiving a request from a first user to access a lease transaction management system;
determining a first organization and a first role associated with a current session of the first user;
customizing a user interface of the lease transaction management system based on the first organization and the first role associated with the current session, including displaying information for lease transactions that the first user is authorized to view based on the first role and the first organization;
receiving information regarding performance of a first lease transaction action for a first lease transaction; and
updating a status of the first lease transaction action in response to receiving the information regarding the performance of the first lease transaction action.

2. The method of claim 1, wherein the first role is one of a property owner, leasing team member, or tenant representative.

3. The method of claim 1, wherein receiving information regarding performance of the first lease transaction action comprises receiving a user input provided to the user interface that indicates completion of the first lease transaction action.

4. The method of claim 3, wherein the first user is assigned to the first lease transaction action and the user input is received from the first user.

5. The method of claim 1, wherein the first lease transaction action comprises uploading a document to the lease transaction management system.

6. The method of claim 5, wherein the document is a shared document accessible by users who are associated with the first lease transaction.

7. The method of claim 5, wherein the document is a team document accessible by members of a team that includes the first user and not accessible by users of the lease transaction management system that are not included in the team.

8. The method of claim 7, wherein the team is a leasing team.

9. The method of claim 1, wherein receiving information regarding performance of the first lease transaction action comprises automatically receiving information from an application.

10. The method of claim 1, wherein the information regarding performance of the first lease transaction action indicates completion of the first lease transaction action and the method further comprises determining a next lease transaction action.

11. The method of claim 10, further comprising determining at least one assigned user who is assigned to the next lease transaction action and providing a notification to the at least one assigned user regarding the next lease transaction action.

12. The method of claim 11, wherein the notification is provided to the at least one assigned user in the user interface.

13. The method of claim 11, wherein the notification is provided to the at least one user using an electronic messaging system.

14. The method of claim 10, wherein the first lease transaction action is a last action of a first stage and determining the next lease transaction action comprises:
updating a stage status of the first stage to be completed;
determining a next stage; and
determining a first action of the next stage as the next lease transaction action.

15. The method of claim 14, wherein stages include tour, proposal, lease, closing, and revenue.

16. The method of claim 1, wherein the information regarding performance of the first lease transaction action indicates completion of the first lease transaction action, and wherein the first lease transaction action is a last action of a last stage, and wherein the method further comprises updating a status of the first lease transaction to be completed.

17. A system comprising:
one or more computers; and
a computer-readable medium coupled to the one or more computers having instructions stored thereon which, when executed by the one or more computers, cause the one or more computers to perform operations comprising:
receiving a request from a first user to access a lease transaction management system;
determining a first organization and a first role associated with a current session of the first user;
customizing a user interface of the lease transaction management system based on the first organization and the first role associated with the current session, including displaying information for lease transactions that the first user is authorized to view based on the first role and the first organization;
receiving information regarding performance of a first lease transaction action for a first lease transaction; and
updating a status of the first lease transaction action in response to receiving the information regarding the performance of the first lease transaction action.

18. The system of claim 17, wherein the first role is one of a property owner, leasing team member, or tenant representative.

19. A computer program product encoded on a non-transitory storage medium, the product comprising non-transitory, computer readable instructions for causing one or more processors to perform operations comprising:
receiving a request from a first user to access a lease transaction management system;
determining a first organization and a first role associated with a current session of the first user;
customizing a user interface of the lease transaction management system based on the first organization and the first role associated with the current session, including displaying information for lease transactions that the first user is authorized to view based on the first role and the first organization;
receiving information regarding performance of a first lease transaction action for a first lease transaction; and
updating a status of the first lease transaction action in response to receiving the information regarding the performance of the first lease transaction action.

20. The computer program product of claim 19, wherein the first role is one of a property owner, leasing team member, or tenant representative.

21. A computer implemented method comprising:
receiving a request from a first user to access a lease transaction management system;
determining a first organization and a first role associated with a current session of the first user;
customizing a user interface of the lease transaction management system based on the first organization and the first role associated with the current session, including displaying information for tenant inquiries that the first user is authorized to view based on the first role and the first organization;
receiving, through the user interface, first tenant inquiry information for a first tenant inquiry for a first prospective tenant;
automatically identifying at least one matching property that matches the tenant inquiry information; and
presenting, in the user interface, information about the at least one matching property to the first user.

22. The method of claim 21, wherein the first role is one of a property owner, leasing team member, or tenant representative.

23. The method of claim 21, further comprising:
receiving information regarding performance of an action relating to the first tenant inquiry; and
updating the user interface to reflect performance of the action relating to the first tenant inquiry.

24. The method of claim 23, wherein receiving information regarding performance of the action comprises receiving a user input provided to the user interface that indicates completion of the action.

25. The method of claim 24, wherein the first user is assigned to the first tenant inquiry and the user input is received from the first user.

26. The method of claim 21, wherein receiving information regarding performance of the first action comprises automatically receiving information from an application.

27. The method of claim 21, wherein the information regarding performance of the action indicates completion of the action and the method further comprises determining a next action for the first tenant inquiry.

28. The method of claim 27, further comprising determining at least one assigned user who is assigned to the next action and providing a notification to the at least one assigned user regarding the next action.

29. The method of claim 27, wherein the action is a last action of a first stage of a tenant inquiry workflow and determining the next action comprises:
updating a stage status of the first stage to be completed;
determining a next stage; and
determining a first action of the next stage as the next action.

30. The method of claim 29, wherein stages of the tenant inquiry workflow include inquiry, tour, and proposal.

31. The method of claim 29, wherein a first property associated with the first tenant inquiry has a first stage status and a second property associated with the first tenant inquiry has a second stage status, wherein the first stage status is different than the second stage status.

32. The method of claim 31, further comprising:
receiving selection of the first property for formal deal proceedings; and
in response to receiving selection of the first property for formal deal proceedings:
initiating a deal workflow process for the first property; and
marking the first tenant inquiry as completed.

33. The method of claim 21, wherein the first tenant inquiry information is new tenant inquiry information and the first tenant inquiry is a new tenant inquiry.

34. The method of claim 21, wherein the first tenant inquiry information is updated tenant inquiry information, the first tenant inquiry is an existing inquiry, and the method further comprises updating stored tenant inquiry information for the first tenant inquiry.

35. The method of claim 34, wherein automatically identifying the at least one matching property comprises identifying at least one property that matches updated stored tenant inquiry information for the first tenant inquiry.

36. The method of claim 21, wherein the first tenant inquiry information includes a primary use type, a property size specification, a lease commencement date range, a desired location, and a rent specification.

37. The method of claim 31, further comprising:
receiving a selection, from the first user, of a third property as a matching property for the first tenant inquiry; and
updating the user interface to include presentation of the third property as a matching property for the first tenant inquiry.

38. The method of claim 21, wherein automatically identifying at least one matching property that matches the tenant inquiry information comprises:
analyzing the tenant inquiry information to identify a plurality of tenant inquiry parameters;
identifying a plurality of rules for matching tenant inquiry parameters to candidate properties
generating, for each candidate property, a match score based on the identified rules for matching tenant inquiry parameters to candidate properties;
determining whether at least one candidate property has a match score that exceeds a predetermined threshold; and
in response to determining that at least one candidate property has a match score that exceeds the predetermined threshold, selecting the candidate properties that have a match score that exceeds the predetermined threshold as matching properties for the first tenant inquiry.

39. A system comprising:
one or more computers; and
a computer-readable medium coupled to the one or more computers having instructions stored thereon which, when executed by the one or more computers, cause the one or more computers to perform operations comprising:
receiving a request from a first user to access a lease transaction management system;
determining a first organization and a first role associated with a current session of the first user;
customizing a user interface of the lease transaction management system based on the first organization and the first role associated with the current session, including displaying information for tenant inquiries that the first user is authorized to view based on the first role and the first organization;
receiving, through the user interface, first tenant inquiry information for a first tenant inquiry for a first prospective tenant;
automatically identifying at least one matching property that matches the tenant inquiry information; and
presenting, in the user interface, information about the at least one matching property to the first user.

40. A computer program product encoded on a non-transitory storage medium, the product comprising non-transitory, computer readable instructions for causing one or more processors to perform operations comprising:
receiving a request from a first user to access a lease transaction management system;
determining a first organization and a first role associated with a current session of the first user;
customizing a user interface of the lease transaction management system based on the first organization and the first role associated with the current session, including displaying information for tenant inquiries that the first user is authorized to view based on the first role and the first organization;
receiving, through the user interface, first tenant inquiry information for a first tenant inquiry for a first prospective tenant;
automatically identifying at least one matching property that matches the tenant inquiry information; and
presenting, in the user interface, information about the at least one matching property to the first user.
